(19) United States
(12) Patent Application Publication
(10) Pub. No.: US 2016/0234307 A1
(43) Pub. Date: Aug. 11, 2016

(54) DATA TRANSMISSION METHOD, DEVICE, AND SYSTEM

(71) Applicants: BEIJING QIHOO TECHNOLOGY COMPANY LIMITED, Beijing (CN); QIZHI SOFTWARE (BEIJING) COMPANY LIMITED, Beijing (CN)

(72) Inventors: Tengfei YAN, Beijing (CN); Yang JIANG, Beijing (CN)

(73) Assignee: Beijing Qihoo Technology Company Limited, Beijing (CN)

(21) Appl. No.: 15/025,401

(22) PCT Filed: Sep. 23, 2014
(86) PCT No.: PCT/CN2014/087203

§ 371 Date: Mar. 28, 2016

(30) Foreign Application Priority Data
Sep. 29, 2013 (CN) 201310456173.X
Sep. 29, 2013 (CN) 201310456199.4
Sep. 29, 2013 (CN) 201310456279.X
Sep. 29, 2013 (CN) 201310456451.1
Sep. 29, 2013 (CN) 201310456454.5

(51) Int. Cl. H04L 29/08; H04L 12/26; H04L 29/06

(52) U.S. Cl. CPC H04L 67/1095; H04L 67/42; H04L 43/0811

(57) ABSTRACT

The invention discloses a data transmission method, device and system. The data transmission method comprises: determining that a connection is established between a first terminal and a second terminal; obtaining identification information of a first client disposed in the first terminal; and transmitting the identification information to a second client disposed in the second terminal. By employing the invention, the problem can be solved in which since data transmission can not be conducted between different clients, user requirements must be re-introduced when a new client is enabled, thereby resulting in resource waste and low efficiency.

### FIELD OF THE INVENTION

The invention relates to the field of internet applications, and in particular, to a data transmission method, device and system.

### BACKGROUND OF THE INVENTION

With the explosive growth of mobile terminal internet users and ever changing of mobile internet applications, requirements of either enterprises or common internet users for sharing information between the same clients on mobile terminals and other terminals become higher and higher. As far as the prior art is concerned, information synchronization can not be achieved between a client on a mobile terminal and the same client on other terminal.

In particular, many users have had such an experience: when one and the same browser is used on different terminals, with respect to information within the favorites or information of frequently browsed webpages in the browser, it is necessary to repetitively execute operations that are on one browser and have been executed so as to be able to save some commonly used execution operation data to the browser of another terminal.

Such a problem that synchronous sharing of information can not be achieved between the same clients of different terminals results in that when a user uses the same clients on a mobile terminal and other terminal, he has to perform repetitive operations to guarantee synchronous sharing of information, and not only the operation steps are very tedious, but the efficiency is also low.

### SUMMARY OF THE INVENTION

In view of the above problems, the invention is proposed to provide a data transmission method, device and system, which overcome the above problems or at least in part solve or mitigate the above problems.

According to an aspect of the invention, there is provided a data transmission method comprising:

determining that a connection is established between a first terminal and a second terminal;

obtaining identification information of a first client disposed in the first terminal; and

transmitting the identification information to a second client disposed in the second terminal.

The invention further provides another data transmission method comprising:

after a first terminal is connected with a second terminal, receiving identification information of a first client disposed in the first terminal sent by the first client;

a second client located in the second terminal utilizing the identification information to search for address information of a corresponding persistent connection server; and

establishing a persistent connection between the second client and the persistent connection server according to the obtained address information, such that the second client receives data from the persistent connection server.

The invention further provides a first client disposed in a first terminal, comprising:

a first determination module configured to determine that the first terminal is connected with a second terminal;

a first obtaining module configured to obtain identification information of the client; and

a data transmission module configured to transmit the identification information to the second terminal.

The invention further provides a second client disposed in a second terminal, comprising:

a second determination module configured to determine that the second terminal is connected with a first terminal;

a second reception module configured to receive identification information of a first client disposed in the first terminal sent by the first client;

a second obtaining module configured to obtain the identification information and search for address information of a corresponding persistent connection server according to the identification information; and

a connection establishment module configured to establish a persistent connection between the client and the persistent connection server according to the obtained address information, such that the client receives data from the persistent connection server.

The invention further provides a data transmission system comprising a first client as claimed in any of the above terms and a second client as claimed in any of the above terms, the first client being disposed in a first terminal, the second client being disposed in a second terminal, the first terminal being connected with the second terminal, and further comprising a first server corresponding to the first terminal, a persistent connection allocation server and a persistent connection server, wherein

the first client is configured to transmit its own identification information to the second client; and transmit data in the first client to the persistent connection server via the first server;

the first server is configured to receive data sent by the first client and forward it to the persistent connection server;

the second client is configured to receive identification information sent by the first client and search for address information of a corresponding persistent connection server via the persistent connection allocation server; establish a persistent connection with the persistent connection server; and receive data transmitted by the first client via the persistent connection server;

the persistent connection allocation server is configured to allocate a persistent connection server according to the identification information of the first client; and receive an address request message sent by an individual client carrying the identification information of the first client and feed the address of a corresponding persistent connection server back to the requester; and

the persistent connection server is configured to establish a persistent connection with the second client; and receive data from the first client forwarded by the first server, and forward the data to the second client.

According to another aspect of the invention, there is provided a data transmission method applied for a first client sending data to a second client, comprising:

establishing a persistent connection between the second client and a persistent connection server utilizing a network; and

receiving data from the first client forwarded by the persistent connection server, wherein the first client sends the data to a first server, and the first server forwards it to the persistent connection server.

The invention further provides a second client comprising:

a first connection establisher configured to establish a persistent connection with a persistent connection server utilizing a network;

a first data receiver configured to receive data from a first client forwarded by the persistent connection server, wherein the first client sends the data to a first server, and the first server forwards it to the persistent connection server.

The invention further provides a first client comprising:

a first data obtainer configured to obtain data of the client; and

a first data sender configured to send the data to a first server and the first server forwards the data to a second client via a persistent connection server.

The invention further provides a data transmission system comprising a first client as described above and a second client as described above, and further comprising a first server and a persistent connection server,

the first client is configured to send data of the first client to the first server;

the first server is configured to forward the data of the first client to the persistent connection server;

the persistent connection server is configured to receive the data from the first server and forward it to the second client; and

the second client is configured to receive the data forwarded by the persistent connection server.

According to yet another aspect of the invention, there is provided a data transmission method comprising:

establishing a connection between a first terminal and a mobile terminal, wherein a first client is disposed in the first terminal, and a second client is disposed in the mobile terminal;

obtaining first data of the first client and sending the first data to the second client; and/or

obtaining second data of the second client and sending the second data to the first client.

The invention further provides a first client disposed in a first terminal, the first terminal establishing a connection with a mobile terminal, comprising:

a third obtaining module configured to obtain first data of the first client running locally; and

a first sending module configured to send the first data to a second client running and disposed in the mobile terminal.

The invention further provides a second client disposed in a mobile terminal, the mobile terminal establishing a connection with a first terminal, comprising:

a fourth obtaining module configured to obtain second data of the client; and

a second sending module configured to send the second data to a first client running in the first terminal.

The invention further provides a network system comprising a first client disposed in a first terminal and a second client disposed in a mobile terminal, the first terminal establishing a connection with the mobile terminal,

the first client is configured to send first data to the second client; and

the second client is configured to send second data to the first client.

According to still another aspect of the invention, there is provided a data transmission method applied in a situation where data transmission can be conducted between a first client and a second client, comprising:

transmitting data in the first client and its identification information to a first server, and forwarding them by the first server to a persistent connection server determined according to the identification information of the first client; and

determining whether to forward the data of the first client to the second client according to a persistent connection state of the second client and the persistent connection server.

The invention further provides a client applied in a situation where data transmission can be conducted between the client and other client, comprising:

a second data obtainer configured to obtain data of the client and its identification information; and

a data transmitter configured to transmit data in the client and its identification information obtained by the data obtainer to a first server, forward them by the first server to a persistent connection server determined according to the identificaition information of the client, and determine whether to forward the data in the client to the other client according to a persistent connection state of the other client and the persistent connection server.

The invention further provides a data transmission system applied in a situation where data transmission can be conducted between a first client and a second client, comprising the first client, the second client, a persistent connection server determined according to identification information of the first client and a first server, wherein

the first client is configured to transmit data in the first client and its identification information to the first server;

the first server is configured to receive the data and the identification information sent by the first client, and forward them to the persistent connection server;

the persistent connection server is configured to establish a persistent connection with the second client; and receive the data in the first client and its identification information forwarded by the first server, and determine whether to forward the data of the first client to the second client according to a persistent connection state of the second client and the persistent connection server; and

the second client is configured to receive the data sent via the persistent connection server.

According to yet another aspect of the invention, there is further provided a data transmission method applied in a situation where data transmission is conducted between a first client and a second client, comprising:

sending data in the first client to a persistent connection server; and

determining whether to send the data of the first client to the second client according to the state of a persistent connection between the persistent connection server and the second client.

The invention further provides a client applied in a situation where data transmission is conducted between the client and other client, comprising:

a third data sender configured to send data in the client and its identification information to a persistent connection server corresponding to the other client, wherein it is determined whether to send the data to the other client according to the state a persistent connection between the persistent connection server and the other client;

a second connection establisher configured to establish a persistent connection between the client and a persistent connection server corresponding to the client; and

a third data receiver configured to receive data in the other client sent by the other client via the persistent connection server corresponding to the client.

The invention further provides a wireless data transmission system comprising a first client as described above and a second client as described above, wherein data transmission is conducted between the first client and the second client, and further comprising a persistent connection server and a persistent connection allocation server, wherein

the first client is configured to send data in the first client via the persistent connection server;

the persistent connection allocation server is configured to allocate a persistent connection server to an individual client according to address request messages sent by different clients, and send correspondingly allocated address information to the individual client respectively;

the persistent connection server is configured to receive data of the first client transmitted by the first client; and determine whether to forward the data in the first client to the second client according to the state of a persistent connection between the second client and the persistent connection server; and

the second client is configured to receive the data in the first client forwarded by the persistent connection server.

According to yet another aspect of the invention, there is provided a computer program comprising a computer readable code which causes a computing device to perform the data transmission method according to any of claims 1-7, and/or the data transmission method according to any of claims 8-17, and/or the data transmission method according to any of claims 21-32, and/or the data transmission method according to any of claims 36-55, and/or the data transmission method according to any of claims 59-71, and/or the data transmission method according to any of claims 74-85, when said computer readable code is running on the computing device.

According to still another aspect of the invention, there is provided a computer readable medium storing therein the computer program as claimed in claim 88.

The beneficial effects of the invention are as follows:

In embodiments of the invention, any data of the first client may be sent to the second client, which ensures that various operations performed by a user in the first client may be synchronously updated to the second client, avoids that the user performs repetitive operations and obtains repetitive information in a new client, and further avoids data redundancy and resource waste.

The above description is merely an overview of the technical solutions of the invention. In the following particular embodiments of the invention will be illustrated in order that the technical means of the invention can be more clearly understood and thus may be embodied according to the content of the specification, and that the foregoing and other objects, features and advantages of the invention can be more apparent.

### BRIEF DESCRIPTION OF THE DRAWINGS

Various other advantages and benefits will become apparent to those of ordinary skills in the art by reading the following detailed description of the preferred embodiments. The drawings are only for the purpose of showing the preferred embodiments, and are not considered to be limiting to the invention. And throughout the drawings, like reference signs are used to denote like components. In the drawings:

FIG. 1 shows a processing flow chart of a first data transmission method according to an embodiment of the invention;

FIG. 2 shows a flow chart of sending data according to a preferred embodiment of the invention;

FIG. 3 shows a processing flow chart of a second data transmission method according to an embodiment of the invention;

FIG. 4 shows a flow chart of a data transmission method according to a preferred embodiment of the invention;

FIG. 5 shows a structural schematic diagram of a client according to an embodiment of the invention;

FIG. 6 shows a structural schematic diagram of another client according to an embodiment of the invention;

FIG. 7 shows a structural schematic diagram of a data transmission system according to an embodiment of the invention;

FIG. 8 shows a processing flow chart of yet another data transmission method according to an embodiment of the invention;

FIG. 9 shows a flow chart of a data transmission method according to a preferred embodiment of the invention;

FIG. 10 shows a structural schematic diagram of yet another client according to an embodiment of the invention;

FIG. 11 shows a structural schematic diagram of yet another client according to an embodiment of the invention;

FIG. 12 shows a structural schematic diagram of yet another data transmission system according to an embodiment of the invention;

FIG. 13 shows a processing flow chart of yet another data transmission method according to an embodiment of the invention;

FIG. 14 shows a processing flow chart of a data transmission method on a first client side according to an embodiment of the invention;

FIG. 15 shows another flow chart of sending data according to a preferred embodiment of the invention;

FIG. 16 shows a processing flow chart of a data transmission method on a second client side according to an embodiment of the invention;

FIG. 17 shows a flow chart of another data transmission method according to a preferred embodiment of the invention;

FIG. 18 shows a structural schematic diagram of yet another client according to an embodiment of the invention;

FIG. 19 shows a structural schematic diagram of yet another client according to an embodiment of the invention;

FIG. 20 shows a structural schematic diagram of yet another data transmission system according to an embodiment of the invention;

FIG. 21 shows a processing flow chart of yet another data transmission method according to an embodiment of the invention;

FIG. 22 shows a structural schematic diagram of yet another client according to an embodiment of the invention;

FIG. 23 shows a flow chart of yet another data transmission method according to a preferred embodiment of the invention;

FIG. 24 shows a flow chart of yet another data transmission method according to another preferred embodiment of the invention;

FIG. 25 shows a structural schematic diagram of yet another data transmission system according to an embodiment of the invention;

FIG. 26 shows a processing flow chart of yet another data transmission method according to an embodiment of the invention;

FIG. 27 shows a structural schematic diagram of a data transmission device according to an embodiment of the invention;

FIG. 28 shows a structural schematic diagram of yet another data transmission system according to an embodiment of the invention;

FIG. 29 shows a flow chart of yet another data transmission method according to a preferred embodiment of the invention;

FIG. 30 shows a flow chart of a data transmission method according to another preferred embodiment of the invention;

FIG. 31 shows schematically a block diagram of a computing device for performing a data transmission method according to the invention; and

FIG. 32 shows schematically a storage unit for retaining or carrying a program code implementing a data transmission method according to the invention.

### DETAILED DESCRIPTION OF THE INVENTION

In the following the invention will be further described in connection with the drawings and the particular embodiments.

It is mentioned in related arts that when a user enables a new client, it is necessary to input user requirements again to the new client, causing actions of the new client and data redundancy, wasting lots of resources and causing the delay of implementation of the user requirements to become long and the efficiency to be low.

To solve the above technical problem, embodiments of the invention provide multiple data transmission methods, and now different data transmission methods will be described in detail utilizing embodiments.

### Embodiment 1

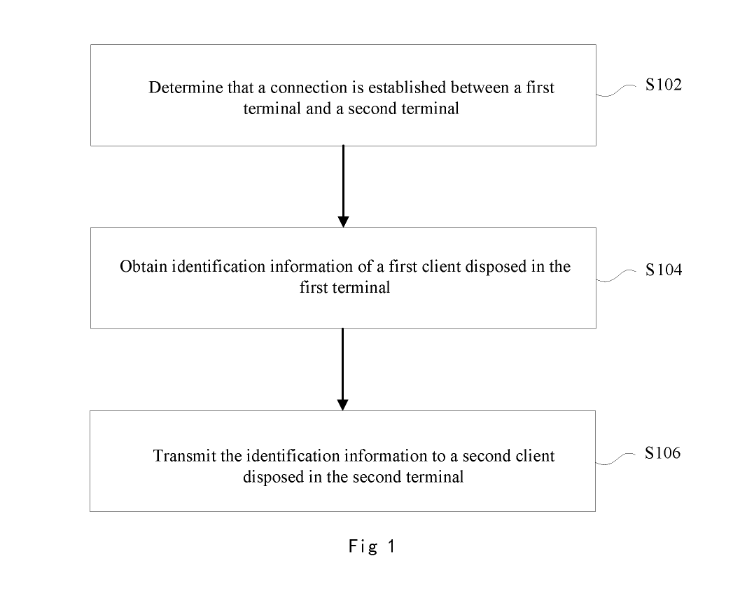

This embodiment provides a data transmission method. FIG. 1 shows a processing flow chart of a first data transmission method according to an embodiment of the invention. As shown in FIG. 1, the flow begins at step S102 to determine that a connection is established between a first terminal and a second terminal. The first terminal may establish a connection with the second terminal by multiple modes, for example wired mode, wireless mode, wherein for the wired mode, the connection may be conducted by a data line, and for the wireless mode, the connection may be conducted by a wireless network (for example, Bluetooth, wifi, local area network, etc.). Preferably, in an embodiment of the invention, the first terminal directly establishes a connection with the second terminal by a universal serial bus (USB for short in the following) data line. The operation of the mode of establishing a connection using a USB data line is simple and easy. The USB data line is currently widely employed and its identifiability is high, and it can conduct transmission of data (e.g., identification information) rapidly and efficiently.

After execution of the step S102 is finished, step S104 is further triggered to obtain identification information of a first client disposed in the first terminal. After obtaining identification information is finished, step S106 is triggered to transmit the identification information of the first client obtained at the step S104 to a second client disposed in the second terminal along the connection established at the step S102.

According to the embodiment of the invention, identification information of the first client can be sent to the second client, and data transmission from the first client to the second client is achieved, which solves the problem mentioned in the prior art that data transmission can not be conducted between clients, and further solves the problem that since data transmission can not be conducted between different clients, user requirements must be re-introduced when a new client is enabled, thereby resulting in resource waste and low efficiency.

It can be seen from the flow as shown in FIG. 1 that in the embodiment of the invention, identification information can be transmitted between the first client and the second client, namely, a channel where data transmission can be conducted has already been established between the first client and the second client. Therefore, after the transmission of the identification information to the second client mentioned at the step S106, data in the first client may be further transmitted to the second client. In transmission of data in the client to the second client, it may be routed and forwarded via a server, etc. Now, its transmission procedure will be described particularly.

Firstly, data in the first client is obtained. Secondly, the obtained data is transmitted to a first server, and here the first server is a server corresponding to the first terminal. For example, if the first terminal is a personal computer (PC for short in the following), the first server is a PC server. After receiving the data from the first client, the first server transmits it to a persistent connection server which has a persistent connection with the second client, and the persistent connection server transmits the data of the first client to the second client.

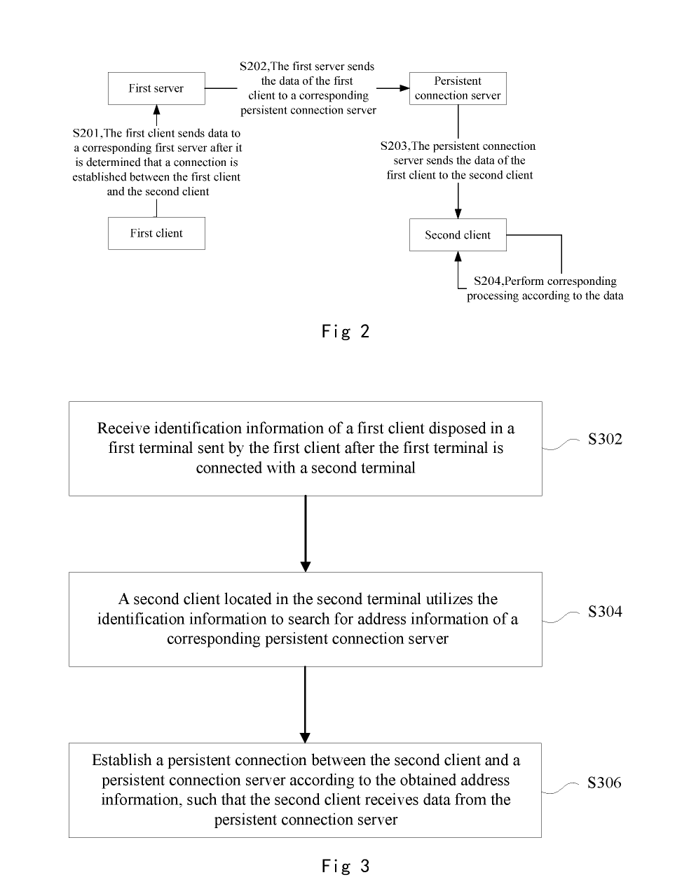

FIG. 2 shows a flow chart of sending data according to a preferred embodiment of the invention. With reference to FIG. 2, first, step S201 is performed, that is, after a channel where data transmission can be conducted has already been established between the first client and the second client, the first client sends its own identification information and data to a corresponding first server.

With reference to step S202 in FIG. 2, after receiving the data of the first client, the first server first performs legality verification on the data of the first client. Preferably, in an embodiment of the invention, the first server verifies identification information of the first client in the data to determine whether the identification information of the first client is legal information, for example, to verify whether the identification information has been registered in a client center, or the identification information is an identifier generated inside the server. If the identification information is verified to be legal information, the first server transmits the identification information to a persistent connection server, and if the identification information is not legal information, the first server refuses to send the identification information to the persistent connection server.

Likewise, the first server may further perform legality verification on other data than the identification information in the data, for example, verify whether webpage data, etc. of the first client is non-malicious data. In an embodiment of the invention, the malicious data refers to a virus, Trojan, etc. which performs an illegal action of steal, destruction, etc. on data in a user terminal. If the first server verifies that the data of the first client is the above-mentioned malicious data, the first server refuses to transmit the malicious data to the persistent connection server. If it is verified by the first server that the data of the first client is non-malicious data, the first server transmits the data to the persistent connection server. Preferably, in an embodiment of the invention, after legality verification is performed on the data of the first client, the first server may further perform encryption processing on the data of the first client, which more effectively improves the security of data transmission. By performing security verification and processing on the data of the first client by the first server, the security of data transmission can be guaranteed more effectively, avoiding that in the procedure of data transmission, some malicious network addresses, etc. are attached to the transmitted data and cause damage to a terminal or client of a user.

After performing legality verification on the data of the first client, the first server sends the data on which legality verification has been performed to a corresponding persistent connection server. The first server may communicate with the persistent connection server by multiple protocols, for example, the transmission control protocol, the user datagram protocol, etc. Preferably, in an embodiment of the invention, the first server communicates with the persistent connection server by a hypertext transfer protocol (HTTP for short hereafter) request. The HTTP supports multiple server modes and is simple and fast, and therefore communication by an HTTP request can improve the efficiency of data transmission.

It can be seen from FIG. 2 that, after the step (i.e., the step S202 in FIG. 2) of the first server sending the data of the first client to a corresponding persistent connection server is performed, step S203 is performed, in which the persistent connection server sends the data of the first client to the second client. After the second client receives the data of the first client, step S204 is triggered. At the step S204, the second client performs corresponding processing according to the received data of the first client.

From the foregoing, when data is transmitted from the first client to the second client, it needs to pass a corresponding persistent connection server. The address information of the persistent connection server needs to be obtained by the first client according to the identification information of the first client. Now, a way of obtaining the address information of a corresponding persistent connection server by the first client will be introduced. First, the first client sends an address request message carrying its own identification information to a persistent connection allocation server. After receiving the address request message, the persistent connection allocation server verifies the identification information carried in it, and then returns a response message to the first client according to the identification information. Therein, in the response message returned by the persistent connection allocation server is carried the address information of a persistent connection server corresponding to the first client.

In the embodiment of the invention, the first client searches for the address information of a corresponding persistent connection server by a persistent connection allocation server. The persistent connection allocation server returns different persistent connection server addresses to individual clients according to identification information of clients on different terminals, which ensures that synchronization of information between different clients is more rapid and timely. In addition, the first client and the second client search for a corresponding persistent connection server by the same identification information, which ensures that data of a client of a specified user is sent to a client of other terminal of the same user, and avoids that data sending of a client of the user is confused. After obtaining the address information of the corresponding persistent connection server, the first client establishes a persistent connection with the persistent connection server according to the address information, and sends data of the user in the first client to the second client via this persistent connection server.

In the embodiment of the invention, the identification information is identity verification information of a client, it may be identity verification information set by the user, or also may be identity verification information set for a client by a server, which will not be defined by the embodiment of the invention. Preferably, in an embodiment of the invention, the identification information may be account information of user login of the first client, the account information is an account which is applied by the user for registration in the client center, the application of the account information is simple and easy, and each piece of account information may be logged in on multiple clients.

Additionally, the identification information in the embodiment of the invention may also be a character string generated by a server, e.g., a shadow account, which can be taken as a unique identification. The shadow account may be a unique identification generated by the server according to information such as time, machine identification, etc. The shadow account may also be an account randomly generated by the server. After generating the account, the server checks whether the generated shadow account has already existed, and if yes, the server regenerates a shadow account, until the account did not exist before. The shadow account has nonrepeatability and uniqueness, and each shadow account can only identify one client.

In the embodiment of the invention, the first client and/or the second client may be any clients of the same type, such as a browser client, a security guard client, a reader client, a media player client, or also may be clients of different types, but which implement the same function, which will not be defined by the embodiment of the invention. The first, second herein are only used for differentiating different clients, they do not result in definition of clients' own attributes, order and functions, and the first, second may be interchanged to refer to different clients.

Preferably, in an embodiment of the invention, the first client and/or the second client is/are a browser client. A user generally performs on a browser client personalized operations of collecting network addresses, setting commonly used webpages, etc. When the user turns from one terminal to another terminal, he needs to newly enable a new client on another terminal. According to the embodiment of the invention, the personalized operations set by the user on the former client may be automatically synchronized to the newly enabled client, and it is unnecessary for the user to repeat the operations.

Similarly, in the embodiment of the invention, data of the first client may be data of any operation which is performed by a user in the first client, or also may be other data updated by the first client, data stored in the first client, etc., which will not be defined by the embodiment of the invention in any way. Preferably, in an embodiment of the invention, the data may comprise individual network addresses collected in the favorites of the first client, a network address currently opened by the first client, commonly used network addresses of the first client, and any user data invoked by the first client according to a user instruction, etc. Any data of the first client may be sent to the second client, which ensures that various operations performed by a user in the first client may be synchronously updated to the second client, avoids that the user performs repetitive operations and obtains repetitive information in a new client, and further avoids data redundancy and resource waste.

In an embodiment of the invention, in addition to client data transmission between different terminals mentioned above, client data transmission between a mobile terminal and a terminal can be further accomplished. Therefore, in an embodiment of the invention, the first terminal and the second terminal may be a terminal such as a desktop computer, a notebook computer, etc., or also may be a mobile terminal such as a mobile phone, a music player, a tablet computer, etc. Preferably, in an embodiment of the invention, the second terminal is a mobile terminal, in order that client data transmission between a terminal and a mobile terminal is more clearly and briefly elucidated.

FIG. 3 shows a processing flow chart of a second data transmission method according to an embodiment of the invention, and the data transmission method focuses on the data receiving side. With reference to FIG. 3, first, step S302 is performed, namely, after a first terminal establishes a connection with a second terminal, a second client disposed in the second terminal receives identification information sent by a first client. After the second client receives the identification information, step S304 is performed. The second client utilizes the identification information sent by the first client to search for address information of a corresponding persistent connection server. After the address of the corresponding persistent connection server, step S306 is performed to establish a persistent connection between the second client and the corresponding persistent connection server according to the obtained address information of the persistent connection server, such that the second client receives data from the corresponding persistent connection server.

According to the embodiment of the invention, utilizing the identification information, the second client can establish a persistent connection with a corresponding persistent connection server, such that data of a user in the first client is timely transmitted to the second client, which facilitates information update by the second client. The embodiment of the invention solves the problem of information sharing between the first client and the second client, enables a user to timely synchronize information between two clients, thereby avoids that the user performs repetitive operations and obtains repetitive information in a new client, and further avoids data redundancy and resource waste.

In particular, after the step S302 is performed in which the second terminal receives identification information sent by the first client, the second terminal queries about whether a second client exists. If the second client exists, the step S304 is performed in which the second client searches for the address of a persistent connection server according to the identification information of the first client. If the second client does not exist, it is necessary to first obtain an installation package of the second client and download and install the second client in the second terminal. After the installation is finished, the step S304 is performed in which the second client searches for the address of a persistent connection server according to the identification information of the first client.

Now, a specific way in which the second client searches for the address of a persistent connection server will be introduced. The second client sends an address request message carrying identification information to a persistent connection allocation server, and after receiving the address request message, the persistent connection allocation server determines a corresponding persistent connection server according to the identification information carried by the address request message, and returns to the second client a response message carrying the address information of the corresponding persistent connection server.

After the second client receives the address information of the corresponding persistent connection server sent by the persistent connection allocation server, the step S306 is performed to establish a persistent connection with the persistent connection server corresponding to the address information to receive data from the persistent connection server.

After the second client establishes a persistent connection with the corresponding persistent connection server successfully, an online device list is stored in the persistent connection server, and the list records identification information of individual clients which maintain persistent connections with the persistent connection server. If the persistent connection between a certain client and the persistent connection server is disconnected, the identification information corresponding to the disconnected client is deleted in the online device list of the persistent connection server. The real-time update of the online device list in the persistent connection server ensures that the persistent connection server can timely update information on clients which establish persistent connections with it, avoids that data is sent to a disconnected client since the data update of the online device list is not in time and a malignant consequence such as packet loss, etc. is caused, and improves the security of data transmission.

When the persistent connection server receives data of the first client sent via the first server, the persistent connection server finds the second client according to the identification information carried in the data of the first client, and determines the state of the persistent connection between it and the second client according to information recorded in the online device list. If the state of the persistent connection is connected, the persistent connection server sends the data of the first client to the second client. If the state of the persistent connection is disconnected, the data of the first client is stored in the persistent connection server, and then it is not until the state of the persistent connection between the persistent connection server and the second client turns from disconnected to connected that the data of the first client stored in the persistent connection server is sent to the second client.

After receiving the data sent by the persistent connection server, the second client performs corresponding processing according to the data to ensure that information sharing is realized between the first client and the second client, and operations of which the execution was not finished on the first client previously can continue to be performed on the second client, for example, continue to read content of a webpage.

In the embodiment of the invention, the identification information is identity verification information of a client, it may be identity verification information set by the user, or also may be identity verification information set for a client by a server, which will not be defined by the embodiment of the invention. Preferably, in an embodiment of the invention, the identification information may be account information of user login of the first client, the account information is an account which is applied by the user for registration in a client center, the application of the account information is simple and easy, and each piece of account information may be logged in on multiple clients. Additionally, the identification information in the embodiment of the invention may also be a character string generated by a server, e.g., a shadow account, which can be taken as a unique identification. The shadow account may be a unique identification generated by the server according to information such as time, machine identification, etc. The shadow account may also be an account randomly generated by the server. After generating the account, the server checks whether the generated shadow account has already existed, and if yes, the server regenerates a shadow account, until the account did not exist before. The shadow account has nonrepeatability and uniqueness, and each shadow account can only identify one client.

In the embodiment of the invention, the first client and/or the second client may be any clients of the same type, such as a browser client, a security guard client, a reader client, a media player client, or also may be clients of different types, but which implement the same function, which will not be defined by the embodiment of the invention. The first, second herein are only used for differentiating different clients, they do not result in definition of clients' own attributes, order and functions, and the first, second may be interchanged to refer to different clients.

Preferably, in an embodiment of the invention, the first client and/or the second client is/are a browser client. A user generally performs on a browser client personalized operations of collecting network addresses, setting commonly used webpages, etc. When the user turns from one terminal to another terminal, he needs to newly enable a new client on another terminal. According to the embodiment of the invention, the personalized operations set by the user on the former client may be automatically synchronized to the newly enabled client, and it is unnecessary for the user to repeat the operations.

Similarly, in the embodiment of the invention, data of the first client may be data of any operation which is performed by a user in the first client, or also may be other data updated by the first client, data stored in the first client, etc., which will not be defined by the embodiment of the invention in any way. Preferably, in an embodiment of the invention, the data may comprise individual network addresses collected in the favorites of the first client, a network address currently opened by the first client, commonly used network addresses of the first client, and any user data invoked by the first client according to a user instruction, etc. In addition, in the embodiment of the invention, the processing performed by the second client according to the received data of the first client may be to perform corresponding processing on the second client itself according to the data of the first client, or also may be to perform processing on the received data of the first client. Preferably, in an embodiment of the invention, the processing performed by the second client according to the data of the first client comprises that the second client updates the favorites, the second client updates commonly used network addresses, and the second client opens a webpage corresponding to a network address, and so on.

In the embodiment of the invention, any data of the first client may be sent to the second client, which ensures that various operations performed by a user in the first client may be synchronously updated to the second client, avoids that the user performs repetitive operations and obtains repetitive information in a new client, and further avoids data redundancy and resource waste.

In an embodiment of the invention, in addition to client data transmission between different terminals mentioned above, client data transmission between a mobile terminal and a terminal can be further accomplished. Therefore, in an embodiment of the invention, the first terminal and the second terminal may be a terminal such as a desktop computer, a notebook computer, etc., or also may be a mobile terminal such as a mobile phone, a music player, a tablet computer, etc. Preferably, in an embodiment of the invention, the second terminal is a mobile terminal, in order that client data transmission between a terminal and a mobile terminal is more clearly and briefly elucidated.

### Embodiment 1.1

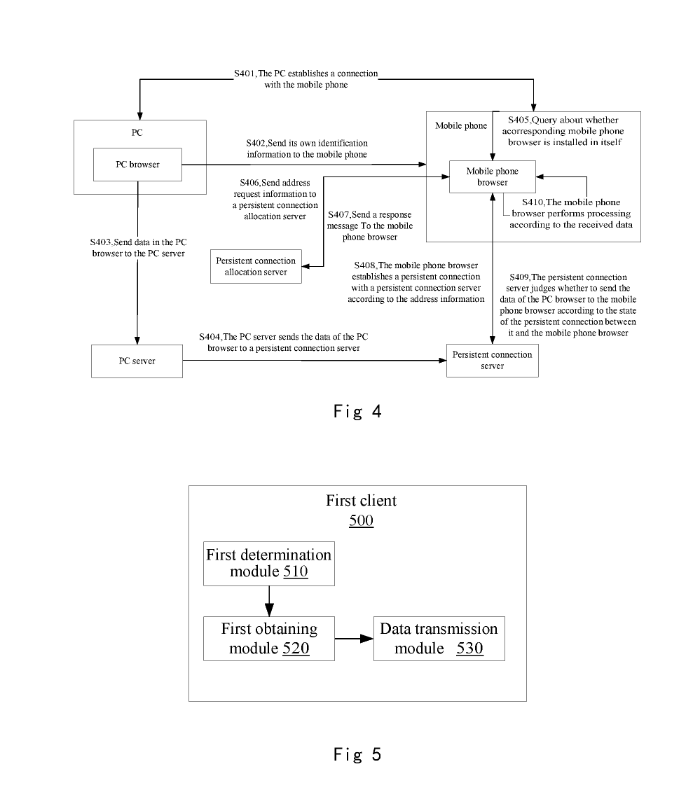

FIG. 4 shows a flow chart of a data transmission method according to a preferred embodiment of the invention, which is used for supporting any of the data transmission methods described above and elaborating the data transmission methods more clearly. As shown in FIG. 4, in this example, a PC is selected as the first terminal, a mobile phone is the second terminal, and the clients are browser clients. For the convenience of identifying the first client and the second client, in this example, the first client is called a PC browser, and the second client is called a mobile phone browser.

With reference to FIG. 4, first step S401 is performed to use a USB data line to establish a connection between the PC and the mobile phone. After the PC browser receives a notification of the mobile phone being connected to the PC, step S402 is performed to send its own identification information to the mobile phone. After the PC browser receives the notification, step S403 is performed to query about whether account information has already been logged in the client and send data of the PC browser to a PC server according to the query result. In particular, if account information has already been logged in the client, the PC browser sends the account information and data of the PC browser to the PC server. If no account information is logged in the client, the PC browser generates a unique identification as the identification information of the PC browser, and sends the identification information and data of the PC browser to the PC server.

In this preferred embodiment, the step in which the PC browser sends data to the PC server mentioned at the step S403 can be performed in the whole procedure of data transmission, to ensure that the PC browser can timely send its own data and data updated in real time to the PC server. That is, the PC browser may send data of the PC browser to the PC server after the PC establishes a connection with the mobile phone, and also may send data when the PC does not establish a connection with the mobile phone. Likewise, the PC browser may send data to the PC server before sending its own identification information to the mobile phone, or also may send data to the PC server after the PC browser sends its own identification information to the mobile phone.

After the PC server receives the data of the PC browser, step S404 is performed to perform legality verification on the data sent by the PC browser, and send the data which passes the legality verification to a persistent connection server after the data is encrypted. Therein, the legality verification may be to verify whether the identification information sent by the PC browser is legal, or also may be to verify whether the data sent by the PC browser is non-malicious data. If the data of the PC browser can not pass the legality verification by the PC server, then the PC server does not perform sending processing on the data.

Furthermore, after the mobile phone receives the identification information sent by the PC browser via the step S402, step S405 is performed to query about whether a corresponding mobile phone browser is installed in itself. If a corresponding mobile phone browser is not installed in the mobile phone, then first a mobile phone browser is downloaded and installed in the mobile phone, and after the installation is finished, the mobile phone sends the identification information of the PC browser to the mobile phone browser. If a corresponding mobile phone browser has already existed in the mobile phone, then the identification information of the PC browser is directly sent to the mobile phone browser.

After the mobile phone browser receives the identification information of the PC browser, step S406 is performed to send address request information for a persistent connection server which carries the identification information to a persistent connection allocation server. After the persistent connection allocation server receives the address request message of the mobile phone browser, step S407 is triggered to send a response message carrying the address information of a persistent connection server to the mobile phone browser. After the mobile phone browser receives the response message carrying the address information of a persistent connection server, step S408 is performed to establish a persistent connection with a corresponding persistent connection server according to the address information of the persistent connection server so as to receive data of the PC browser from the persistent connection server.

An online device list is stored in the persistent connection server, and the real-time update of the list ensures that the persistent connection server can timely update information on browsers which establish a persistent connection with it, avoids that data is sent to a disconnected browser since the data update of the online device list is not in time and a malignant consequence such as packet loss, etc. is caused, and improves the security of data transmission.

After the persistent connection server receives the data of the PC browser sent via the PC server, with reference to step S409 in FIG. 4, the persistent connection server judges whether to send the data of the PC browser to the mobile phone browser according to the state of the persistent connection between it and the mobile phone browser. In particular, the persistent connection server queries about the state of the persistent connection between it and the corresponding mobile phone browser according to the online device list, and if the state of the persistent connection is maintained, then sends the data of the PC browser to the mobile phone browser. If the the state of the persistent connection is disconnected, it stores the data of the PC browser, and will not send the data of the PC browser to the mobile phone browser, until the state of the persistent connection between the persistent connection server and the corresponding mobile phone browser is recovered.

With reference to FIG. 4, after the mobile phone browser receives the data sent by the persistent connection server, step S410 is triggered. In the step S410, the mobile phone browser performs corresponding processing according to the received data of the PC browser to ensure that information sharing is realized between the first client and the second client, and operations of which the execution was not finished on the first client previously can continue to be performed on the second client, for example, continue to read content of a webpage.

On the basis of the data transmission methods provided in the above individual preferred embodiments and based on the same concept, an embodiment of the invention provides a client for data transmission, which is used for implementing a data transmission method as described above.

FIG. 5 shows a structural schematic diagram of a client according to an embodiment of the invention. In order to elaborate the embodiment of the invention more clearly and briefly, in the following, the client for data transmission is abbreviated as a first client disposed in a first terminal. Referring to FIG. 5, the first client 500 of the embodiment of the invention comprises at least: a first determination module 510, a first obtaining module 520 and a data transmission module 530.

Now, functions of individual devices or components and a connection relationship between individual parts of the first client 500 in a data transmission device of the embodiment of the invention will be introduced. In the first client 500, the first determination module 510 determines that the first terminal is connected with a second terminal, the first obtaining module 520 coupled with it can obtain the client's own identification information, and then the data transmission module 530 coupled with the first obtaining module 520 transmits the identification information to the second terminal.

According to the embodiment of the invention, identification information of the first client 500 can be sent to a second client, and data transmission from the first client 500 to the second client is achieved, which solves the problem mentioned in the prior art that data transmission can not be conducted between clients, and further solves the problem that since data transmission can not be conducted between different clients, user requirements must be re-introduced when a new client is enabled, thereby resulting in resource waste and low efficiency.

In particular, in the embodiment of the invention, identification information can be transmitted between the first client 500 and the second client, namely, a channel where data transmission can be conducted has already been established between the first client 500 and the second client. Therefore, after the transmission of the identification information to the second client, the first obtaining module 520 may further obtain data in the first client 500, and then the data in the first client 500 is transmitted by the data transmission module 530 to the second client. In transmission of data in the first client 500 to the second client, it may be routed and forwarded via a server, etc.

After the first obtaining module 520 obtains data in the first client 500, the data transmission module 530 transmits the obtained data to a first server, and the first server here is a server corresponding to the first terminal 500. For example, if the first terminal is a PC, the first server is a PC server. After receiving the data from the first client 500, the first server transmits it to a persistent connection server which has a persistent connection with the second client, and the persistent connection server transmits the data of the first client 500 to the second client.

It can be seen from above that when data is transmitted from the first client 500 to the second client, it needs to pass through a corresponding persistent connection server. The address information of the persistent connection server needs to be obtained by the first obtaining module 520 in the first client 500 according to the identification information of the first client 500. Now, a way of the first obtaining module 520 obtaining the address information of a corresponding persistent connection server will be introduced. First, the first obtaining module 520 sends an address request message carrying the identification information of the first client 500 to a persistent connection allocation server. After receiving the address request message, the persistent connection allocation server verifies the identification information carried by it, and then returns a response message to the first obtaining module 520 according to the identification information. Therein, in the response message returned by the persistent connection allocation server is carried the address information of a persistent connection server corresponding to the first client 500.

In the embodiment of the invention, the first client 500 searches for the address information of a corresponding persistent connection server by a persistent connection allocation server. The persistent connection allocation server returns different persistent connection server addresses to individual clients according to identification information of clients on different terminals, which ensures that synchronization of information between different clients is more rapid and timely. In addition, the first client 500 and the second client search for a corresponding persistent connection server by the same identification information, which ensures that data of a client of a specified user is sent to a client of other terminal of the same user, and avoids that data sending of a client of the user is confused. After the first obtaining module 520 in the first client 500 obtains the address information of the corresponding persistent connection server, a connection establishment module 530 establishes a persistent connection with the persistent connection server according to the address information, and sends data of the user in the first client 500 to the second client via this persistent connection server.

In the embodiment of the invention, the identification information is identity verification information of a client, it may be identity verification information set by the user, or also may be identity verification information set for a client by a server, which will not be defined by the embodiment of the invention. Preferably, in an embodiment of the invention, the identification information may be account information of user login of the first client 500, the account information is an account which is applied by the user for registration in a client center, the application of the account information is simple and easy, and each piece of account information may be logged in on multiple clients.

Additionally, the identification information in the embodiment of the invention may also be a character string generated by a server, e.g., a shadow account, which can be taken as a unique identification. The shadow account may be a unique identification generated by the server according to information such as time, machine identification, etc. The shadow account may also be an account randomly generated by the server. After generating the account, the server checks whether the generated shadow account has already existed, and if yes, the server regenerates a shadow account, until the account did not exist before. The shadow account has nonrepeatability and uniqueness, and each shadow account can only identify one client.

In the embodiment of the invention, the first client 500 and/or the second client may be any clients of the same type, such as a browser client, a security guard client, a reader client, a media player client, or also may be clients of different types, but which implement the same function, which will not be defined by the embodiment of the invention. The first, second herein are only used for differentiating different clients, they do not result in definition of clients' own attributes, order and functions, and the first, second may be interchanged to refer to different clients.

Preferably, in an embodiment of the invention, the first client 500 and/or the second client is/are a browser client. A user generally performs on a browser client personalized operations of collecting network addresses, setting commonly used webpages, etc. When the user turns from one terminal to another terminal, he needs to newly enable a new client on another terminal. According to the embodiment of the invention, the personalized operations set by the user on the former client may be automatically synchronized to the newly enabled client, and it is unnecessary for the user to repeat the operations.

Similarly, in the embodiment of the invention, data of the first client 500 may be data of any operation which is performed by a user in the first client 500, or also may be other data updated by the first client 500, data stored in the first client 500, etc., which will not be defined by the embodiment of the invention in any way. Preferably, in an embodiment of the invention, the data may comprise individual network addresses collected in the favorites of the first client 500, a network address currently opened by the first client 500, commonly used network addresses of the first client 500, and any user data invoked by the first client 500 according to a user instruction, etc. Any data of the first client 500 may be sent to the second client, which ensures that various operations performed by a user in the first client 500 may be synchronously updated to the second client, avoids that the user performs repetitive operations and obtains repetitive information in a new client, and further avoids data redundancy and resource waste.

In an embodiment of the invention, in addition to client data transmission between different terminals mentioned above, client data transmission between a mobile terminal and a terminal can be further accomplished. Therefore, in an embodiment of the invention, the first terminal and the second terminal may be a terminal such as a desktop computer, a notebook computer, etc., or also may be a mobile terminal such as a mobile phone, a music player, a tablet computer, etc. Preferably, in an embodiment of the invention, the second terminal is a mobile terminal, in order that client data transmission between a terminal and a mobile terminal is more clearly and briefly elucidated.

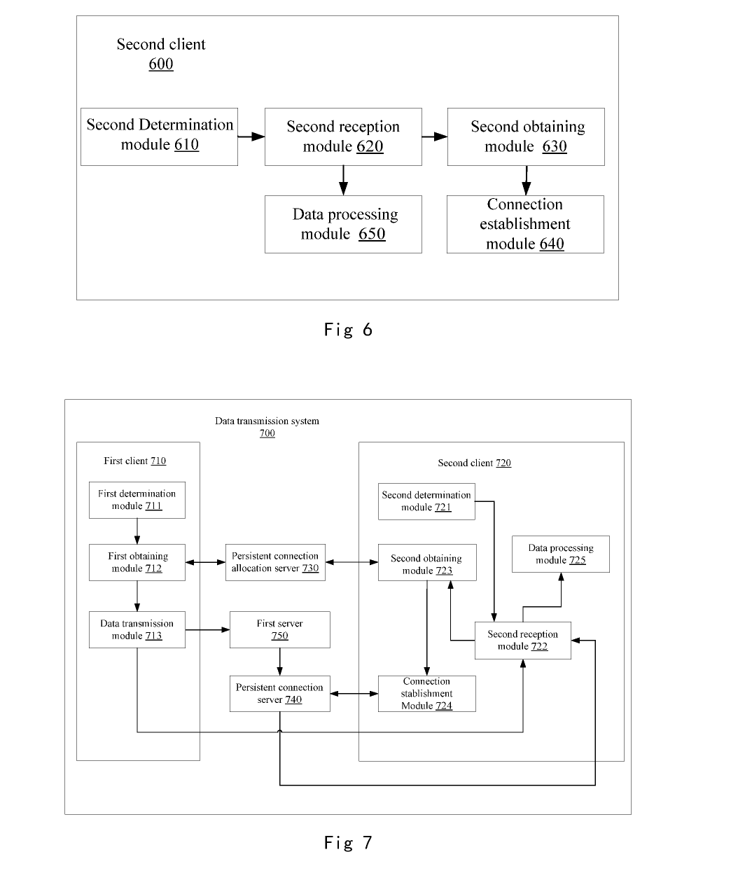

FIG. 6 shows a structural schematic diagram of another client according to an embodiment of the invention. In order to elaborate the embodiment of the invention more clearly and concisely, in the following, another client for data transmission will be abbreviated as a second client disposed in a second terminal. Referring to FIG. 6, the second client 600 comprises at least: a second determination module 610, a second reception module 620, a second obtaining module 630, a connection establishment module 640 and a data processing module 650.

Now, functions of individual devices or components and a connection relationship between individual parts of the second client 600 will be introduced. After the second determination module 610 in the second client 600 determines that the establishment of a connection with the second terminal 600 by a first terminal is finished, the second reception module 620 receives identification information sent by a first client. After the second reception module 620 receives the identification information of the first client, the second obtaining module 630 is triggered directly.

The second obtaining module 630 searches for address information of a corresponding persistent connection server according to the identification information of the first client. After finding the address information of the corresponding persistent connection server, the second obtaining module 630 triggers the connection establishment module 640. The connection establishment module 640 establishes a persistent connection between the second client 600 and the corresponding persistent connection server according to the obtained address information of the persistent connection server, such that the second client 600 receives data from the corresponding persistent connection server.

According to the embodiment of the invention, utilizing the identification information, the second client 600 can establish a persistent connection with a corresponding persistent connection server, so as to receive data from the persistent connection server, which solves the problem of information sharing between the first client and the second client 600, and further solves the repetition of performing operations desired by a user and the repetition of obtaining information in a new client, thereby avoiding the time consumption of operations and the data redundancy of a different client, saving the user's time and improving the user's experience.

In particular, after the second reception module 620 receives the identification information of the first client, the second obtaining module 630 sends an address request message carrying the identification information to a persistent connection allocation server. The persistent connection allocation server receives the address request message, and returns a response message to the second obtaining module 630 according to the identification information carried by it. In the response message is carried address information of a persistent connection server corresponding to the second client 600. After the second obtaining module 630 receives the response message carrying the address information of the corresponding persistent connection server, the connection establishment module 640 is triggered. According to the address information returned by the persistent connection allocation server, the connection establishment module 640 establishes a persistent connection between the second client 600 and the persistent connection server corresponding to the address information, such that data is received from the persistent connection server.

When the persistent connection server receives data of the first client sent via a first server, the persistent connection server finds the second client 600 according to the identification information carried in the data of the first client, and queries about the state of a persistent connection between it and the second client 600. If the state of the persistent connection is connected, the persistent connection server sends the data of the first client to the second client 600. If the state of the persistent connection is disconnected, the data of the first client is stored in the persistent connection server, and then it is not until the state of the persistent connection between the persistent connection server and the second client 600 is recovered that the data of the first client stored in the persistent connection server is sent to the second client 600.

The second reception module 620 in the second client 600 receives the data of the first client sent via the persistent connection server, and then the data 650 is triggered. The data processor 650 performs corresponding processing according to the data of the first client to ensure that information sharing is realized between the first client and the second client 600, and operations of which the execution was not finished on the first client previously can continue to be performed on the second client, for example, continue to read content of a webpage.

In the embodiment of the invention, the identification information is identity verification information of a client, it may be identity verification information set by the user, or also may be identity verification information set for a client by a server, which will not be defined by the embodiment of the invention. Preferably, in an embodiment of the invention, the identification information may be account information of user login of the first client, the account information is an account which is applied by the user for registration in a client center, the application of the account information is simple and easy, and each piece of account information may be logged in on multiple clients.

Additionally, the identification information in the embodiment of the invention may also be a character string generated by a server, e.g., a shadow account, which can be taken as a unique identification. The shadow account may be a unique identification generated by the server according to information such as time, machine identification, etc. The shadow account may also be an account randomly generated by the server. After generating the account, the server checks whether the generated shadow account has already existed, and if yes, the server regenerates a shadow account, until the account did not exist before. The shadow account has nonrepeatability and uniqueness, and each shadow account can only identify one client.

In the embodiment of the invention, the first client and/or the second client 600 may be any clients of the same type, such as a browser client, a security guard client, a reader client, a media player client, or also may be clients of different types, but which implement the same function, which will not be defined by the embodiment of the invention. The first, second herein are only used for differentiating different clients, they do not result in definition of clients' own attributes, order and functions, and the first, second may be interchanged to refer to different clients.

Preferably, in an embodiment of the invention, the first client and/or the second client 600 is/are a browser client. A user generally performs on a browser client personalized operations of collecting network addresses, setting commonly used webpages, etc. When the user turns from one terminal to another terminal, he needs to newly enable a new client on another terminal. According to the embodiment of the invention, the personalized operations set by the user on the former client may be automatically synchronized to the newly enabled client, and it is unnecessary for the user to repeat the operations.

Similarly, in the embodiment of the invention, data received by the second client 600 may be data of any operation which is performed by a user in the first client, or also may be other data updated by the first client, data stored in the first client, etc., which will not be defined by the embodiment of the invention in any way. Preferably, in an embodiment of the invention, the data may comprise individual network addresses collected in the favorites of the first client, a network address currently opened by the first client, commonly used network addresses of the first client, and any user data invoked by the first client according to a user instruction, etc.

In addition, in the embodiment of the invention, the processing performed by the second client 600 according to the received data of the first client may be to perform corresponding processing on the second client 600 itself according to the data of the first client, or also may be to perform processing on the received data of the first client. Preferably, in an embodiment of the invention, the processing performed by the second client 600 according to the data of the first client comprises that the second client 600 updates the favorites, the second client 600 updates commonly used network addresses, and the second client 600 opens a webpage corresponding to a network address, and so on.

In the embodiment of the invention, any data of the first client may be sent to the second client 600, which ensures that various operations performed by a user in the first client may be synchronously updated to the second client 600, avoids that the user performs repetitive operations and obtains repetitive information in a new client, and further avoids data redundancy and resource waste.

In an embodiment of the invention, in addition to client data transmission between different terminals mentioned above, client data transmission between a mobile terminal and a terminal can be further accomplished. Therefore, in an embodiment of the invention, the first terminal and the second terminal may be a terminal such as a desktop computer, a notebook computer, etc., or also may be a mobile terminal such as a mobile phone, a music player, a tablet computer, etc. Preferably, in an embodiment of the invention, the second terminal is a mobile terminal, in order that client data transmission between a terminal and a mobile terminal is more clearly and briefly elucidated.

FIG. 7 shows a structural schematic diagram of a data transmission system according to an embodiment of the invention. As shown in FIG. 7, the data transmission system 700 in the embodiment of the invention comprises a first client 710 disposed in a first terminal, a second client 720 disposed in a second terminal, a persistent connection allocation server 730, a persistent connection server 740 and a first server 750 corresponding to the first client 710.

Now, functions of individual devices or components and a connection relationship between individual parts in the data transmission system 700 of the embodiment of the invention will be introduced. In the first client 710, a first determination module 711 determines that the first terminal has already established a connection with the second terminal, then a first obtaining module 712 coupled with the first determination module 711 obtains the client's own identification information, and a data transmission module 713 coupled with the first obtaining module 712 transmits the identification information to the second terminal.

In particular, the first obtaining module 712 sends an address request message carrying the identification information to the persistent connection allocation server 730, the persistent connection allocation server 730 verifies the identification information carried by the address request information after receiving the address request information, and then returns a response message carrying the address information of a persistent connection server 740 to the first obtaining module 712. In addition, the first obtaining module 712 can obtain data in the first client 710. The data transmission module 713 coupled with the first obtaining module 712 transmits the data obtained by the first obtaining module 712 to the corresponding persistent connection server 740 via the first server 750. There is a persistent connection between the persistent connection server 740 and the second client 720, and then the data in the first client 710 is sent by the persistent connection server 740 to the second client 720 which establishes a persistent connection with it.

In the data transmission system 700, according to the identification information of the first client 710 received by a second reception module 720, a second obtaining module 723 directly sends an address request message carrying the identification information to the persistent connection allocation server 730. After receiving the address request message, the persistent connection allocation server 730 returns a response message carrying address information. The second obtaining module 723 receives the response message carrying the address information. Further, a connection establishment module 724 in the second client 720 establishes a connection with a persistent connection server according to the obtained address information of the persistent connection server.

After the establishment of the connection is successful, data may be transmitted between the first client 710 and the second client 720. At this point, the first client 710 may transmit data of the first client 710 to the persistent connection server 740 via the first server 750. Then, the persistent connection server 740 transmits the data of the first client to the second client 720. A data processing module 725 of the second client 720 processes the data.

According to the embodiment of the invention, identification information of the first client can be sent to the second client, and data transmission from the first client to the second client is achieved, which solves the problem mentioned in the prior art that data transmission can not be conducted between clients, and further solves the problem that since data transmission can not be conducted between different clients, user requirements must be re-introduced when a new client is enabled, thereby resulting in resource waste and low efficiency.

In addition, according to the embodiment of the invention, utilizing the identification information, the second client can establish a persistent connection with a corresponding persistent connection server, so as to receive data from the persistent connection server, which solves the problem of information sharing between the first client and the second client, and further solves the repetition of performing operations desired by a user and the repetition of obtaining information in a new client, thereby avoiding the time consumption of operations and the data redundancy of a different client, saving the user's time and improving the user's experience.

In the embodiment of the invention, the identification information is identity verification information of a client, it may be identity verification information set by the user, or also may be identity verification information set for a client by a server, which will not be defined by the embodiment of the invention. Preferably, in an embodiment of the invention, the identification information may be account information of user login of the first client, the account information is an account which is applied by the user for registration in a client center, the application of the account information is simple and easy, and each piece of account information may be logged in on multiple clients.

Additionally, the identification information in the embodiment of the invention may also be a character string generated by a server, e.g., a shadow account, which can be taken as a unique identification. The shadow account may be a unique identification generated by the server according to information such as time, machine identification, etc. The shadow account may also be an account randomly generated by the server. After generating the account, the server checks whether the generated shadow account has already existed, and if yes, the server regenerates a shadow account, until the account did not exist before. The shadow account has nonrepeatability and uniqueness, and each shadow account can only identify one client.

In the embodiment of the invention, the first client and/or the second client may be any clients of the same type, such as a browser client, a security guard client, a reader client, a media player client, or also may be clients of different types, but which implement the same function, which will not be defined by the embodiment of the invention. The first, second herein are only used for differentiating different clients, they do not result in definition of clients' own attributes, order and functions, and the first, second may be interchanged to refer to different clients.

Preferably, in an embodiment of the invention, the first client and/or the second client is/are a browser client. A user generally performs on a browser client personalized operations of collecting network addresses, setting commonly used webpages, etc. When the user turns from one terminal to another terminal, he needs to newly enable a new client on another terminal. According to the embodiment of the invention, the personalized operations set by the user on the former client may be automatically synchronized to the newly enabled client, and it is unnecessary for the user to repeat the operations.

Similarly, in the embodiment of the invention, data of the first client may be data of any operation which is performed by a user in the first client, or also may be other data updated by the first client, data stored in the first client, etc., which will not be defined by the embodiment of the invention in any way. Preferably, in an embodiment of the invention, the data may comprise individual network addresses collected in the favorites of the first client, a network address currently opened by the first client, commonly used network addresses of the first client, and any user data invoked by the first client according to a user instruction, etc.

In addition, in the embodiment of the invention, the processing performed by the second client according to the received data of the first client may be to perform corresponding processing on the second client itself according to the data of the first client, or also may be to perform processing on the received data of the first client. Preferably, in an embodiment of the invention, the processing performed by the second client according to the data of the first client comprises that the second client updates the favorites, the second client updates commonly used network addresses, and the second client opens a webpage corresponding to a network address, and so on.

In the embodiment of the invention, any data of the first client may be sent to the second client, which ensures that various operations performed by a user in the first client may be synchronously updated to the second client, avoids that the user performs repetitive operations and obtains repetitive information in a new client, and further avoids data redundancy and resource waste.

In an embodiment of the invention, in addition to client data transmission between different terminals mentioned above, client data transmission between a mobile terminal and a terminal can be further accomplished. Therefore, in an embodiment of the invention, the first terminal and the second terminal may be a terminal such as a desktop computer, a notebook computer, etc., or also may be a mobile terminal such as a mobile phone, a music player, a tablet computer, etc. Preferably, in an embodiment of the invention, the second terminal is a mobile terminal, in order that client data transmission between a terminal and a mobile terminal is more clearly and briefly elucidated.

According to any of the above preferred embodiments or a combination of multiple preferred embodiments, an embodiment of the invention can achieve the following beneficial effects:

According to the embodiment of the invention, identification information of the first client can be sent to the second client, and data transmission from the first client to the second client is achieved, which solves the problem mentioned in the prior art that data transmission can not be conducted between clients, and further solves the problem that since data transmission can not be conducted between different clients, user requirements must be re-introduced when a new client is enabled, thereby resulting in resource waste and low efficiency.

In addition, according to the embodiment of the invention, utilizing the identification information, the second client can establish a persistent connection with a corresponding persistent connection server, so as to receive data from the persistent connection server, which solves the problem of information sharing between the first client and the second client, and further solves the repetition of performing operations desired by a user and the repetition of obtaining information in a new client, thereby avoiding the time consumption of operations and the data redundancy of a different client, saving the user's time and improving the user's experience.

In the embodiment of the invention, the second client receives data of the first client via a persistent connection server, wherein the second client first requests the address information of a corresponding persistent connection server from a persistent connection allocation server. The persistent connection allocation server returns an address of a different persistent connection server to an individual client according to identification information of different clients, which ensures that the synchronization of information between the same clients of different terminals is more rapid and timely. In addition, in the embodiment of the invention, an online device list stored in the persistent connection server can be updated in real time, which ensures that the persistent connection server can timely update information of clients which establish persistent connections with it, avoids that data is sent to a disconnected client since the data update of the online device list is not in time and a malignant consequence such as packet loss, etc. is caused, and improves the security of data transmission.

### Embodiment 2

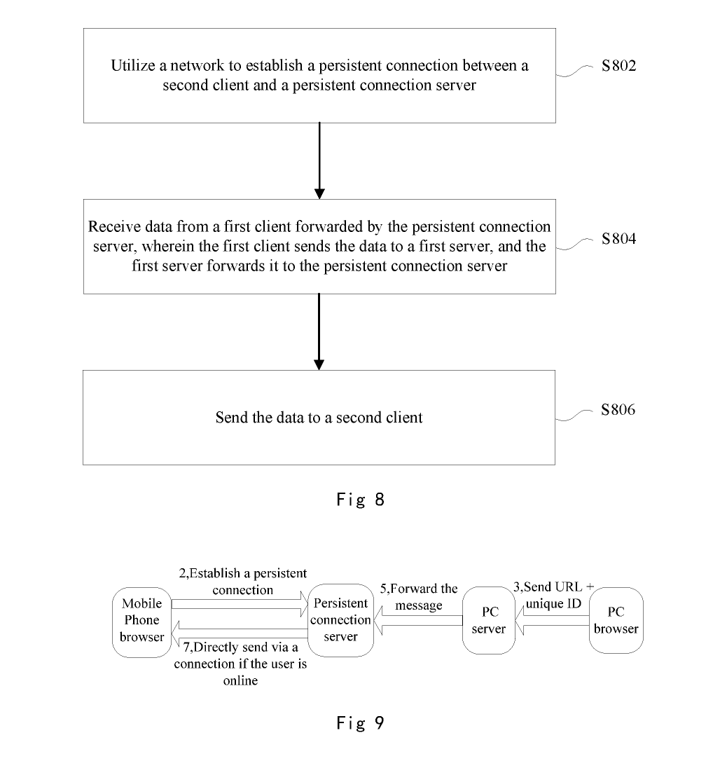

To solve the above technical problems, an embodiment of the invention provides yet another data transmission method, in which a connection is accomplished between different terminals via a wireless mode (e.g., a network). FIG. 8 shows a processing flow chart of yet another data transmission method according to an embodiment of the invention. As shown in FIG. 8, the flow begins at step S802 in which a network is utilized to establish a persistent connection between a second client and a persistent connection server. After the establishment of a persistent connection between the second client and the persistent connection server is successful, step S804 is performed to receive data from a first client forwarded by the persistent connection server.

According to the embodiment of the invention, data of the first client can be sent to the second client, which solves the problem mentioned in the prior art that data transmission can not be conducted between clients, further solves the problems that since data transmission can not be conducted between different clients, user requirements must be re-introduced when a new client is enabled, performing operations desired by a user is repeated and obtaining information is repeated in a new client, thereby resulting in resource waste and low efficiency, avoids the time consumption of operations and the data redundancy of a different client, saves the user's time and improves the user's experience.

In particular, in transmission of data to the second client by the first client, it needs to be routed and forwarded via a server, etc. Reference is made to the step S804 in FIG. 8, in which the first client sends data to a first server, and the first server forwards the data of the first client to the persistent connection server. After receiving the data sent by the first client, the first server first performs legality verification on the data of the first client. Preferably, in an embodiment of the invention, the first server verifies identification information of the first client in the data to determine whether the identification information of the first client is legal information, for example, to verify whether the identification information has been registered in a client center, or the identification information is an identifier generated inside the server. If the identification information is verified to be legal information, the first server transmits the identification information to the persistent connection server, and if the identification information is not legal information, the first server refuses to send the identification information to the persistent connection server.

Likewise, the first server may further perform legality verification on other data than the identification information in the data, for example, verify whether webpage data, etc. of the first client is non-malicious data. In an embodiment of the invention, the malicious data refers to a virus, Trojan, etc. which performs an illegal action of steal, destruction, etc. on data in a user terminal. If the first server verifies that the data of the first client is the above-mentioned malicious data, the first server may refuse to transmit the malicious data to the persistent connection server, or may also prompt the persistent connection server that the data might contain malicious data when transmitting it to the persistent connection server, and in turn when transmitting the data to the second client, the persistent connection server prompts a user that the data received by the second client might contain malicious data. The second client selects whether to receive the data that might contain malicious data according to an instruction of the user. In addition, if it is verified by the first server that the data of the first client is non-malicious data, the first server transmits the data to the persistent connection server.

Preferably, in an embodiment of the invention, after legality verification is performed on the data of the first client, the first server may further perform encryption processing on the data of the first client, which more effectively improves the security of data transmission. By performing security verification and processing on the data of the first client by the first server, the security of data transmission can be guaranteed more effectively, avoiding that in the procedure of data transmission, some malicious network addresses, etc. are attached to the transmitted data and cause damage to a terminal or client of a user.

After performing legality verification on the data of the first client, the first server sends the data on which legality verification has been performed to a corresponding persistent connection server. The first server may communicate with the persistent connection server by multiple protocols, for example, the transmission control protocol, the user datagram protocol, etc. Preferably, in an embodiment of the invention, the first server communicates with the persistent connection server by an HTTP request. The HTTP supports multiple server modes and is simple and fast, and therefore communication by an HTTP request can improve the efficiency of data transmission.

After receiving the data of the first client forwarded by the first server, the persistent connection server forwarded the data to the second client. Before receiving the data of the first client from the persistent connection server, the second client first searches for the address information of the persistent connection server, and establishes a persistent connection with the corresponding persistent connection server according to the address information.

Now, a specific way in which the second client searches for the address information of the persistent connection server will be introduced. The second client sends an address request message carrying the identification information of the first client to a persistent connection allocation server, and after receiving the address request message, the persistent connection allocation server determines a corresponding persistent connection server according to the identification information carried by it, and returns a response message carrying the address information of the corresponding persistent connection server to the second client.

According to the found address information of the persistent connection server, the second client performs the step S802 to establish a persistent connection with the persistent connection server utilizing a network. It is worth noting that if at least two pieces of address information are carried in the response message returned by the persistent connection allocation server, the second client may select one piece of the address information as the address information of a persistent connection server to be connected according to a preset policy, and establishes a persistent connection with the corresponding persistent connection server. Which piece of the address information is particularly selected depends on the actual situation. The preset policy herein is just a method, step or policy for selecting address information, for example, it may be a random selection policy, or also may be a sequential selection policy. It may be further possible to determine the preset policy according to information related with the second client, to select address information, for example, to select address information according to a way of connection with the second client, or to select address information according to the size of the bandwidth of data transmission to and from the second client, or the like.

In the embodiment of the invention, the network comprises a wired network and a wireless network. Preferably, in an embodiment of the invention, the wireless network comprises any one of or a combination of several of Wifi, 2G\3G\4G. The mentioned wireless networks are all ones which are widely employed currently, and can conduct transmission of data (e.g., identification information or a webpage address) rapidly and efficiently.

After the second client establishes a persistent connection with the corresponding persistent connection server successfully, an online device list is stored in the persistent connection server, and the list records identification information of individual clients which maintain persistent connections with the persistent connection server. If the persistent connection between a certain client and the persistent connection server is disconnected, the identification information corresponding to the disconnected client is deleted in the online device list of the persistent connection server. The real-time update of the online device list in the persistent connection server ensures that the persistent connection server can timely update information on clients which establish persistent connections with it, avoids that data is sent to a disconnected client since the data update of the online device list is not in time and a malignant consequence such as packet loss, etc. is caused, and improves the security of data transmission.

When the persistent connection server receives data of the first client sent via the first server, the persistent connection server finds the second client according to the identification information carried in the data of the first client, and determines the state of the persistent connection between it and the second client according to information recorded in the online device list. If the state of the persistent connection is connected, the persistent connection server sends the data of the first client to the second client. If the state of the persistent connection is disconnected, the data of the first client is stored in the persistent connection server, and then it is not until the state of the persistent connection between the persistent connection server and the second client turns from disconnected to connected that the data of the first client stored in the persistent connection server is sent to the second client. The persistent connection server stores data that can not be transmitted to the second client in time, which can equally avoid the malignant consequence of packet loss and ensure that the data of the first client is sent to the second client.

After receiving the data sent by the persistent connection server, the second client performs corresponding processing according to the data. By performing corresponding processing on the received data of the first client by the second client, it is ensured that information sharing is realized between the first client and the second client, and operations of which the execution was not finished on the first client previously can continue to be performed on the second client, for example, continue to read content of a webpage.

In the embodiment of the invention, the identification information is identity verification information of a client, it may be identity verification information set by the user, or also may be identity verification information set for a client by a server, which will not be defined by the embodiment of the invention. Preferably, in an embodiment of the invention, the identification information may be account information of user login of the first client, the account information is an account which is applied by the user for registration in a client center, the application of the account information is simple and easy, and each piece of account information may be logged in on multiple clients. Additionally, the identification information in the embodiment of the invention may also be a character string generated by a server, e.g., a shadow account, which can be taken as a unique identification. The shadow account may be a unique identification generated by the server according to information such as time, machine identification, etc. The shadow account may also be an account randomly generated by the server. After generating the account, the server checks whether the generated shadow account has already existed, and if yes, the server regenerates a shadow account, until the account did not exist before. The shadow account has nonrepeatability and uniqueness, and each shadow account can only identify one client.

In the embodiment of the invention, the first client and/or the second client may be any clients of the same type, such as a browser client, a security guard client, a reader client, a media player client, or also may be clients of different types, but which implement the same function, which will not be defined by the embodiment of the invention. The first, second herein are only used for differentiating different clients, they do not result in definition of clients' own attributes, order and functions, and the first, second may be interchanged to refer to different clients.

Preferably, in an embodiment of the invention, the first client and/or the second client is/are a browser client. A user generally performs on a browser client personalized operations of collecting network addresses, setting commonly used webpages, etc. When the user turns from one terminal to another terminal, he needs to newly enable a new client on another terminal. According to the embodiment of the invention, the personalized operations set by the user on the former client may be automatically synchronized to the newly enabled client, and it is unnecessary for the user to repeat the operations.

In the embodiment of the invention, any data of the first client may be sent to the second client, which ensures that various operations performed by a user in the first client may be synchronously updated to the second client, avoids that the user performs repetitive operations and obtains repetitive information in a new client, and further avoids data redundancy and resource waste.

In an embodiment of the invention, if the first client is disposed in a first terminal and the second client is disposed in a second terminal, client data transmission between different terminals may be implemented, and client data transmission between a mobile terminal and a terminal can be further accomplished. Therefore, in an embodiment of the invention, the first terminal and the second terminal may be a terminal such as a desktop computer, a notebook computer, etc., or also may be a mobile terminal such as a mobile phone, a music player, a tablet computer, etc. Preferably, in an embodiment of the invention, the second terminal is disposed in a mobile terminal, in order that client data transmission between a terminal and a mobile terminal is more clearly and briefly elucidated.

### Embodiment 2.1

FIG. 9 shows a flow chart of a data transmission method according to a preferred embodiment of the invention, which is used for supporting the data transmission method provided in embodiment 2 and elaborating the data transmission method more clearly. As shown in FIG. 9, in this example, a PC is selected as the terminal, a mobile phone is the mobile terminal, and the clients are browser clients. For the convenience of identifying the first client and the second client, in this example, the first client is called a PC browser, the second client is called a mobile phone browser, and the identification information is called a unique ID.

In FIG. 9, a pathway in which data transmission can be conducted has already been established between the PC browser and the mobile phone browser and a unique ID is saved in them respectively. With reference to FIG. 9, when connected with a network the first time, the mobile phone browser requests the address of a persistent connection server from a persistent connection allocation server, the mobile phone browser arbitrarily selects one piece of address information from the address information returned by the persistent connection allocation server, and as shown at step 2 in FIG. 9, utilizes the network to automatically establish a persistent connection with a corresponding persistent connection server. When establishing a persistent connection with a persistent connection server, the mobile phone browser sends a unique ID to the persistent connection server. An online device list in the persistent connection server identifies the user of the mobile phone browser corresponding to the unique ID as being online.

Referring to step 3 in FIG. 9, the PC browser sends a unique ID and its own data (e.g., a webpage address) to a PC server. After receiving the data of the PC browser, the PC server first verifies the data of the PC browser, comprising verifying that the unique ID is legal, namely, verifying that the unique ID is an ID that has already been registered in the system, and verifying that data of other PC browsers is non-malicious data. For example, by sending a network address to a network shield server, it is verified that the network address is a non-malicious network address. After verifying the data of the PC browser, the PC server forwards the data for which legality verification has been conducted to the persistent connection server by way of HTTP communication. After receiving the data from the PC server, the persistent connection server performs step 7 in FIG. 9 to find whether a corresponding mobile phone browser is online according to the online device list stored in the persistent connection server, and if yes, the persistent connection server sends the data of the PC browser via a persistent connection between it and the mobile phone browser, and if no, the persistent connection server stores the data from the PC server, and will not send the data to the mobile phone browser until the persistent connection between it and the mobile phone browser is recovered.

After receiving the data sent by the persistent connection server, the mobile phone browser performs corresponding processing according to the data to ensure that information sharing is realized between the first client and the second client, and operations of which the execution was not finished on the first client previously can continue to be performed on the second client, for example, continue to read content of a webpage.

On the basis of the data transmission methods provided in the above individual preferred embodiments and based on the same concept, an embodiment of the invention provides yet another client for data transmission, which is used for implementing the data transmission method provided in embodiment 2.

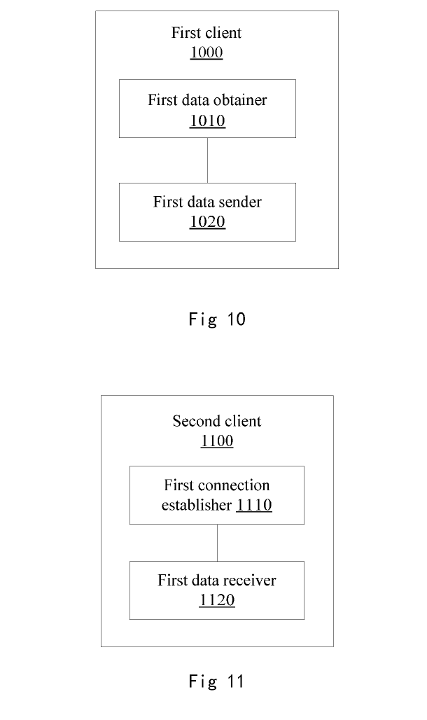

FIG. 10 shows a structural schematic diagram of a client according to an embodiment of the invention. In order to elaborate the embodiment of the invention more clearly and briefly, in the following, the client for data transmission is abbreviated as a first client. Referring to FIG. 10, the first client 1000 of the embodiment of the invention comprises at least: a first data obtainer 1010 and a first data sender 1020.

Now, functions of individual devices or components and a connection relationship between individual parts of the first client 1000 in a data transmission device of the embodiment of the invention will be introduced. In the first client 1000, the first data obtainer 1010 can obtain the client's own identification information, and then the first data sender 1020 coupled with the first data obtainer 1010 transmits the identification information to a second terminal.

According to the embodiment of the invention, data of the first client 1000 can be sent to a second client, which solves the problem mentioned in the prior art that data transmission can not be conducted between clients, further solves the problems that since data transmission can not be conducted between different clients, user requirements must be re-introduced when a new client is enabled, performing operations desired by a user is repeated and obtaining information is repeated in a new client, thereby resulting in resource waste and low efficiency, avoids the time consumption of operations and the data redundancy of a different client, saves the user's time and improves the user's experience.

In particular, in the embodiment of the invention, identification information can be transmitted between the first client 1000 and the second client, namely, a channel where data transmission can be conducted has already been established between the first client 1000 and the second client, for example via a data line connection. Therefore, after the transmission of the identification information to the second client, the first data obtainer 1010 may further obtain data in the first client 1000, and then the data in the first client 1000 is transmitted by the first data sender 1020 to the second client. Unlike direct transmission of the identification information, in transmission of data in the first client 1000 to the second client, it may be routed and forwarded via a server, etc.

After the first data obtainer 1010 obtains data in the first client 1000, the first data sender 1020 transmits the obtained data to a first server, and the first server here is a server corresponding to the first terminal 1000. For example, if the first terminal is a PC, the first server is a PC server. After receiving the data from the first client 1000, the first server transmits it to a persistent connection server which has a persistent connection with the second client, and the persistent connection server transmits the data of the first client 1000 to the second client.

It can be seen from above that when data is transmitted from the first client 1000 to the second client, it needs to pass through a corresponding persistent connection server. The address information of the persistent connection server needs to be obtained by the first data obtainer 1010 in the first client 1000 according to the identification information of the first client 1000. Now, a way of the first data obtainer 1010 obtaining the address information of a corresponding persistent connection server will be introduced. First, the first data obtainer 1010 sends an address request message carrying the identification information of the first client 1000 to a persistent connection allocation server. After receiving the address request message, the persistent connection allocation server verifies the identification information carried by it, and then returns a response message to the first data obtainer 1010 according to the identification information. Therein, in the response message returned by the persistent connection allocation server is carried the address information of a persistent connection server corresponding to the first client 1000.

In the embodiment of the invention, the first client 1000 searches for the address information of a corresponding persistent connection server by a persistent connection allocation server. The persistent connection allocation server returns different persistent connection server addresses to individual clients according to identification information of clients on different terminals, which ensures that synchronization of information between different clients is more rapid and timely. In addition, the first client 1000 and the second client search for a corresponding persistent connection server by the same identification information, which ensures that data of a client of a specified user is sent to a client of other terminal of the same user, and avoids that data sending of a client of the user is confused. After the first data obtainer 1010 in the first client 1000 obtains the address information of the corresponding persistent connection server, a connection establishment module 10100 establishes a persistent connection with the persistent connection server according to the address information, and sends data of the user in the first client 1000 to the second client via this persistent connection server.

In the embodiment of the invention, the identification information is identity verification information of a client, it may be identity verification information set by the user, or also may be identity verification information set for a client by a server, which will not be defined by the embodiment of the invention. Preferably, in an embodiment of the invention, the identification information may be account information of user login of the first client 1000, the account information is an account which is applied by the user for registration in a client center, the application of the account information is simple and easy, and each piece of account information may be logged in on multiple clients.

Additionally, the identification information in the embodiment of the invention may also be a character string generated by a server, e.g., a shadow account, which can be taken as a unique identification. The shadow account may be a unique identification generated by the server according to information such as time, machine identification, etc. The shadow account may also be an account randomly generated by the server. After generating the account, the server checks whether the generated shadow account has already existed, and if yes, the server regenerates a shadow account, until the account did not exist before. The shadow account has nonrepeatability and uniqueness, and each shadow account can only identify one client.

In the embodiment of the invention, the first client 1000 and/or the second client may be any clients of the same type, such as a browser client, a security guard client, a reader client, a media player client, or also may be clients of different types, but which implement the same function, which will not be defined by the embodiment of the invention. The first, second herein are only used for differentiating different clients, they do not result in definition of clients' own attributes, order and functions, and the first, second may be interchanged to refer to different clients.

Preferably, in an embodiment of the invention, the first client 1000 and/or the second client is/are a browser client. A user generally performs on a browser client personalized operations of collecting network addresses, setting commonly used webpages, etc. When the user turns from one terminal to another terminal, he needs to newly enable a new client on another terminal. According to the embodiment of the invention, the personalized operations set by the user on the former client may be automatically synchronized to the newly enabled client, and it is unnecessary for the user to repeat the operations.

Similarly, in the embodiment of the invention, data of the first client 1000 may be data of any operation which is performed by a user in the first client 1000, or also may be other data updated by the first client 1000, data stored in the first client 1000, etc., which will not be defined by the embodiment of the invention in any way. Preferably, in an embodiment of the invention, the data may comprise individual network addresses collected in the favorites of the first client 1000, a network address currently opened by the first client 1000, commonly used network addresses of the first client 1000, and any user data invoked by the first client 1000 according to a user instruction, etc. Any data of the first client 1000 may be sent to the second client, which ensures that various operations performed by a user in the first client 1000 may be synchronously updated to the second client, avoids that the user performs repetitive operations and obtains repetitive information in a new client, and further avoids data redundancy and resource waste.

In an embodiment of the invention, if the first client is disposed in a first terminal and the second client is disposed in a second terminal, client data transmission between different terminals may be implemented, and client data transmission between a mobile terminal and a terminal can be further accomplished. Therefore, in an embodiment of the invention, the first terminal and the second terminal may be a terminal such as a desktop computer, a notebook computer, etc., or also may be a mobile terminal such as a mobile phone, a music player, a tablet computer, etc. Preferably, in an embodiment of the invention, the second terminal is disposed in a mobile terminal, in order that client data transmission between a terminal and a mobile terminal is more clearly and briefly elucidated.

FIG. 11 shows a structural schematic diagram of another client according to an embodiment of the invention. In order to elaborate the embodiment of the invention more clearly and briefly, in the following, another client for data transmission is abbreviated as a second client. Referring to FIG. 11, the second client 1100 comprises at least: a first connection establisher 1110 and a first data receiver 1120.

Now, functions of individual devices or components and a connection relationship between individual parts of the second client 1100 in a data transmission device of the embodiment of the invention will be introduced. The first connection establisher 1110 in the second client 1100 utilizes a network to establish a persistent connection with a persistent connection server. When the establishment of a persistent connection between the second client 1100 and the persistent connection server is successful, the first data receiver 1120 in the second client 1100 receives data of a first client forwarded by the persistent connection server.

According to the embodiment of the invention, data of the first client can be sent to the second client 1100, which solves the problem mentioned in the prior art that data transmission can not be conducted between clients, further solves the problems that since data transmission can not be conducted between different clients, user requirements must be re-introduced when a new client is enabled, performing operations desired by a user is repeated and obtaining information is repeated in a new client, thereby resulting in resource waste and low efficiency, avoids the time consumption of operations and the data redundancy of a different client, saves the user's time and improves the user's experience.

In particular, the first connection establisher 1110 sends an address request message carrying the identification information of the first client to a persistent connection allocation server, and after receiving the address request message, the persistent connection allocation server determines a corresponding persistent connection server according to the identification information carried by it, and returns a response message carrying the address information of the corresponding persistent connection server to the first connection establisher 1110.

The first connection establisher 1110 receives the response message returned by the persistent connection allocation server, and establishes a persistent connection with the corresponding persistent connection server according to the address information of the persistent connection server carried in the response message. In particular, if at least two pieces of address information are carried in the response message returned by the persistent connection allocation server, the first connection establisher 1110 selects one piece of the address information as the address information of a persistent connection server to be connected according to a preset policy, and establishes a persistent connection with the corresponding persistent connection server.

The first connection establisher 1110 utilizes a network to establish a persistent connection with the persistent connection server successfully according to the address information of the persistent connection server. In the embodiment of the invention, the network comprises a wired network and a wireless network. Preferably, in an embodiment of the invention, the wireless network comprises any one of or a combination of several of Wifi, 2G\3G\4G. The mentioned wireless networks are all ones which are widely employed currently, and can conduct transmission of data (e.g., identification information or a webpage address) rapidly and efficiently.

An online device list is stored in the persistent connection server, and the list records identification information of individual clients which maintain persistent connections with the persistent connection server. If the persistent connection between a certain client and the persistent connection server is disconnected, the identification information corresponding to the disconnected client is deleted in the online device list of the persistent connection server. After the first connection establisher 1110 in the second client 1100 establishes a persistent connection with the persistent connection server successfully, the second client 1100 is identified as being online in the online device list. The real-time update of the online device list in the persistent connection server ensures that the persistent connection server can timely update information on clients which establish persistent connections with it, avoids that data is sent to a disconnected client since the data update of the online device list is not in time and a malignant consequence such as packet loss, etc. is caused, and improves the security of data transmission.

When the persistent connection server receives data of the first client sent via a first server, the persistent connection server finds the second client 1100 according to the identification information carried in the data of the first client, and determines the state of the persistent connection between it and the second client 1100 according to information recorded in the online device list. If the state of the persistent connection is connected, the persistent connection server sends the data of the first client to the second client 1100. If the state of the persistent connection is disconnected, the data of the first client is stored in the persistent connection server, and then it is not until the state of the persistent connection between the persistent connection server and the second client 1100 turns from disconnected to connected that the data of the first client stored in the persistent connection server is sent to the second client 1100.

The first data receiver 1120 in the second client 1100 determines whether to receive the data of the first client according to the state of the persistent connection between the second client 1100 and the persistent connection server. A specific way is as follows. If the state of the persistent connection between the second client 1100 and the persistent connection server is disconnected, the first data receiver 1120 stops receiving data, and the first data receiver 1120 will not continue to receive the data of the first client from the persistent connection server, until the state of the persistent connection between the second client 1100 and the persistent connection server is recovered, and if the state of the persistent connection between the second client 1100 and the persistent connection server is connected, the first data receiver 1120 receives the data of the first client from the persistent connection server.

In the procedure of transmission of the data of the first client to the second client, first, the first server is utilized to perform legality verification on the data of the first client. Preferably, in an embodiment of the invention, the first server verifies identification information of the first client in the data to determine whether the identification information of the first client is legal information, for example, to verify whether the identification information has been registered in a client center, or the identification information is an identifier generated inside the server. If the identification information is verified to be legal information, the first server transmits the identification information to a persistent connection server, and if the identification information is not legal information, the first server refuses to send the identification information to the persistent connection server.

Likewise, the first server may further perform legality verification on other data than the identification information in the data, for example, verify whether webpage data, etc. of the first client is non-malicious data. In an embodiment of the invention, the malicious data refers to a virus, Trojan, etc. which performs an illegal action of steal, destruction, etc. on data in a user terminal. If the first server verifies that the data of the first client is the above-mentioned malicious data, the first server refuses to transmit the malicious data to the persistent connection server. If it is verified by the first server that the data of the first client is non-malicious data, the first server transmits the data to the persistent connection server.

After the persistent connection server receives the data of the first client which passes the legality verification, the first data receiver 1120 in the second client 1100 receives the data of the first client.

In the embodiment of the invention, the identification information is identity verification information of a client, it may be identity verification information set by the user, or also may be identity verification information set for a client by a server, which will not be defined by the embodiment of the invention. Preferably, in an embodiment of the invention, the identification information may be account information of user login of the first client, the account information is an account which is applied by the user for registration in a client center, the application of the account information is simple and easy, and each piece of account information may be logged in on multiple clients.

Additionally, the identification information in the embodiment of the invention may also be a character string generated by a server, e.g., a shadow account, which can be taken as a unique identification. The shadow account may be a unique identification generated by the server according to information such as time, machine identification, etc. The shadow account may also be an account randomly generated by the server. After generating the account, the server checks whether the generated shadow account has already existed, and if yes, the server regenerates a shadow account, until the account did not exist before. The shadow account has nonrepeatability and uniqueness, and each shadow account can only identify one client.

In the embodiment of the invention, the first client and/or the second client 1100 may be any clients of the same type, such as a browser client, a security guard client, a reader client, a media player client, or also may be clients of different types, but which implement the same function, which will not be defined by the embodiment of the invention. The first, second herein are only used for differentiating different clients, they do not result in definition of clients' own attributes, order and functions, and the first, second may be interchanged to refer to different clients.

Preferably, in an embodiment of the invention, the first client and/or the second client 1100 is/are a browser client. A user generally performs on a browser client personalized operations of collecting network addresses, setting commonly used webpages, etc. When the user turns from one terminal to another terminal, he needs to newly enable a new client on another terminal. According to the embodiment of the invention, the personalized operations set by the user on the former client may be automatically synchronized to the newly enabled client, and it is unnecessary for the user to repeat the operations.

Similarly, in the embodiment of the invention, data received by the second client 1100 may be data of any operation which is performed by a user in the first client, or also may be other data updated by the first client, data stored in the first client, etc., which will not be defined by the embodiment of the invention in any way. Preferably, in an embodiment of the invention, the data may comprise individual network addresses collected in the favorites of the first client, a network address currently opened by the first client, commonly used network addresses of the first client, and any user data invoked by the first client according to a user instruction, etc.

In addition, in the embodiment of the invention, the processing performed by the second client 1100 according to the received data of the first client may be to perform corresponding processing on the second client 1100 itself according to the data of the first client, or also may be to perform processing on the received data of the first client. Preferably, in an embodiment of the invention, the processing performed by the second client 1100 according to the data of the first client comprises that the second client 1100 updates the favorites, the second client 1100 updates commonly used network addresses, and the second client 1100 opens a webpage corresponding to a network address, and so on.

In the embodiment of the invention, any data of the first client may be sent to the second client 1100, which ensures that various operations performed by a user in the first client may be synchronously updated to the second client 1100, avoids that the user performs repetitive operations and obtains repetitive information in a new client, and further avoids data redundancy and resource waste.

In an embodiment of the invention, if the first client is disposed in a first terminal and the second client is disposed in a second terminal, client data transmission between different terminals may be implemented, and client data transmission between a mobile terminal and a terminal can be further accomplished. Therefore, in an embodiment of the invention, the first terminal and the second terminal may be a terminal such as a desktop computer, a notebook computer, etc., or also may be a mobile terminal such as a mobile phone, a music player, a tablet computer, etc. Preferably, in an embodiment of the invention, the second terminal is disposed in a mobile terminal, in order that client data transmission between a terminal and a mobile terminal is more clearly and briefly elucidated.

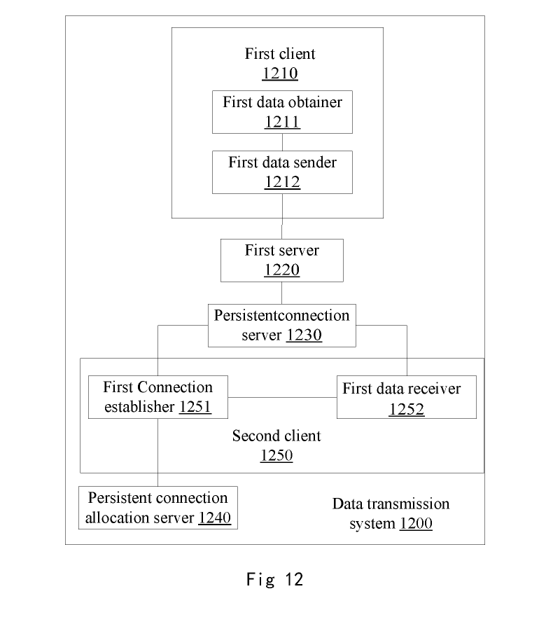

FIG. 12 shows a structural schematic diagram of a data transmission system according to an embodiment of the invention. As shown in FIG. 12, the data transmission system 1200 in the embodiment of the invention comprises a first client 1210, a first server 1220, a persistent connection server 1230, a persistent connection allocation server 1240 and a second client 1250.

Now, functions of individual devices or components and a connection relationship between individual parts in the data transmission system 1200 of the embodiment of the invention will be introduced. A first data obtainer 1211 in the first client 1210 obtains its own data, and triggers a first data sender 1212.

The first data sender 1212 sends data in the first client 1210 to the first server 1220. After receiving the data in the first client 1210, the first server 1220 first performs legality verification on the data in the first client 1210. Preferably, in an embodiment of the invention, the first server 1220 verifies identification information of the first client 1210 in the data to determine whether the identification information of the first client 1210 is legal information, for example, to verify whether the identification information has been registered in a client center, or the identification information is an identifier generated inside the server. If the identification information is verified to be legal information, the first server 1220 transmits the identification information to the persistent connection server 1230, and if the identification information is not legal information, the first server 1220 refuses to send the identification information to the persistent connection server 1230.

Likewise, the first server 1220 may further perform legality verification on other data than the identification information in the data, for example, verify whether webpage data, etc. of the first client 1210 is non-malicious data. In an embodiment of the invention, the malicious data refers to a virus, Trojan, etc. which performs an illegal action of steal, destruction, etc. on data in a user terminal. If the first server 1220 verifies that the data of the first client 1210 is the above-mentioned malicious data, the first server 1220 refuses to transmit the malicious data to the persistent connection server 1230, and if it is verified by the first server 1220 that the data of the first client 1210 is non-malicious data, the first server 1220 transmits the data to the persistent connection server 1230.

When the persistent connection server 1230 receives data of the first client 1210 sent via the first server 1220, the persistent connection server 1230 finds the second client 1250 according to the identification information carried in the data of the first client 1210, and determines the state of the persistent connection between it and the second client 1250 according to information recorded in an online device list. If the state of the persistent connection is connected, the persistent connection server 1230 sends the data of the first client 1210 to the second client 1250. If the state of the persistent connection is disconnected, the data of the first client 1210 is stored in the persistent connection server 1230, and then it is not until the state of the persistent connection between the persistent connection server 1230 and the second client 1250 turns from disconnected to connected that the data of the first client 1210 stored in the persistent connection server 530 is sent to the second client 1250.

Before receiving the data of the first client 1210 via the persistent connection server 1230, the second client 1250 first searches for the address information of the corresponding persistent connection server 1230 through the persistent connection allocation server 1240. A specific way is as follows. A first connection establisher 1251 sends an address request message carrying the identification information of the first client 1210 to the persistent connection allocation server 1240, and after receiving the address request message, the persistent connection allocation server determines a corresponding persistent connection server 1230 according to the identification information carried by it, and returns a response message carrying the address information of the corresponding persistent connection server 1230 to the first connection establisher 1251.

The first connection establisher 1251 receives the response message returned by the persistent connection allocation server 1240, and establishes a persistent connection with the corresponding persistent connection server 1230 according to the address information of the persistent connection server carried in the response message. In particular, if at least two pieces of address information are carried in the response message returned by the persistent connection allocation server 1240, the first connection establisher 1251 selects one piece of the address information as the address information of a persistent connection server 1230 to be connected according to a preset policy, and establishes a persistent connection with the corresponding persistent connection server 1230.

The first connection establisher 1251 utilizes a network to establish a persistent connection with the persistent connection server 1230 successfully according to the address information of the persistent connection server 1230. In the embodiment of the invention, the network comprises a wired network and a wireless network. Preferably, in an embodiment of the invention, the wireless network comprises any one of or a combination of several of Wifi, 2G\3G\4G. The mentioned wireless networks are all ones which are widely employed currently, and can conduct transmission of data (e.g., identification information or a webpage address) rapidly and efficiently.

After the second client 1250 establishes a persistent connection with the persistent connection server 1230 successfully, a first data receiver 1252 in the second client 1250 determines whether to receive the data of the first client 1210 according to the state of the persistent connection between the second client 1250 and the persistent connection server 1230. A specific way is as follows. If the state of the persistent connection between the second client 1250 and the persistent connection server 1230 is disconnected, the first data receiver 1252 stops receiving data, and the first data receiver 1252 will not continue to receive the data of the first client 1210 from the persistent connection server 1230, until the state of the persistent connection between the second client 1250 and the persistent connection server is recovered, and if the state of the persistent connection between the second client 1250 and the persistent connection server 1230 is connected, the first data receiver 1252 in the second client 1250 receives data from the persistent connection server 1230.

In the embodiment of the invention, the identification information is identity verification information of a client, it may be identity verification information set by the user, or also may be identity verification information set for a client by a server, which will not be defined by the embodiment of the invention. Preferably, in an embodiment of the invention, the identification information may be account information of user login of the first client, the account information is an account which is applied by the user for registration in a client center, the application of the account information is simple and easy, and each piece of account information may be logged in on multiple clients.

Additionally, the identification information in the embodiment of the invention may also be a character string generated by a server, e.g., a shadow account, which can be taken as a unique identification. The shadow account may be a unique identification generated by the server according to information such as time, machine identification, etc. The shadow account may also be an account randomly generated by the server. After generating the account, the server checks whether the generated shadow account has already existed, and if yes, the server regenerates a shadow account, until the account did not exist before. The shadow account has nonrepeatability and uniqueness, and each shadow account can only identify one client.

In the embodiment of the invention, the first client and/or the second client may be any clients of the same type, such as a browser client, a security guard client, a reader client, a media player client, or also may be clients of different types, but which implement the same function, which will not be defined by the embodiment of the invention. The first, second herein are only used for differentiating different clients, they do not result in definition of clients' own attributes, order and functions, and the first, second may be interchanged to refer to different clients.

Preferably, in an embodiment of the invention, the first client and/or the second client is/are a browser client. A user generally performs on a browser client personalized operations of collecting network addresses, setting commonly used webpages, etc. When the user turns from one terminal to another terminal, he needs to newly enable a new client on another terminal. According to the embodiment of the invention, the personalized operations set by the user on the former client may be automatically synchronized to the newly enabled client, and it is unnecessary for the user to repeat the operations.

Similarly, in the embodiment of the invention, data of the first client may be data of any operation which is performed by a user in the first client, or also may be other data updated by the first client, data stored in the first client, etc., which will not be defined by the embodiment of the invention in any way. Preferably, in an embodiment of the invention, the data may comprise individual network addresses collected in the favorites of the first client, a network address currently opened by the first client, commonly used network addresses of the first client, and any user data invoked by the first client according to a user instruction, etc.

In addition, in the embodiment of the invention, the processing performed by the second client according to the received data of the first client may be to perform corresponding processing on the second client itself according to the data of the first client, or also may be to perform processing on the received data of the first client. Preferably, in an embodiment of the invention, the processing performed by the second client according to the data of the first client comprises that the second client updates the favorites, the second client updates commonly used network addresses, and the second client opens a webpage corresponding to a network address, and so on.

In the embodiment of the invention, any data of the first client may be sent to the second client, which ensures that various operations performed by a user in the first client may be synchronously updated to the second client, avoids that the user performs repetitive operations and obtains repetitive information in a new client, and further avoids data redundancy and resource waste.

In an embodiment of the invention, if the first client is disposed in a first terminal and the second client is disposed in a second terminal, client data transmission between different terminals may be implemented, and client data transmission between a mobile terminal and a terminal can be further accomplished. Therefore, in an embodiment of the invention, the first terminal and the second terminal may be a terminal such as a desktop computer, a notebook computer, etc., or also may be a mobile terminal such as a mobile phone, a music player, a tablet computer, etc. Preferably, in an embodiment of the invention, the second terminal is disposed in a mobile terminal, in order that client data transmission between a terminal and a mobile terminal is more clearly and briefly elucidated.

According to any of the above preferred embodiments or a combination of multiple preferred embodiments, an embodiment of the invention can achieve the following beneficial effects:

According to the embodiment of the invention, data of the first client can be sent to the second client, which solves the problem mentioned in the prior art that data transmission can not be conducted between clients, further solves the problems that since data transmission can not be conducted between different clients, user requirements must be re-introduced when a new client is enabled, performing operations desired by a user is repeated and obtaining information is repeated in a new client, thereby resulting in resource waste and low efficiency, avoids the time consumption of operations and the data redundancy of a different client, saves the user's time and improves the user's experience.

In the embodiment of the invention, the second client receives data of the first client via a persistent connection server, wherein the second client first requests the address information of a corresponding persistent connection server from a persistent connection allocation server. The persistent connection allocation server returns an address of a different persistent connection server to an individual client according to identification information of different clients, which ensures that the synchronization of information between the same clients of different terminals is more rapid and timely. In addition, in the embodiment of the invention, an online device list stored in the persistent connection server can be updated in real time, which ensures that the persistent connection server can timely update information of clients which establish persistent connections with it, avoids that data is sent to a disconnected client since the data update of the online device list is not in time and a malignant consequence such as packet loss, etc. is caused, and improves the security of data transmission.

### Embodiment 3

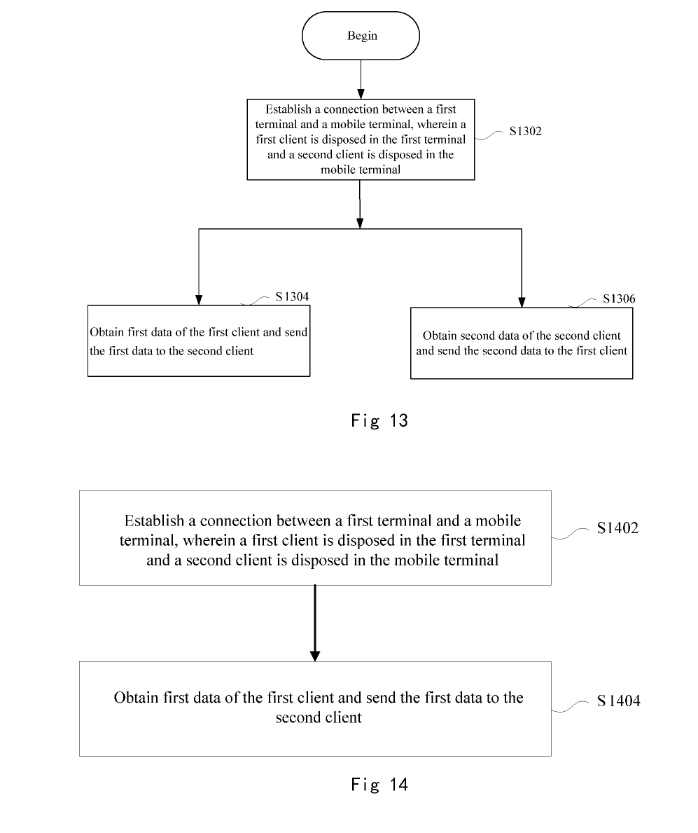

To solve the above technical problems in the relevant art, an embodiment of the invention provides yet another data transmission method, which provides a technical solution of bidirectional data transmission. FIG. 13 shows a processing flow chart of a data transmission method according to an embodiment of the invention. As shown in FIG. 13, in the embodiment of the invention, a first client is disposed in a first terminal, and a second client is disposed in a mobile terminal. Reference is made to step S1302 in FIG. 13, in which a connection is established between the first terminal and the mobile terminal first. When the establishment of the connection between the first terminal and the mobile terminal, step S1304 is performed to obtain first data of the first client and send the first data to the second client, and/or step S1306 is performed to obtain second data of the second client and send the second data to the first client.

According to the embodiment of the invention, after the first terminal and the mobile terminal establish a connection, bidirectional transmission of data can be conducted between the first client and the second client disposed in the two terminals respectively, which solves the problem mentioned in the prior art that data transmission can not be conducted between clients, and further solves the problem that since data transmission can not be conducted between different clients, user requirements must be re-introduced when a new client is enabled, thereby resulting in resource waste and low efficiency.

It can be seen from FIG. 13 that the data transmission method provided by the embodiment of the invention is a bidirectional data transmission method, namely, he data transmission method provided by the embodiment of the invention may be that the first client transmits the first data to the second client, or also may be that the second client transmits the second data to the first client, wherein the procedures of data transmission in the two directions are similar. To elaborate the embodiment of the invention more clearly and briefly, now that the first client sends data to the second client will be taken as an example for introduction.

FIG. 14 shows a processing flow chart of a data transmission method on a first client side according to an embodiment of the invention. As shown in FIG. 14, the flow begins at step S1402 to determine that a connection is established between a first terminal and a mobile terminal. The first terminal may establish a connection with the mobile terminal by multiple modes, for example wired mode, wireless mode, wherein for the wired mode, the connection may be conducted by a data line, and for the wireless mode, the connection may be conducted by a wireless network (for example, Bluetooth, wife, local area network, etc.).

After execution of the step S1402 is finished, a connection is established between the first terminal and the mobile terminal. Step S1404 is further triggered to obtain first data of a first client disposed in the first terminal, and send the first data to a second client.

According to the embodiment of the invention, after the first terminal and the mobile terminal establish a connection, bidirectional transmission of data can be conducted between the first client and the second client disposed in the two terminals respectively, which solves the problem mentioned in the prior art that data transmission can not be conducted between clients, and further solves the problem that since data transmission can not be conducted between different clients, user requirements must be re-introduced when a new client is enabled, thereby resulting in resource waste and low efficiency.

It can be seen from the flow as shown in FIG. 14, in the embodiment of the invention, data can be transmitted between the first client and the second client. In particular, in transmission of data in the client to the second client, it needs to be routed and forwarded via a server, etc. Now, its transmission procedure will be described particularly.

Firstly, first data in the first client is obtained. Secondly, the obtained first data is transmitted to a first server utilizing a first message as a carrier. Here, in the first message are carried the first data and the identification information of the first client. In addition, the first server here is a server corresponding to the first terminal. For example, if the first terminal is a PC, the first server is a PC server. After receiving the first message sent by the first client, the first server transmits it to a persistent connection server which has a persistent connection with the second client, and the persistent connection server transmits the first message to the second client.

FIG. 15 shows a flow chart of sending data according to a preferred embodiment of the invention. First, a connection is established between the first terminal and the mobile terminal. When the mobile terminal is connected to the first terminal, the connection may be established directly between the mobile terminal and the first terminal, or also whether to establish the connection with the mobile terminal may be determined according to whether the first terminal has already established a connection with other mobile terminal as well as selection of the user.

Preferably, in an embodiment of the invention, first, it is judged whether the first terminal has established a connection with other mobile terminal, and if no, it is determined that a connection is established between the first terminal and the mobile terminal, and if yes, a mobile terminal that establishes a connection with the first terminal is determined according to selection of the user. Whether to establish the connection with the mobile terminal is determined by judging whether the first terminal has already established a connection with other mobile terminal as well as selection of the user, which can ensure that the user sends data of a client of a specified mobile terminal to the first terminal according to his own needs, and avoid confusion of data sending by clients of the user.

After it is determined that a connection is established between the first terminal and the mobile terminal, with reference to FIG. 15, step S1501 is performed first, in which the first client sends the first message carrying the first data and the identification information of the first client itself to a first server.

After receiving the first message, with reference to step S1502 in FIG. 15, the first server first performs legality verification on the first message and forwards the first message that passes the legality verification. Preferably, in an embodiment of the invention, the first server verifies identification information of the first client in the first message to determine whether the identification information of the first client is legal information, for example, to verify whether the identification information has been registered in a client center, or the identification information is an identifier generated inside the server. If the identification information is verified to be legal information, the first server transmits the identification information to a persistent connection server, and if the identification information is not legal information, the first server refuses to send the identification information to the persistent connection server.

Likewise, the first server may further perform legality verification on other data than the identification information in the first message, for example, verify whether webpage data, etc. of the first client is non-malicious data. In an embodiment of the invention, the malicious data refers to a virus, Trojan, etc. which performs an illegal action of steal, destruction, etc. on data in a user terminal. If the first server verifies that the data of the first client is the above-mentioned malicious data, the first server refuses to transmit the malicious data to the persistent connection server, and if it is verified by the first server that the data of the first client is non-malicious data, the first server transmits the data to the persistent connection server. Preferably, in an embodiment of the invention, after legality verification is performed on the first message transmitted by the first client, the first server may further perform encryption processing on the first message, which more effectively improves the security of data transmission. By performing security verification and processing on the first message by the first server, the security of data transmission can be guaranteed more effectively, avoiding that in the procedure of data transmission, some malicious network addresses, etc. are attached to the transmitted data and cause damage to a terminal or client of a user.

After performing legality verification on the first message, the first server sends the first message on which legality verification has been performed to a corresponding persistent connection server. The first server may communicate with the persistent connection server by multiple protocols, for example, the transmission control protocol, the user datagram protocol, etc. Preferably, in an embodiment of the invention, the first server communicates with the persistent connection server by an HTTP request. The HTTP supports multiple server modes and is simple and fast, and therefore communication by an HTTP request can improve the efficiency of data transmission.

It can be seen from FIG. 15 that, after the step (i.e., the step S1502 in FIG. 15) of the first server sending the first message to a corresponding persistent connection server is performed, step S1503 is performed. At the step S1503, the persistent connection server sends the first message to the second client. At step S1504, the second client performs corresponding processing according to the received first message to ensure that information sharing is realized between the first client and the second client, and operations of which the execution was not finished on the first client previously can continue to be performed on the second client, for example, continue to read content of a webpage.

From the foregoing, when the first message is transmitted from the first client to the second client, it needs to pass a corresponding persistent connection server. The address information of the persistent connection server needs to be obtained by the first client according to the identification information of the first client. Now, a way of obtaining the address information of a corresponding persistent connection server by the first client will be introduced. First, the first client sends an address request message carrying its own identification information to a persistent connection allocation server. After receiving the address request message, the persistent connection allocation server verifies the identification information carried in it, and then returns a response message to the first client according to the identification information. Therein, in the response message returned by the persistent connection allocation server is carried the address information of a persistent connection server corresponding to the first client.

In the embodiment of the invention, the first client searches for the address information of a corresponding persistent connection server by a persistent connection allocation server. The persistent connection allocation server returns different persistent connection server addresses to individual clients according to identification information of clients on different terminals, which ensures that synchronization of information between different clients is more rapid and timely.

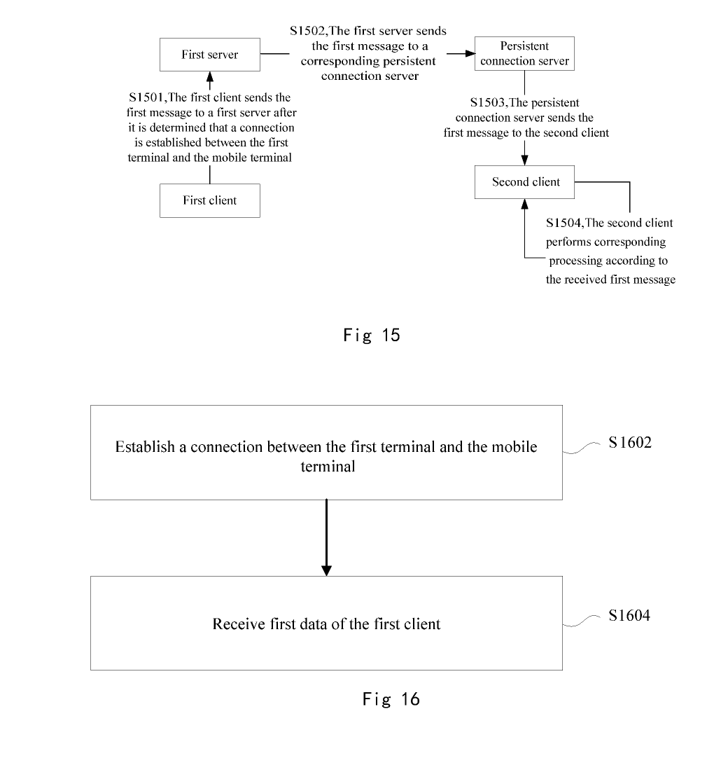

FIG. 16 shows a processing flow chart of a data transmission method on a second client side according to an embodiment of the invention. Referring to FIG. 16, first, step S1602 is performed, that is, a connection is established between the first terminal and the mobile terminal. After it is determined that a connection is established between the first terminal and the mobile terminal, the second client receives first data of the first client.

According to the embodiment of the invention, the second client can timely obtain the first data in the first client, which facilitates information update by the second client. The embodiment of the invention solves the problem of information sharing between the first client and the second client, enables a user to timely synchronize information between two clients, thereby avoids that the user performs repetitive operations and obtains repetitive information in a new client, and further avoids data redundancy and resource waste.

In particular, after the establishment of a connection between the first terminal and the mobile terminal (i.e., the step S1602 in FIG. 16) is finished, the mobile terminal queries about whether a second client exists. If the second client exists, step S1604 is triggered directly in which the second client receives first data of the first client. If the second client does not exist, it is necessary to first obtain an installation package of the second client and download and install the second client in the second terminal. After the installation is finished, the step S1604 is performed in which the second client receives the first data of the first client.

In the procedure of the second client receiving the first data of the first client, the first data needs to be routed and forwarded by a server, etc. In addition, the first data is transmitted utilizing a first message as a carrier, wherein in the first message are carried the first data and the identification information of the first client. Now, its transmission procedure will be described particularly.

The second client first searches for the address information of a persistent connection server corresponding to it. Now, a specific way in which the second client searches for the address of a persistent connection server will be introduced. The second client sends an address request message carrying identification information to a persistent connection allocation server, and after receiving the address request message, the persistent connection allocation server determines a corresponding persistent connection server according to the identification information carried by it, and returns to the second client a response message carrying the address information of the corresponding persistent connection server.

After receiving the address information of the corresponding persistent connection server sent by the persistent connection allocation server, the second client establishes a persistent connection with the persistent connection server corresponding to the address information to receive the first data from the persistent connection server.

After the second client establishes a persistent connection with the corresponding persistent connection server successfully, an online device list is stored in the persistent connection server, and the list records identification information of individual clients which maintain persistent connections with the persistent connection server. If the persistent connection between a certain client and the persistent connection server is disconnected, the identification information corresponding to the disconnected client is deleted in the online device list of the persistent connection server. The real-time update of the online device list in the persistent connection server ensures that the persistent connection server can timely update information on clients which establish persistent connections with it, avoids that data is sent to a disconnected client since the data update of the online device list is not in time and a malignant consequence such as packet loss, etc. is caused, and improves the security of data transmission.

When the persistent connection server receives the first data sent via the first server, the persistent connection server finds the second client according to the identification information carried in the first data, and determines the state of the persistent connection between it and the second client according to information recorded in the online device list. If the state of the persistent connection is connected, the persistent connection server sends the first data to the second client. If the state of the persistent connection is disconnected, the first data is stored in the persistent connection server, and then it is not until the state of the persistent connection between the persistent connection server and the second client turns from disconnected to connected that the first data stored in the persistent connection server is sent to the second client.

After receiving the first data sent by the persistent connection server, the second client performs corresponding processing according to the first data to ensure that information sharing is realized between the first client and the second client, and operations of which the execution was not finished on the first client previously can continue to be performed on the second client, for example, continue to read content of a webpage.

In the embodiment of the invention, the identification information is identity verification information of a client, it may be identity verification information set by the user, or also may be identity verification information set for a client by a server, which will not be defined by the embodiment of the invention. Preferably, in an embodiment of the invention, the identification information may be account information of user login of the first client, the account information is an account which is applied by the user for registration in a client center, the application of the account information is simple and easy, and each piece of account information may be logged in on multiple clients. Additionally, the identification information in the embodiment of the invention may also be a character string generated by a server, e.g., a shadow account, which can be taken as a unique identification. The shadow account may be a unique identification generated by the server according to information such as time, machine identification, etc. The shadow account may also be an account randomly generated by the server. After generating the account, the server checks whether the generated shadow account has already existed, and if yes, the server regenerates a shadow account, until the account did not exist before. The shadow account has nonrepeatability and uniqueness, and each shadow account can only identify one client.

In the embodiment of the invention, the first client and/or the second client may be any clients of the same type, such as a browser client, a security guard client, a reader client, a media player client, or also may be clients of different types, but which implement the same function, which will not be defined by the embodiment of the invention. The first, second herein are only used for differentiating different clients, they do not result in definition of clients' own attributes, order and functions, and the first, second may be interchanged to refer to different clients.

Preferably, in an embodiment of the invention, the first client and/or the second client is/are a browser client. A user generally performs on a browser client personalized operations of collecting network addresses, setting commonly used webpages, etc. When the user turns from one terminal to another terminal, he needs to newly enable a new client on another terminal. According to the embodiment of the invention, the personalized operations set by the user on the former client may be automatically synchronized to the newly enabled client, and it is unnecessary for the user to repeat the operations.

Similarly, in the embodiment of the invention, the first data may be data of any operation which is performed by a user in the first client, or also may be other data updated by the first client, data stored in the first client, etc., which will not be defined by the embodiment of the invention in any way. Preferably, in an embodiment of the invention, the data may comprise individual network addresses collected in the favorites of the first client, a network address currently opened by the first client, commonly used network addresses of the first client, and any user data invoked by the first client according to a user instruction, etc. In addition, in the embodiment of the invention, the processing performed by the second client according to the received first data may be to perform corresponding processing on the second client itself according to the first data, or also may be to perform processing on the received first data. Preferably, in an embodiment of the invention, the processing performed by the second client according to the first data comprises that the second client updates the favorites, the second client updates commonly used network addresses, and the second client opens a webpage corresponding to a network address, and so on.

In the embodiment of the invention, any data of the first client may be sent to the second client, which ensures that various operations performed by a user in the first client may be synchronously updated to the second client, avoids that the user performs repetitive operations and obtains repetitive information in a new client, and further avoids data redundancy and resource waste.

### Embodiment 3.1

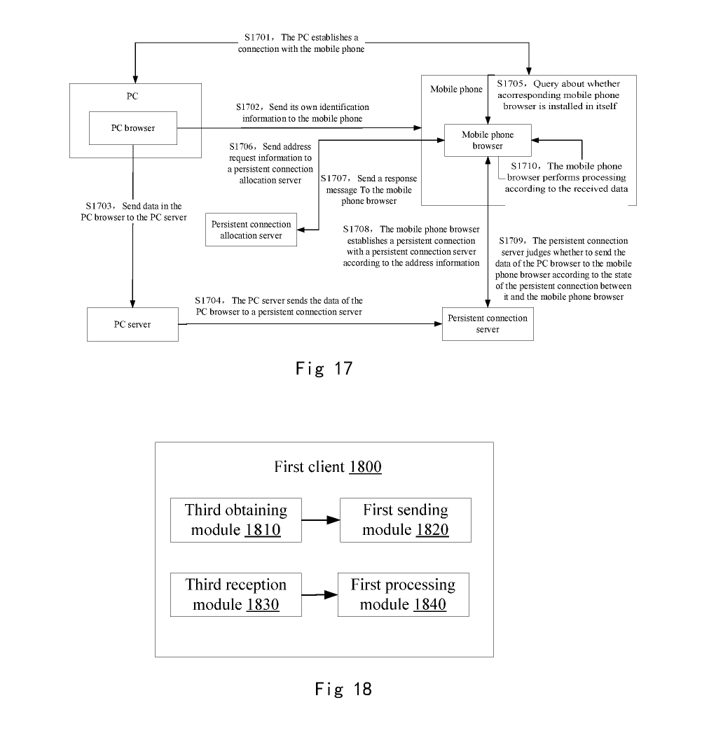

FIG. 17 shows a flow chart of a data transmission method according to a preferred embodiment of the invention, which is used for supporting any of the data transmission methods described above and elaborating the data transmission methods more clearly. As shown in FIG. 17, in this example, a PC is selected as the terminal, a mobile phone is the mobile terminal, and the clients are browser clients. For the convenience of identifying the first client and the second client, in this example, the first client is called a PC browser, and the second client is called a mobile phone browser.

With reference to FIG. 17, first, step S1701 is performed to use a USB data line to establish a connection between the PC and the mobile phone. After the PC browser receives a notification of the mobile phone being connected to the PC, step S1702 is performed to send its own identification information to the mobile phone. After the PC browser receives the notification, step S1703 is performed to query about whether account information has already been logged in the client and send data of the PC browser to a PC server according to the query result. In particular, if account information has already been logged in the client, the PC browser sends valid data in the account information to the PC server. If no account information is logged in the client, the PC browser generates a unique identification as the identification information of the PC browser, and sends the identification information and data of the PC browser itself to the PC server.

In this preferred embodiment, the step in which the PC browser sends its own data to the PC server mentioned at the step S1703 can be performed in the whole procedure of data transmission, to ensure that the PC browser can timely send its own data and data updated in real time to the PC server. That is, the PC browser may send its own data to the PC server after the PC establishes a connection with the mobile phone, and also may send data when the PC does not establish a connection with the mobile phone. Likewise, the PC browser may send data to the PC server before sending its own identification information to the mobile phone, or also may send data to the PC server after the PC browser sends its own identification information to the mobile phone.

After the PC server receives the data of the PC browser, step S1704 is performed to perform legality verification on the data sent by the PC browser, and send the data which passes the legality verification to a persistent connection server after the data is encrypted. Therein, the legality verification may be to verify whether the identification information sent by the PC browser is legal, or also may be to verify whether the data sent by the PC browser is non-malicious data. If the data of the PC browser can not pass the legality verification by the PC server, then the PC server does not perform sending processing on the data.

Furthermore, after the mobile phone receives the identification information sent by the PC browser via the step S1702, step S1705 is performed to query about whether a mobile phone browser is installed in itself. If a mobile phone browser is not installed in the mobile phone, then first a mobile phone browser is downloaded and installed in the mobile phone, and after the installation is finished, the mobile phone sends the identification information of the PC browser to the mobile phone browser. If a mobile phone browser has already existed in the mobile phone, then the identification information of the PC browser is directly sent to the mobile phone browser.

After the mobile phone browser receives the identification information of the PC browser, step S1706 is performed to send address request information for a persistent connection server which carries the identification information to a persistent connection allocation server. After the persistent connection allocation server receives the address request message of the mobile phone browser, step S1707 is performed to send a response message carrying the address information of a persistent connection server to the mobile phone browser. After the mobile phone browser receives the response message carrying the address information of a persistent connection server, step S1708 is performed to establish a persistent connection with a corresponding persistent connection server according to the address information of the persistent connection server.

After the persistent connection server receives the data of the PC browser, step S1709 is performed to judge whether to send the data of the PC browser to the mobile phone browser according to the state of the persistent connection between the mobile phone browser and the persistent connection server. In particular, an online device list is stored in the persistent connection server, and the real-time update of the list ensures that the persistent connection server can timely update information on browsers which establish a persistent connection with it, avoids that data is sent to a disconnected browser since the data update of the online device list is not in time and a malignant consequence such as packet loss, etc. is caused, and improves the security of data transmission.

After receiving the data of the PC browser sent via the PC server, the persistent connection server queries about the state of the persistent connection between it and the corresponding mobile phone browser according to the online device list, and if the state of the persistent connection is connected, then sends the data of the PC browser to the mobile phone browser. If the state of the persistent connection is disconnected, it stores the data of the PC browser, and will not send the data of the PC browser to the mobile phone browser, until the state of the persistent connection between the persistent connection server and the corresponding mobile phone browser is recovered.

After the mobile phone browser receives the data sent by the persistent connection server, step S1710 is performed to perform corresponding processing according to the received data to ensure that information sharing is realized between the first client and the second client, and operations of which the execution was not finished on the first client previously can continue to be performed on the second client, for example, continue to read content of a webpage.

On the basis of the data transmission methods provided in the above individual preferred embodiments and based on the same concept, an embodiment of the invention provides a client for data transmission, which is used for implementing the data transmission method provided by embodiment 3.

FIG. 18 shows a structural schematic diagram of a client according to an embodiment of the invention. In order to elaborate the embodiment of the invention more clearly and briefly, in the following, a client for data transmission is abbreviated as a first client. Referring to FIG. 18, the first client 1800 of the embodiment of the invention comprises at least: a third obtaining module 1810, a first sending module 1820, a third reception module 1830 and a first processing module 1840.

Now, functions of individual devices or components and a connection relationship between individual parts of the first client 1800 in a data transmission device of the embodiment of the invention will be introduced. In the first client 1800, the third obtaining module 1810 obtains first data of the first client 1800 running locally. After the third obtaining module 1810 obtains the first data, the first sending module 1820 sends the first data to a second client disposed in a mobile terminal.

According to the embodiment of the invention, after a first terminal and the mobile terminal establish a connection, bidirectional transmission of data can be conducted between the first client 1800 and the second client disposed in the two terminals respectively, which solves the problem mentioned in the prior art that data transmission can not be conducted between clients, and further solves the problem that since data transmission can not be conducted between different clients, user requirements must be re-introduced when a new client is enabled, thereby resulting in resource waste and low efficiency.

The third obtaining module 1810 and the first sending module 1820 in the first client 1800 can accomplish the function of data sending of the first client 1800, whereas the third reception module 1830 receives second data of the second client and triggers the first processing module 1840, and the first processing module 1840 performs corresponding processing according to the second data of the second client to ensure that information sharing is realized between the first client 1800 and the second client, and operations of which the execution was not finished on the first client 1800 previously can continue to be performed on the second client, for example, continue to read content of a webpage.

In the embodiment of the invention, the processing performed by the first client 1800 according to the received second data of the second client may be to perform corresponding processing on the first client 1800 itself according to the second data, or also may be to perform processing on the received second data. Preferably, in an embodiment of the invention, the processing performed by the first client 1800 according to the second data comprises that the first client 1800 updates the favorites, the first client 1800 updates commonly used network addresses, and the first client 1800 opens a webpage corresponding to a network address, and so on.

In the embodiment of the invention, the first client 1800 and/or the second client may be any clients of the same type, or also may be clients of different types, but which implement the same function, which will not be defined by the embodiment of the invention. The first, second herein are only used for differentiating different clients, they do not result in definition of clients' own attributes, order and functions, and the first, second may be interchanged to refer to different clients.

Preferably, in an embodiment of the invention, the first client 1800 and/or the second client is/are a browser client. A user generally performs on a browser client personalized operations of collecting network addresses, setting commonly used webpages, etc. When the user turns from one terminal to another terminal, he needs to newly enable a new client on another terminal. According to the embodiment of the invention, the personalized operations set by the user on the former client may be automatically synchronized to the newly enabled client, and it is unnecessary for the user to repeat the operations.

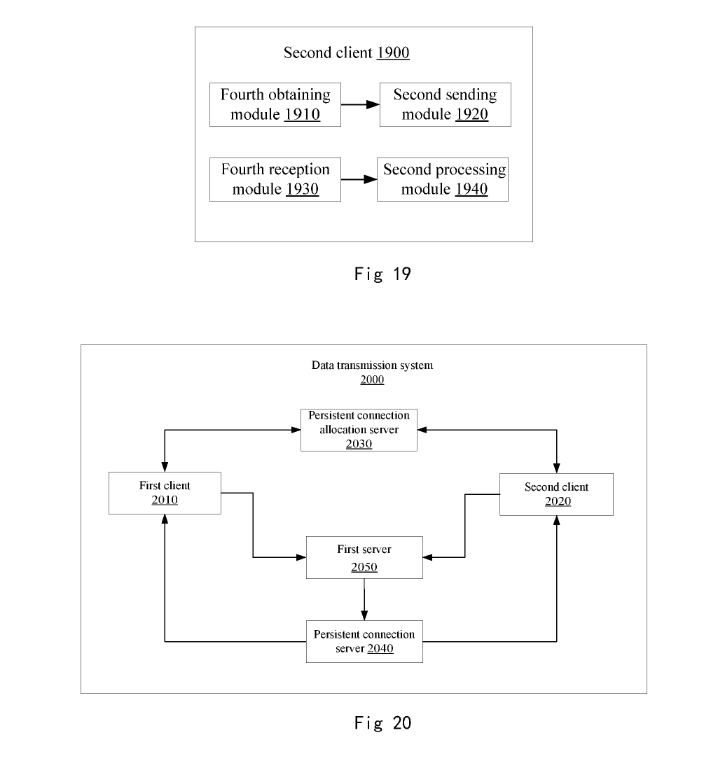

FIG. 19 shows a structural schematic diagram of another client according to an embodiment of the invention. In order to elaborate the embodiment of the invention more clearly and briefly, in the following, another client for data transmission is abbreviated as a second client. Referring to FIG. 19, the second client 1900 of the embodiment of the invention comprises at least: a fourth obtaining module 1910, a second sending module 1919, a fourth reception module 1930 and a second processing module 1940.

Now, functions of individual devices or components and a connection relationship between individual parts of the second client 1900 in a data transmission device of the embodiment of the invention will be introduced. In the second client 1900, the fourth obtaining module 1910 obtains second data of the second client 1900 running locally. After the fourth obtaining module 1910 obtains the second data, the second sending module 1919 sends the second data to a first client.

According to the embodiment of the invention, the second data of the second client 1900 can be sent to the first client, and data transmission between the first client and the second client 1900 is achieved, which solves the problem mentioned in the prior art that data transmission can not be conducted between clients, and further solves the problem that since data transmission can not be conducted between different clients, user requirements must be re-introduced when a new client is enabled, thereby resulting in resource waste and low efficiency.

The fourth obtaining module 1910 and the second sending module 1919 in the second client 1900 can accomplish the function of data sending of the second client 1900, whereas the fourth reception module 1930 receives first data of the first client and triggers the second processing module 1940, and the second processing module 1940 performs corresponding processing according to the first data of the first client to ensure that information sharing is realized between the first client and the second client 1900, and operations of which the execution was not finished on the first client previously can continue to be performed on the second client 1900, for example, continue to read content of a webpage.

In the embodiment of the invention, the first client and/or the second client 1900 may be any clients of the same type, or also may be clients of different types, but which implement the same function, which will not be defined by the embodiment of the invention. The first, second herein are only used for differentiating different clients, they do not result in definition of clients' own attributes, order and functions, and the first, second may be interchanged to refer to different clients.

Preferably, in an embodiment of the invention, the first client and/or the second client 1900 is/are a browser client. A user generally performs on a browser client personalized operations of collecting network addresses, setting commonly used webpages, etc. When the user turns from one terminal to another terminal, he needs to newly enable a new client on another terminal. According to the embodiment of the invention, the personalized operations set by the user on the former client may be automatically synchronized to the newly enabled client, and it is unnecessary for the user to repeat the operations.

Similarly, in the embodiment of the invention, the first data received by the second client 1900 may be data of any operation which is performed by a user in the first client, or also may be other data updated by the first client, data stored in the first client, etc., which will not be defined by the embodiment of the invention in any way. Preferably, in an embodiment of the invention, the data may comprise individual network addresses collected in the favorites of the first client, a network address currently opened by the first client, commonly used network addresses of the first client, and any user data invoked by the first client according to a user instruction, etc.

In addition, in the embodiment of the invention, the processing performed by the second client 1900 according to the received first data may be to perform corresponding processing on the second client 1900 itself according to the first data, or also may be to perform processing on the received first data. Preferably, in an embodiment of the invention, the processing performed by the second client 1900 according to the first data comprises that the second client 1900 updates the favorites, the second client 1900 updates commonly used network addresses, and the second client 1900 opens a webpage corresponding to a network address, and so on.

FIG. 20 shows a structural schematic diagram of a data transmission system according to an embodiment of the invention. As shown in FIG. 20, the data transmission system 2000 in the embodiment of the invention comprises a first client 2010 disposed in a first terminal, a second client 2020 disposed in a mobile terminal, a persistent connection allocation server 2030, a persistent connection server 2040 and a first server 2050 corresponding to the first client.

Now, functions of individual devices or components and a connection relationship between individual parts in the data transmission system 2000 of the embodiment of the invention will be introduced. When acting as a data sending side, the first client 2010 obtains its own first data, and sends the first data and its own identification information to the first server 2050 utilizing a first message as a carrier. After receiving the first message, the first server 2050 performs legality verification on the first message. Preferably, in an embodiment of the invention, the first server 2050 verifies identification information of the first client 2010 in the first message to determine whether the identification information of the first client 2010 is legal information, for example, to verify whether the identification information has been registered in a client center, or the identification information is an identifier generated inside the server. If the identification information is verified to be legal information, the first server 2050 transmits the identification information to a persistent connection server 2040, and if the identification information is not legal information, the first server 2050 refuses to send the identification information to the persistent connection server 2040.

Likewise, the first server 2050 may further perform legality verification on other data than the identification information in the first message, for example, verify whether webpage data, etc. of the first client 2010 is non-malicious data. In an embodiment of the invention, the malicious data refers to a virus, Trojan, etc. which performs an illegal action of steal, destruction, etc. on data in a user terminal. If the first server 2050 verifies that the data of the first client 2010 is the above-mentioned malicious data, the first server 2050 refuses to transmit the malicious data to the persistent connection server 2040, and if it is verified by the first server 2050 that the data of the first client 2010 is non-malicious data, the first server 2050 transmits the data to the persistent connection server 2040. Preferably, in an embodiment of the invention, after legality verification is performed on the first message transmitted by the first client 2010, the first server 2050 may further perform encryption processing on the first message, which more effectively improves the security of data transmission. By performing security verification and processing on the first message by the first server 2050, the security of data transmission can be guaranteed more effectively, avoiding that in the procedure of data transmission, some malicious network addresses, etc. are attached to the transmitted data and cause damage to a terminal or client of a user.

After performing legality verification on the first message, the first server 2050 performs encryption processing on the first message which passes the legality verification and sends it to the persistent connection server 2040. The persistent connection server 2040 receives the first message, and queries about the state of the persistent connection between it and the corresponding second client 2020 in a local online device list according to the identification information carried therein. If the state of the persistent connection is connected, the persistent connection server 2040 sends the first data to the second client 2020. If the state of the persistent connection is disconnected, the first data is stored in the persistent connection server 2040, and the data will not be sent until the state of the persistent connection between it and the second client 2020 is recovered.

As a data receiving side, the second client 2020 first requests the address information of a corresponding persistent connection server 2040 from the persistent connection allocation server 2030. A specific way of the second client 2020 requesting the address information of a persistent connection server 2040 is as follows. The second client 2020 sends an address request message carrying the identification information of the first client 2010 to the persistent connection allocation server 2030. The persistent connection allocation server 2030 determines a corresponding persistent connection server 2040 according to the identification information of the first client 2010 in the received address request message, and returns a response message to the second client 2020. In the response message is carried the address information of the persistent connection server 2040. After receiving the response message, the second client 2020 establishes a persistent connection with the corresponding persistent connection server 2040 according to the address information of the persistent connection server 2040 carried in the response message, so as to receive the first data of the first client 2010 from the persistent connection server 2040.

After receiving the first data, the second client 2020 performs corresponding processing according to the first data to ensure that information sharing is realized between the first client 2010 and the second client 2020, and operations of which the execution was not finished on the first client 2010 previously can continue to be performed on the second client 2020, for example, continue to read content of a webpage.

According to the embodiment of the invention, after the first terminal and the mobile terminal establish a connection, bidirectional transmission of data can be conducted between the first client 2010 and the second client 2020 disposed in the two terminals respectively, which solves the problem mentioned in the prior art that data transmission can not be conducted between clients, and further solves the problem that since data transmission can not be conducted between different clients, user requirements must be re-introduced when a new client is enabled, thereby resulting in resource waste and low efficiency.

In the embodiment of the invention, the identification information is identity verification information of a client, it may be identity verification information set by the user, or also may be identity verification information set for a client by a server, which will not be defined by the embodiment of the invention. Preferably, in an embodiment of the invention, the identification information may be account information of user login of the first client 2010, the account information is an account which is applied by the user for registration in a client center, the application of the account information is simple and easy, and each piece of account information may be logged in on multiple clients. Additionally, the identification information in the embodiment of the invention may also be a character string generated by a server, e.g., a shadow account, which can be taken as a unique identification. The shadow account may be a unique identification generated by the server according to information such as time, machine identification, etc. The shadow account may also be an account randomly generated by the server. After generating the account, the server checks whether the generated shadow account has already existed, and if yes, the server regenerates a shadow account, until the account did not exist before. The shadow account has nonrepeatability and uniqueness, and each shadow account can only identify one client.

In the embodiment of the invention, the first client 2010 and/or the second client 2020 may be any clients of the same type, such as a browser client, a security guard client, a reader client, a media player client, or also may be clients of different types, but which implement the same function, which will not be defined by the embodiment of the invention. The first, second herein are only used for differentiating different clients, they do not result in definition of clients' own attributes, order and functions, and the first, second may be interchanged to refer to different clients.

Preferably, in an embodiment of the invention, the first client 2010 and/or the second client 2020 is/are a browser client. A user generally performs on a browser client personalized operations of collecting network addresses, setting commonly used webpages, etc. When the user turns from one terminal to another terminal, he needs to newly enable a new client on another terminal. According to the embodiment of the invention, the personalized operations set by the user on the former client may be automatically synchronized to the newly enabled client, and it is unnecessary for the user to repeat the operations.

Similarly, in the embodiment of the invention, the first data may be data of any operation which is performed by a user in the first client 2010, or also may be other data updated by the first client 2010, data stored in the first client 2010, etc., which will not be defined by the embodiment of the invention in any way. Preferably, in an embodiment of the invention, the data may comprise individual network addresses collected in the favorites of the first client 2010, a network address currently opened by the first client 2010, commonly used network addresses of the first client 2010, and any user data invoked by the first client 2010 according to a user instruction, etc. In addition, in the embodiment of the invention, the processing performed by the second client 2020 according to the received first data may be to perform corresponding processing on the second client 2020 itself according to the first data, or also may be to perform processing on the received first data. Preferably, in an embodiment of the invention, the processing performed by the second client 2020 according to the first data comprises that the second client 2020 updates the favorites, the second client 2020 updates commonly used network addresses, and the second client 2020 opens a webpage corresponding to a network address, and so on.

In the embodiment of the invention, any data of the first client 2010 may be sent to the second client 2020, which ensures that various operations performed by a user in the first client 2010 may be synchronously updated to the second client 2020, avoids that the user performs repetitive operations and obtains repetitive information in a new client, and further avoids data redundancy and resource waste. It is worth noting that the persistent connection server corresponding to the first client and the persistent connection server corresponding to the second client may be the same server, or also may be different servers.

In the embodiment of the invention, bidirectional data transmission may be conducted between the first client 2010 and the second client 2020, that is, it may be that the first client 2010 sends the first data of the first client 2010 to the second client, or also it may be that the second client 2020 sends the second data of the second client 2020 to the first client. In the above, a specific procedure is introduced in which the first client 2010 transmits the first data to the second client 2020 in the data transmission system 2000. The procedure in which the second client 2020 transmits the second data to the first client 2010 is similar to it and will not be repeated here.

### Embodiment 4

To solve the above technical problems, an embodiment of the invention further provides still another data transmission method applied in a situation in which a channel of data transmission has already been established between a first client and a second client, namely, data transmission can be conducted between the first client and the second client. The embodiment of the invention aims at illustrating a specific procedure of data transmission between the first client and the second client.

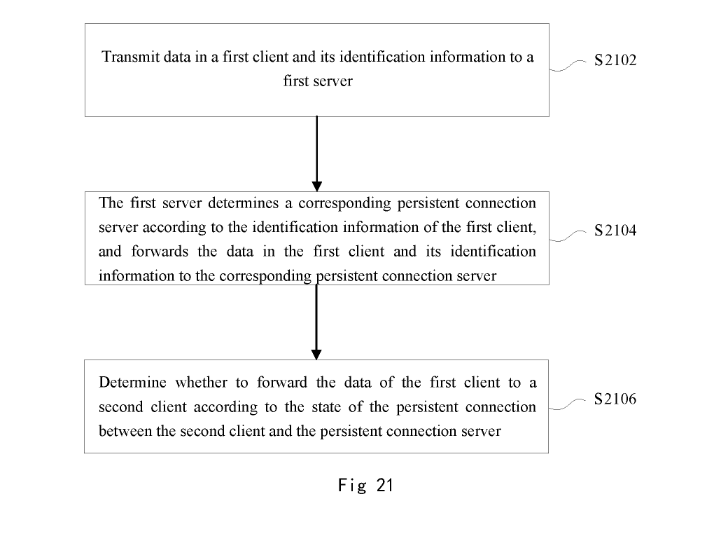

FIG. 21 shows a processing flow chart of a data transmission method according to an embodiment of the invention. As shown in FIG. 21, the processing flow of the data transmission method begins at step S2102, in which data in a first client and its identification information are transmitted to a first server. After the first server receives the data of the first client and its identification information, step S2104 is triggered.

At the step S2104, the first server determines a corresponding persistent connection server according to the identification information of the first client, and forwards the data in the first client and its identification information to the corresponding persistent connection server. After the persistent connection server receives the data of the first client and its identification information sent by the first server, step S2106 is performed to determine whether to forward the data of the first client to a second client according to the state of the persistent connection between the second client and the persistent connection server.

According to the embodiment of the invention, the first client can send data to the second client, which achieves data transmission from the first client to the second client, solves the problem mentioned in the prior art that data transmission can not be conducted between clients, and further solves the problem that since data transmission can not be conducted between different clients, user requirements must be re-introduced when a new client is enabled, thereby resulting in resource waste and low efficiency.

To elaborate the embodiment of the invention more clearly and briefly, in the embodiment of the invention, the first client is disposed in a first terminal, and the second client is disposed in a second terminal. It can be seen from the flow as shown in FIG. 21 that, in the procedure of data transmission, when data in the first client is transmitted to the second client, it needs to be routed and forwarded by a server, etc. Now, the transmission procedure of the first client transmitting data in the first client to the second client will be described particularly.

Firstly, the step S2102 as shown in FIG. 21 is performed in which the first client sends data in the first client and its identification information to a first server, and here the first server is a server corresponding to the first terminal. For example, if the first terminal is a PC, the first server is a PC server. Secondly, the step S2104 is performed in which after receiving the data of the first client, the first server performs legality verification on the data of the first client. Preferably, in an embodiment of the invention, the first server verifies identification information of the first client in the data to determine whether the identification information of the first client is legal information, for example, to verify whether the identification information has been registered in a client center, or the identification information is an identifier generated inside the server. If the identification information is verified to be legal information, the first server transmits the identification information to a persistent connection server, and if the identification information is not legal information, the first server refuses to send the identification information to the persistent connection server.

Likewise, the first server may further perform legality verification on other data than the identification information in the data, for example, verify whether webpage data, etc. of the first client is non-malicious data. In an embodiment of the invention, the malicious data refers to a virus, Trojan, etc. which performs an illegal action of steal, destruction, etc. on data in a user terminal. If the first server verifies that the data of the first client is the above-mentioned malicious data, the first server refuses to transmit the malicious data to the persistent connection server, and if it is verified by the first server that the data of the first client is non-malicious data, the first server transmits the data to the persistent connection server. Preferably, in an embodiment of the invention, after legality verification is performed on the data of the first client, the first server may further perform encryption processing on the data of the first client, which more effectively improves the security of data transmission. By performing security verification and processing on the data of the first client by the first server, the security of data transmission can be guaranteed more effectively, avoiding that in the procedure of data transmission, some malicious network addresses, etc. are attached to the transmitted data and cause damage to a terminal or client of a user.

After performing legality verification on the data of the first client, the first server sends the data on which legality verification has been performed to a corresponding persistent connection server. The first server may communicate with the persistent connection server by multiple protocols, for example, the transmission control protocol, the user datagram protocol, etc. Preferably, in an embodiment of the invention, the first server communicates with the persistent connection server by an HTTP request. The HTTP supports multiple server modes and is simple and fast, and therefore communication by an HTTP request can improve the efficiency of data transmission.

When the persistent connection server receives the data in the first client and its identification information sent via the first server, the persistent connection server determines a corresponding second client according to the identification information of the first client, and determines the state of the persistent connection between it and the second client according to information recorded in an online device list stored in the persistent connection server.

The online device list stored in the persistent connection server records identification information of individual clients which maintain persistent connections with the persistent connection server. If the persistent connection between a certain client and the persistent connection server is disconnected, the identification information corresponding to the disconnected client is deleted in the online device list of the persistent connection server. In the embodiment of the invention, the online device list stored in the persistent connection server can be updated in real time, which ensures that the persistent connection server can timely update information on clients which establish persistent connections with it, avoids that data is sent to a disconnected client since the data update of the online device list is not in time and a malignant consequence such as packet loss, etc. is caused, and improves the security of data transmission.

A specific way in which the persistent connection server determines whether to send the data in the first client to the second client is as follows. If according to the online device list of the persistent connection server, the state of the persistent connection between the persistent connection server and the second client is connected, the persistent connection server sends the data of the first client to the second client. If according to the online device list of the persistent connection server, the state of the persistent connection between the persistent connection server and the second client is disconnected, the data of the first client is stored in the persistent connection server, and then it is not until the state of the persistent connection is recovered that the data of the first client stored in the persistent connection server is sent to the second client.

In the embodiment of the invention, a channel of data transmission has already been established between the first client and the second client, in which data transmission can be conducted. Preferably, when the first client sends data to the second client, the identification information of the first client may be sent first, such that a server (e.g., the first server, the persistent connection server), etc. which is passed in the procedure of data sending can confirm a corresponding data receiving side according to the identification information. Secondly, the first client sends other data in the first client than the identification information to the second client, thereby implementing the procedure of the first client transmitting data to the second client.

From the foregoing, in the procedure of data transmission, the second client establishes a persistent connection with the persistent connection server so as to receive the data in the first client from the persistent connection server. Now, a procedure will be particularly introduced in which the second client establishes a persistent connection with a persistent connection server.

The second client determines a corresponding persistent connection server according to the identification information of the second client and sends a connection establishment request to the persistent connection server, and in the connection establishment request is carried the identification information of the second client. After the persistent connection server receives the connection establishment request sent by the second client, the persistent connection server performs identity verification on the second client according to the identification information of the second client carried in the connection establishment request. Preferably, in an embodiment of the invention, the persistent connection server may further perform identity verification on the second client according to other device information of the second client, to ensure that the second client is a receiving side which receives the data in the first client. The other device information of the second client may be device information of the second client, or also may be device information of the second terminal. Preferably, in an embodiment of the invention, the other device information comprises the international mobile equipment identity number (IMEI number for short hereinafter) of the second terminal, the device name of the second terminal, and the system version number of the second terminal.

In the procedure of data transmission, after the persistent connection server performs identity verification on the second client according to the identification information of the second client and its device information, if the second client can not pass the identity verification, the persistent connection server refuses to establish a persistent connection with it, and if the second client passes the identity verification, the persistent connection server establishes a persistent connection with the second client.

After the second client establishes a persistent connection with the persistent connection server successfully, the second client receives the data in the first client from the persistent connection server, and performs corresponding processing according to the data in the first client, to ensure that information sharing is achieved between the first client and the second client in a case in which a channel of data transmission has already been established between them, and operations of which the execution was not finished on the first client previously can continue to be performed on the second client, for example, continue to read content of a webpage.

In the embodiment of the invention, the identification information is identity verification information of a client, it may be identity verification information set by the user, or also may be identity verification information set for a client by a server, which will not be defined by the embodiment of the invention. Preferably, in an embodiment of the invention, the identification information may be account information of user login of the first client, the account information is an account which is applied by the user for registration in a client center, the application of the account information is simple and easy, and each piece of account information may be logged in on multiple clients.

Additionally, the identification information in the embodiment of the invention may also be a character string generated by a server, e.g., a shadow account, which can be taken as a unique identification. The shadow account may be a unique identification generated by the server according to information such as time, machine identification, etc. The shadow account may also be an account randomly generated by the server. After generating the account, the server checks whether the generated shadow account has already existed, and if yes, the server regenerates a shadow account, until the account did not exist before. The shadow account has nonrepeatability and uniqueness, and each shadow account can only identify one client.

In the embodiment of the invention, data of the first client may be data of any operation which is performed by a user in the first client, or also may be other data updated by the first client, data stored in the first client, etc., which will not be defined by the embodiment of the invention in any way. Preferably, in an embodiment of the invention, the data may comprise individual network addresses collected in the favorites of the first client, a network address currently opened by the first client, commonly used network addresses of the first client, and any user data invoked by the first client according to a user instruction, etc.

Any data of the first client may be sent to the second client, which ensures that various operations performed by a user in the first client may be synchronously updated to the second client, avoids that the user performs repetitive operations and obtains repetitive information in a new client, and further avoids data redundancy and resource waste. A user generally performs on a browser client personalized operations of collecting network addresses, setting commonly used webpages, etc. When the user turns from one terminal to another terminal, he needs to newly enable a new client on another terminal. According to the embodiment of the invention, the personalized operations set by the user on the former client may be automatically synchronized to the newly enabled client, and it is unnecessary for the user to repeat the operations.

In the embodiment of the invention, the first client and/or the second client may be any clients of the same type, such as a browser client, a security guard client, a reader client, a media player client, or also may be clients of different types, but which implement the same function, which will not be defined by the embodiment of the invention. The first, second herein are only used for differentiating different clients, they do not result in definition of clients' own attributes, order and functions, and the first, second may be interchanged to refer to different clients. That is, in the embodiment of the invention, it may be that the first client disposed in the first terminal sends data of the first client to the second client disposed in the second terminal, or also may be that the second client disposed in the second terminal sends data of the second client to the first client disposed in the first terminal, thereby realizing mutual transmission of information between the clients.

In the embodiment of the invention, in addition to client data transmission between different terminals mentioned above, data transmission between different clients on the same terminal and client data transmission between a mobile terminal and a terminal can be further accomplished. Therefore, in an embodiment of the invention, the first terminal and the second terminal may be a terminal such as a desktop computer, a notebook computer, etc., or also may be a mobile terminal such as a mobile phone, a music player, a tablet computer, etc. Preferably, in an embodiment of the invention, the first client and/or the second client is/are disposed in a mobile terminal(s), in order that client data transmission between a terminal and a mobile terminal is elucidated more clearly and briefly.

On the basis of the data transmission methods provided in the above individual preferred embodiments and based on the same concept, an embodiment of the invention provides a client for data transmission, which is used for implementing a data transmission method as described above.

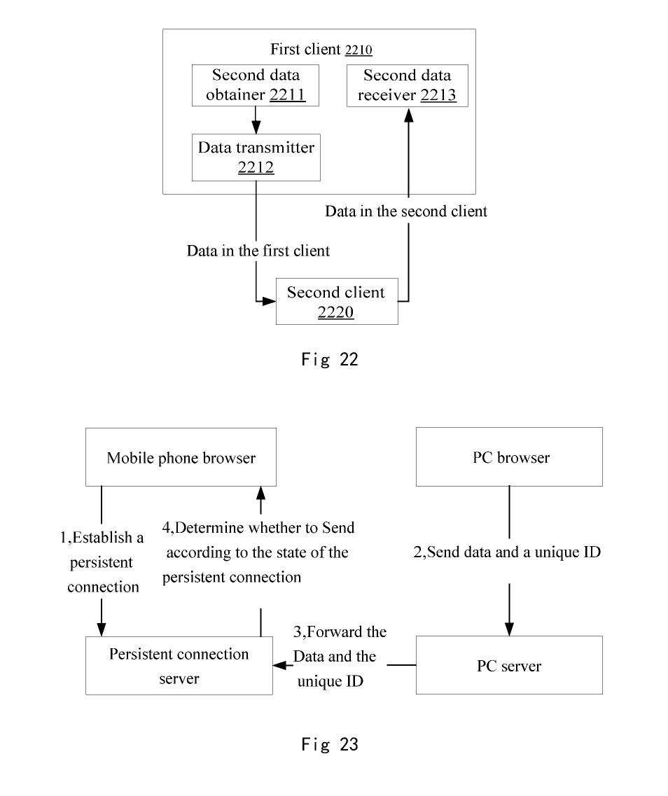

FIG. 22 shows a structural schematic diagram of a client according to an embodiment of the invention. FIG. 22 shows a data transmission flow between a first client 2210 and a second client 2220. Therein, the architectures or compositions or structures of the first client and the second client are similar. To elaborate the embodiment of the invention more clearly and briefly, the embodiment of the invention will only introduce the structure of the first client 2210 in detail, and the structure of the second client 2220 will not be repeated by the embodiment of the invention. In addition, the two clients in FIG. 22 are only used for illustrating that data transmission can be conducted between different clients, and will not define the transmission procedure, the transmission path between the two clients and parameters such as transmitted data, etc.

Referring to FIG. 22, the first client 2210 comprises at least: a second data obtainer 2211, a data transmitter 2212 and a second data receiver 2213. Now, functions of individual devices or components and a connection relationship between individual parts of the first client 2210 will be introduced. The second data obtainer 2211 in the first client 2210 obtains data in the first client 2210 and its identification information. After the second data obtainer 2211 obtains the data in the first client 2210 and its identification information, the data transmitter 2212 is triggered. The data transmitter 2212 transmits the data in the first client 2210 and its identification information to a first server, and the first server transmits them to a corresponding second client 2220 via a persistent connection server.

According to the embodiment of the invention, the first client 2210 can send data to the second client 2220, which achieves data transmission from the first client 2210 to the second client 2220, solves the problem mentioned in the prior art that data transmission can not be conducted between clients, and further solves the problem that since data transmission can not be conducted between different clients, user requirements must be re-introduced when a new client is enabled, thereby resulting in resource waste and low efficiency.

In particular, the second data obtainer 2211 in the first client 2210 obtains data in the first client 2210 and its identification information. After the second data obtainer 2211 obtains the data in the first client 2210 and its identification information, the data transmitter 2212 is triggered. The data transmitter 2212 is triggered to transmit the data in the first client 2210 and its identification information to a first server, and the first server here is a server corresponding to the first terminal. For example, if the first terminal is a PC, the first server is a PC server.

After receiving the data of the first client 2210, the first server performs legality verification on the data of the first client 2210. Preferably, in an embodiment of the invention, the first server verifies identification information of the first client 2210 to determine whether the identification information of the first client 2210 is legal information, for example, to verify whether the identification information has been registered in a client center, or the identification information is an identifier generated inside the server. If the identification information is verified to be legal information, the first server transmits the identification information to a persistent connection server, and if the identification information is not legal information, the first server refuses to send the identification information to the persistent connection server.

Likewise, the first server may further perform legality verification on other data than the identification information, for example, verify whether webpage data, etc. of the first client 2210 is non-malicious data. In an embodiment of the invention, the malicious data refers to a virus, Trojan, etc. which performs an illegal action of steal, destruction, etc. on data in a user terminal. If the first server verifies that the data of the first client 2210 is the above-mentioned malicious data, the first server refuses to transmit the malicious data to the persistent connection server, and if it is verified by the first server that the data of the first client 2210 is non-malicious data, the first server transmits the data to the persistent connection server. Preferably, in an embodiment of the invention, after legality verification is performed on the data of the first client 2210, the first server may further perform encryption processing on the data of the first client 2210, which more effectively improves the security of data transmission. By performing security verification and processing on the data of the first client 2210 by the first server, the security of data transmission can be guaranteed more effectively, avoiding that in the procedure of data transmission, some malicious network addresses, etc. are attached to the transmitted data and cause damage to a terminal or client of a user.

After performing legality verification on the data of the first client 2210, the first server sends the data on which legality verification has been performed to a corresponding persistent connection server. The first server may communicate with the persistent connection server by multiple protocols, for example, the transmission control protocol, the user datagram protocol, etc. Preferably, in an embodiment of the invention, the first server communicates with the persistent connection server by an HTTP request. The HTTP supports multiple server modes and is simple and fast, and therefore communication by an HTTP request can improve the efficiency of data transmission.

When the persistent connection server receives the data in the first client 2210 and its identification information sent via the first server, the persistent connection server determines a corresponding second client 2220 according to the identification information of the first client 2210, and determines the state of the persistent connection between it and the second client 2220 according to information recorded in an online device list stored in the persistent connection server.

The online device list stored in the persistent connection server records identification information of individual clients which maintain persistent connections with the persistent connection server. If the persistent connection between a certain client and the persistent connection server is disconnected, the identification information corresponding to the disconnected client is deleted in the online device list of the persistent connection server. In the embodiment of the invention, the online device list stored in the persistent connection server can be updated in real time, which ensures that the persistent connection server can timely update information on clients which establish persistent connections with it, avoids that data is sent to a disconnected client since the data update of the online device list is not in time and a malignant consequence such as packet loss, etc. is caused, and improves the security of data transmission.

A specific way in which the persistent connection server determines whether to send the data in the first client 2210 to the second client 2220 is as follows. If according to the online device list of the persistent connection server, the state of the persistent connection between the persistent connection server and the second client 2220 is connected, the persistent connection server sends the data of the first client 2210 to the second client 2220. If according to the online device list of the persistent connection server, the state of the persistent connection between the persistent connection server and the second client 2220 is disconnected, the data of the first client 2210 is stored in the persistent connection server, and then it is not until the state of the persistent connection is recovered that the data of the first client 2210 stored in the persistent connection server is sent to the second client 2220.

In addition, the second data receiver 2213 in the first client 2210 can receive data from the second client 2220 forwarded by a persistent connection server. After receiving the data in the second client 2220, the persistent connection server corresponding to the first client 2210 queries about the state of the persistent connection between it and the first client 2210. When the state of the persistent connection between the persistent connection server and the first client 2210 is connected, the persistent connection server sends the data in the second client 2220 to the first client 2210. The second data receiver 2213 in the first client 2210 receives the data in the second client 2220 sent by the persistent connection server. When the state of the persistent connection between the persistent connection server and the first client 2210 is disconnected, the persistent connection server stores the data in the second client 2220, and will not send the data in the second client 2220 to the first client 2210 until the state of the persistent connection between it and the first client 2210 is recovered.

In the embodiment of the invention, the identification information is identity verification information of a client, it may be identity verification information set by the user, or also may be identity verification information set for a client by a server, which will not be defined by the embodiment of the invention. Preferably, in an embodiment of the invention, the identification information may be account information of user login of the first client 2210, the account information is an account which is applied by the user for registration in a client center, the application of the account information is simple and easy, and each piece of account information may be logged in on multiple clients.

Additionally, the identification information in the embodiment of the invention may also be a character string generated by a server, e.g., a shadow account, which can be taken as a unique identification. The shadow account may be a unique identification generated by the server according to information such as time, machine identification, etc. The shadow account may also be an account randomly generated by the server. After generating the account, the server checks whether the generated shadow account has already existed, and if yes, the server regenerates a shadow account, until the account did not exist before. The shadow account has nonrepeatability and uniqueness, and each shadow account can only identify one client.

Preferably, in an embodiment of the invention, the data of the first client 2210 may be data of any operation which is performed by a user in the first client 2210, or also may be other data updated by the first client 2210, data stored in the first client 2210, etc., which will not be defined by the embodiment of the invention in any way. Preferably, in an embodiment of the invention, the data may comprise individual network addresses collected in the favorites of the first client 2210, a network address currently opened by the first client 2210, commonly used network addresses of the first client 2210, and any user data invoked by the first client 2210 according to a user instruction, etc.

Any data of the first client 2210 may be sent to the second client 2220, which ensures that various operations performed by a user in the first client 2210 may be synchronously updated to the second client 2220, avoids that the user performs repetitive operations and obtains repetitive information in a new client, and further avoids data redundancy and resource waste. A user generally performs on a browser client personalized operations of collecting network addresses, setting commonly used webpages, etc. When the user turns from one terminal to another terminal, he needs to newly enable a new client on another terminal. According to the embodiment of the invention, the personalized operations set by the user on the former client may be automatically synchronized to the newly enabled client, and it is unnecessary for the user to repeat the operations.

In the embodiment of the invention, in addition to client data transmission between different terminals mentioned above, data transmission between different clients on the same terminal and client data transmission between a mobile terminal and a terminal can be further accomplished. Therefore, in an embodiment of the invention, the first terminal and the second terminal may be a terminal such as a desktop computer, a notebook computer, etc., or also may be a mobile terminal such as a mobile phone, a music player, a tablet computer, etc. Preferably, in an embodiment of the invention, the first client 2210 and/or the second client 2220 is/are disposed in a mobile terminal(s), in order that client data transmission between a terminal and a mobile terminal is elucidated more clearly and briefly.

### Embodiment 4.1

FIG. 23 shows a flow chart of a data transmission method according to a preferred embodiment of the invention, which is used for supporting the data transmission method and data transmission device provided in embodiment 4 and elaborating the data transmission method and data transmission device more clearly and briefly. As shown in FIG. 23, in this example, a PC is selected as the first terminal, a mobile phone is the second terminal, and the clients are browser clients. For the convenience of identifying the first client and the second client, in this example, the first client is called a PC browser, the second client is called a mobile phone browser, and the identification information is a unique ID. In addition, this preferred embodiment focuses on describing a procedure of how the PC browser sends data to the mobile phone browser.

As shown in FIG. 23, steps of the preferred embodiment begin at step 1 in which the mobile phone browser establishes a persistent connection with a persistent connection server. A specific way is as follows. The mobile phone browser determines a corresponding persistent connection server according to its own identification information and sends a connection establishment request to the persistent connection server, and in the connection establishment request is carried the identification information of the mobile phone browser. After the persistent connection server receives the connection establishment request sent by the mobile phone browser, the persistent connection server performs identity verification on the mobile phone browser according to the identification information of the mobile phone browser carried in the connection establishment request. Preferably, in an embodiment of the invention, the persistent connection server may further perform identity verification on the mobile phone browser according to other device information of the mobile phone browser, to ensure that the mobile phone browser is a receiving side which receives the data in the PC browser. The other device information of the mobile phone browser may be information of the mobile phone browser, or also may be information of the second terminal. Preferably, in an embodiment of the invention, the other device information comprises the IMEI number of the second terminal, the device name of the second terminal, and the system version number of the second terminal.

After the persistent connection server performs identity verification on the mobile phone browser according to the identification information of the mobile phone browser and its device information, if the mobile phone browser can not pass the identity verification, the persistent connection server refuses to establish a persistent connection with it, and if the mobile phone browser passes the identity verification, the persistent connection server establishes a persistent connection with the mobile phone browser.

After the mobile phone browser establishes a persistent connection with the persistent connection server successfully, the mobile phone browser receives the data in the PC browser from the persistent connection server, and performs corresponding processing according to the data in the PC browser, to ensure that information sharing is achieved between the PC browser and the mobile phone browser, and operations of which the execution was not finished on the PC browser previously can continue to be performed on the mobile phone browser, for example, continue to read content of a webpage.

The data in the PC browser is sent to the mobile phone browser by the PC browser via a PC server and a persistent connection server. Now, a procedure will be introduced in which the PC browser sends the data in the PC browser to a persistent connection server via a PC server.

As described at step 2 in FIG. 23, the PC browser sends the data in the PC browser and a unique ID to a PC server. After receiving the data of the PC browser, the PC server performs legality verification on the data of the PC browser. Preferably, in an embodiment of the invention, the PC server verifies the unique ID of the PC browser in the data to determine whether the unique ID of the PC browser is legal information, for example, to verify whether the unique ID has been registered in a client center, or the unique ID is an identifier generated inside the server. If the unique ID is verified to be legal information, the PC server transmits the unique ID to a persistent connection server, and if the unique ID is not legal information, the PC server refuses to send the unique ID to the persistent connection server.

Likewise, the PC server may further perform legality verification on the data in the PC browser, for example, verify whether webpage data, etc. of the PC browser is non-malicious data. In an embodiment of the invention, the malicious data refers to a virus, Trojan, etc. which performs an illegal action of steal, destruction, etc. on data in a user terminal. If the PC server verifies that the data of the PC browser is the above-mentioned malicious data, the PC server refuses to transmit the malicious data to the persistent connection server, and if it is verified by the PC server that the data of the PC browser is non-malicious data, the PC server transmits the data to the persistent connection server. Preferably, in an embodiment of the invention, after legality verification is performed on the data of the PC browser, the PC server may further perform encryption processing on the data of the PC browser, which more effectively improves the security of data transmission. By performing security verification and processing on the data of the PC browser by the PC server, the security of data transmission can be guaranteed more effectively, avoiding that in the procedure of data transmission, some malicious network addresses, etc. are attached to the transmitted data and cause damage to a terminal or client of a user.

After the PC server performs legality verification on the data of the PC browser, step 3 as shown in FIG. 23 is performed to forward the unique ID and the data in the PC browser on which legality verification has been performed to a corresponding persistent connection server.

When the persistent connection server receives the data in the PC browser and the unique ID sent via the PC server, the persistent connection server determines a corresponding mobile phone browser according to the unique ID of the PC browser, and determines the state of the persistent connection between it and the mobile phone browser according to information recorded in an online device list stored in the persistent connection server.

The online device list stored in the persistent connection server records unique IDs of individual browsers which maintain persistent connections with the persistent connection server. If the persistent connection between a certain browser and the persistent connection server is disconnected, the unique ID corresponding to the disconnected browser is deleted in the online device list of the persistent connection server. In the embodiment of the invention, the online device list stored in the persistent connection server can be updated in real time, which ensures that the persistent connection server can timely update information on browsers which establish persistent connections with it, avoids that data is sent to a disconnected browser since the data update of the online device list is not in time and a malignant consequence such as packet loss, etc. is caused, and improves the security of data transmission.

As shown at step 4 in FIG. 23, the persistent connection server determines whether to send the data in the PC browser to the mobile phone browser according to the state of the persistent connection between it and the mobile phone browser. A specific way in which the persistent connection server determines whether to send the data in the PC browser to the mobile phone browser is as follows. If according to the online device list of the persistent connection server, the state of the persistent connection between the persistent connection server and the mobile phone browser is connected, the persistent connection server sends the data in the PC browser to the mobile phone browser. If according to the online device list of the persistent connection server, the state of the persistent connection between the persistent connection server and the mobile phone browser is disconnected, the data in the PC browser is stored in the persistent connection server, and then it is not until the state of the persistent connection is recovered that the data of the PC browser stored in the persistent connection server is sent to the mobile phone browser.

### Embodiment 4.2

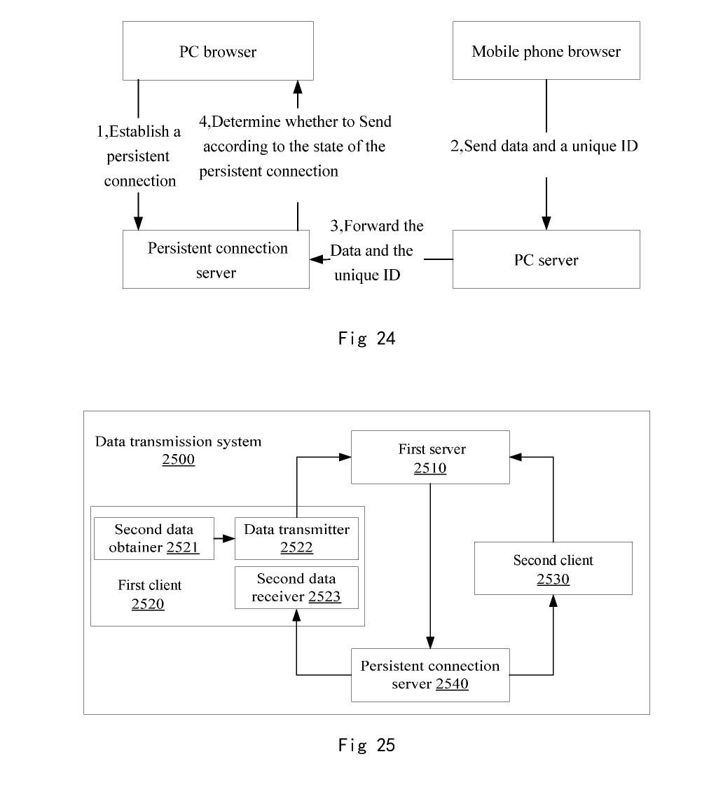

FIG. 24 shows a flow chart of a data transmission method according to another preferred embodiment of the invention, which is used for supporting any data transmission method and data transmission device as described above and elaborating the data transmission method and data transmission device more clearly and briefly. As shown in FIG. 24, in this example, a PC is selected as the first terminal, a mobile phone is the second terminal, and the clients are browser clients. For the convenience of identifying the first client and the second client, in this example, the first client is called a PC browser, the second client is called a mobile phone browser, and the identification information is a unique ID. In addition, this preferred embodiment focuses on describing a procedure of how the mobile phone browser sends data to the PC browser.

As shown in FIG. 24, steps of the preferred embodiment begin at step 1 in which the PC browser establishes a persistent connection with a persistent connection server. A specific way is as follows. The PC browser determines a corresponding persistent connection server according to the unique ID and sends a connection establishment request to the persistent connection server, and in the connection establishment request is carried the unique ID of the PC browser. After the persistent connection server receives the connection establishment request sent by the PC browser, the persistent connection server performs identity verification on the PC browser according to the unique ID of the PC browser carried in the connection establishment request. Preferably, in an embodiment of the invention, the persistent connection server may further perform identity verification on the PC browser according to other device information of the PC browser, to ensure that the PC browser is a receiving side which receives the data in the mobile phone browser. The other device information of the PC browser may be device information of the PC browser, or also may be device information of the first terminal. Preferably, in an embodiment of the invention, the other device information comprises the device name of the first terminal, and the system version number of the first terminal, etc.

After the persistent connection server performs identity verification on the PC browser according to the unique ID of the PC browser and its device information, if the PC browser can not pass the identity verification, the persistent connection server refuses to establish a persistent connection with it, and if the PC browser passes the identity verification, the persistent connection server establishes a persistent connection with the PC browser.

After the PC browser establishes a persistent connection with the persistent connection server successfully, the PC browser receives the data in the mobile phone browser from the persistent connection server, and performs corresponding processing according to the data in the mobile phone browser, to ensure that information sharing is achieved between the mobile phone browser and the PC browser, and operations of which the execution was not finished on the mobile phone browser previously can continue to be performed on the PC browser, for example, continue to read content of a webpage.

The data in the mobile phone browser is sent to the PC browser by the mobile phone browser via a PC server and a persistent connection server. Now, a procedure will be introduced in which the mobile phone browser sends the data in the mobile phone browser to a persistent connection server via a PC server.

As described at step 2 in FIG. 24, the mobile phone browser sends the data in the mobile phone browser and a unique ID to a PC server. After receiving the data and the unique ID of the mobile phone browser, the PC server performs legality verification on the data and the unique ID of the mobile phone browser. Preferably, in an embodiment of the invention, the PC server verifies the unique ID of the mobile phone browser in the data to determine whether the unique ID of the mobile phone browser is legal information, for example, to verify whether the unique ID has been registered in a client center, or the unique ID is an identifier generated inside the server. If the unique ID is verified to be legal information, the PC server transmits the unique ID to a persistent connection server, and if the unique ID is not legal information, the PC server refuses to send the unique ID to the persistent connection server.

Likewise, the PC server may further perform legality verification on the data in the mobile phone browser, for example, verify whether webpage data, etc. of the mobile phone browser is non-malicious data. In an embodiment of the invention, the malicious data refers to a virus, Trojan, etc. which performs an illegal action of steal, destruction, etc. on data in a user terminal. If the PC server verifies that the data of the mobile phone browser is the above-mentioned malicious data, the PC server refuses to transmit the malicious data to the persistent connection server, and if it is verified by the PC server that the data of the mobile phone browser is non-malicious data, the PC server transmits the data to the persistent connection server. Preferably, in an embodiment of the invention, after legality verification is performed on the data of the mobile phone browser, the PC server may further perform encryption processing on the data of the mobile phone browser, which more effectively improves the security of data transmission. By performing security verification and processing on the data of the mobile phone browser by the PC server, the security of data transmission can be guaranteed more effectively, avoiding that in the procedure of data transmission, some malicious network addresses, etc. are attached to the transmitted data and cause damage to a terminal or client of a user.

After the PC server performs legality verification on the data of the mobile phone browser, step 3 as shown in FIG. 24 is performed to forward the unique ID and the data in the mobile phone browser on which legality verification has been performed to a corresponding persistent connection server.

When the persistent connection server receives the data in the mobile phone browser and the unique ID sent via the PC server, the persistent connection server determines a corresponding PC browser according to the unique ID of the mobile phone browser, and determines the state of the persistent connection between it and the PC browser according to information recorded in an online device list stored in the persistent connection server.

The online device list stored in the persistent connection server records unique IDs of individual browsers which maintain persistent connections with the persistent connection server. If the persistent connection between a certain browser and the persistent connection server is disconnected, the unique ID corresponding to the disconnected browser is deleted in the online device list of the persistent connection server. In the embodiment of the invention, the online device list stored in the persistent connection server can be updated in real time, which ensures that the persistent connection server can timely update information on browsers which establish persistent connections with it, avoids that data is sent to a disconnected browser since the data update of the online device list is not in time and a malignant consequence such as packet loss, etc. is caused, and improves the security of data transmission.

As shown at step 4 in FIG. 24, the persistent connection server determines whether to send the data in the mobile phone browser to the PC browser according to the state of the persistent connection between it and the PC browser. A specific way in which the persistent connection server determines whether to send the data in the mobile phone browser to the PC browser is as follows. If according to the online device list of the persistent connection server, the state of the persistent connection between the persistent connection server and the PC browser is connected, the persistent connection server sends the data in the mobile phone browser to the PC browser. If according to the online device list of the persistent connection server, the state of the persistent connection between the persistent connection server and the PC browser is disconnected, the data in the mobile phone browser is stored in the persistent connection server, and then it is not until the state of the persistent connection is recovered that the data in the mobile phone browser stored in the persistent connection server is sent to the PC browser.

On the basis of the data transmission method and device provided in embodiment 4 and based on the same concept, an embodiment of the invention provides a data transmission system. FIG. 25 shows a structural schematic diagram of a data transmission system according to an embodiment of the invention. Referring to FIG. 25, the data transmission system 2500 in the embodiment of the invention comprises at least a first server 2510, a first client 2520, a second client 2530 and a persistent connection server 2540.

To elaborate the embodiment of the invention more clearly and briefly, in the embodiment of the invention, the first client 2520 is disposed in a first terminal, and the second client 2530 is disposed in a second terminal. Now, functions of individual devices or components and a connection relationship between individual parts in the data transmission system in the embodiment of the invention will be introduced. In the data transmission system 2500, a second data obtainer 2521 in the first client 2520 obtains data in the first client 2520 and its identification information, and triggers a data transmitter 2522. The data transmitter 2522 is triggered to transmit the data in the first client 2520 and its identification information to the first server 2510.

After receiving the data of the first client 2520 and its identification information, the first server 2510 performs legality verification on the data of the first client 2520 and its identification information. Preferably, in an embodiment of the invention, the first server 2510 verifies the identification information of the first client 2520 to determine whether the identification information of the first client 2520 is legal information, for example, to verify whether the identification information has been registered in a client center, or the identification information is an identifier generated inside the server. If the identification information is verified to be legal information, the first server 2510 transmits the identification information to a persistent connection server 2540, and if the identification information is not legal information, the first server 2510 refuses to send the identification information to the persistent connection server 2540.

Likewise, the first server 2510 may further perform legality verification on other data than the identification information, for example, verify whether webpage data, etc. of the first client 2520 is non-malicious data. In an embodiment of the invention, the malicious data refers to a virus, Trojan, etc. which performs an illegal action of steal, destruction, etc. on data in a user terminal. If the first server 2510 verifies that the data of the first client 2520 is the above-mentioned malicious data, the first server 2510 refuses to transmit the malicious data to the persistent connection server 2540, and if it is verified by the first server 2510 that the data of the first client 2520 is non-malicious data, the first server 2510 transmits the data to the persistent connection server 2540.

Preferably, in an embodiment of the invention, after legality verification is performed on the data of the first client 2520, the first server 2510 may further perform encryption processing on the data of the first client 2520, which more effectively improves the security of data transmission. By performing security verification and processing on the data of the first client 2520 by the first server 2510, the security of data transmission can be guaranteed more effectively, avoiding that in the procedure of data transmission, some malicious network addresses, etc. are attached to the transmitted data and cause damage to a terminal or client of a user.

After performing legality verification on the data of the first client 2520 and its identification information, the first server 2510 sends the data and the identification information of the first client 2520 on which legality verification has been performed to a corresponding persistent connection server 2540. The first server 2510 may communicate with the persistent connection server 2540 by multiple protocols, for example, the transmission control protocol, the user datagram protocol, etc. Preferably, in an embodiment of the invention, the first server 2510 communicates with the persistent connection server 2540 by an HTTP request. The HTTP supports multiple server modes and is simple and fast, and therefore communication by an HTTP request can improve the efficiency of data transmission.

When the persistent connection server 2540 receives the data in the first client 2520 and its identification information sent via the first server 2510, the persistent connection server 2540 determines a corresponding second client 2530 according to the identification information of the first client 2520, and determines the state of the persistent connection between it and the second client 2530 according to information recorded in an online device list stored in the persistent connection server 2540.

The online device list stored in the persistent connection server 2540 records identification information of individual clients which maintain persistent connections with the persistent connection server 2540. If the persistent connection between a certain client and the persistent connection server 2540 is disconnected, the identification information corresponding to the disconnected client is deleted in the online device list of the persistent connection server 2540. In the embodiment of the invention, the online device list stored in the persistent connection server 2540 can be updated in real time, which ensures that the persistent connection server 2540 can timely update information on clients which establish persistent connections with it, avoids that data is sent to a disconnected client since the data update of the online device list is not in time and a malignant consequence such as packet loss, etc. is caused, and improves the security of data transmission.

A specific way in which the persistent connection server 2540 determines whether to send the data in the first client 2520 to the second client 2530 is as follows. If according to the online device list of the persistent connection server 2540, the state of the persistent connection between the persistent connection server 2540 and the second client 2530 is connected, the persistent connection server 2540 sends the data of the first client 2520 to the second client 2530. If according to the online device list of the persistent connection server 2540, the state of the persistent connection between the persistent connection server 2540 and the second client 2530 is disconnected, the data of the first client 2520 is stored in the persistent connection server 2540, and then it is not until the state of the persistent connection is recovered that the data of the first client 2520 stored in the persistent connection server 2540 is sent to the second client 2530.

From the above, before the second client 2530 receives the data in the first client 2520 from a persistent connection server 2540, it needs to establish a persistent connection with the persistent connection server 2540. Likewise, before the first client 2520 receives the data in the second client 2530 from a persistent connection server 2540, it equally needs to establish a persistent connection with the persistent connection server 2540. Here, it needs to be noted that the persistent connection server corresponding to the first client and the persistent connection server corresponding to the second client may be the same server, or also may be different servers, which are both denoted by 2540 in FIG. 25.

The above portion of the embodiment of the invention is described from the perspective of the first client acting as a data sending side. In view of that the procedure of data transmission of the embodiment of the invention is a bidirectional transmission procedure, the first client may also exist as a data receiving side while it is taken as a data sending side. In the following, the description will be detailed from the perspective of the first client acting as a data receiving side.

Now, a procedure will be particularly introduced in which the first client 2520 establishes a persistent connection with a persistent connection server 2540.

The first client 2520 determines a corresponding persistent connection server 2540 according to the identification information of the first client 2520 and sends a connection establishment request to the persistent connection server 2540, and in the connection establishment request is carried the identification information of the first client 2520. After the persistent connection server 2540 receives the connection establishment request sent by the first client 2520, the persistent connection server 2540 performs identity verification on the first client 2520 according to the identification information of the first client 2520 carried in the connection establishment request. Preferably, in an embodiment of the invention, the persistent connection server 2540 may further perform identity verification on the first client 2520 according to other device information of the first client 2520, to ensure that the first client 2520 is a receiving side which receives the data in the second client 2530. The other device information of the first client 2520 may be device information of the first client 2520, or also may be device information of the first terminal. Preferably, in an embodiment of the invention, the other device information comprises the IMEI number of the first terminal, the device name of the first terminal, and the system version number of the first terminal.

After the persistent connection server 2540 performs identity verification on the first client 2520 according to the identification information of the first client 2520 and its device information, if the first client 2520 can not pass the identity verification, the persistent connection server 2540 refuses to establish a persistent connection with it, and if the first client 2520 passes the identity verification, the persistent connection server 2540 establishes a persistent connection with the first client 2520.

After the first client 2520 establishes a persistent connection with the persistent connection server 2540 successfully, the first client 2520 utilizes a second data receiver 2523 to receive the data in the second client 2530 from the persistent connection server 2540, and performs corresponding processing according to the data in the second client 2530, to ensure that information sharing is achieved between the first client 2520 and the second client 2530, and operations of which the execution was not finished on the second client 2530 previously can continue to be performed on the first client 2520, for example, continue to read content of a webpage.

According to the embodiment of the invention, the first client 2520 can send data to the second client 2530, which achieves data transmission from the first client 2520 to the second client 2530, solves the problem mentioned in the prior art that data transmission can not be conducted between clients, and further solves the problem that since data transmission can not be conducted between different clients, user requirements must be re-introduced when a new client is enabled, thereby resulting in resource waste and low efficiency.

According to any of the above preferred embodiments or a combination of multiple preferred embodiments, an embodiment of the invention can achieve the following beneficial effects:

According to the embodiment of the invention, the first client can send data to the second client, which achieves data transmission from the first client to the second client, solves the problem mentioned in the prior art that data transmission can not be conducted between clients, and further solves the problem that since data transmission can not be conducted between different clients, user requirements must be re-introduced when a new client is enabled, thereby resulting in resource waste and low efficiency.

### Embodiment 5

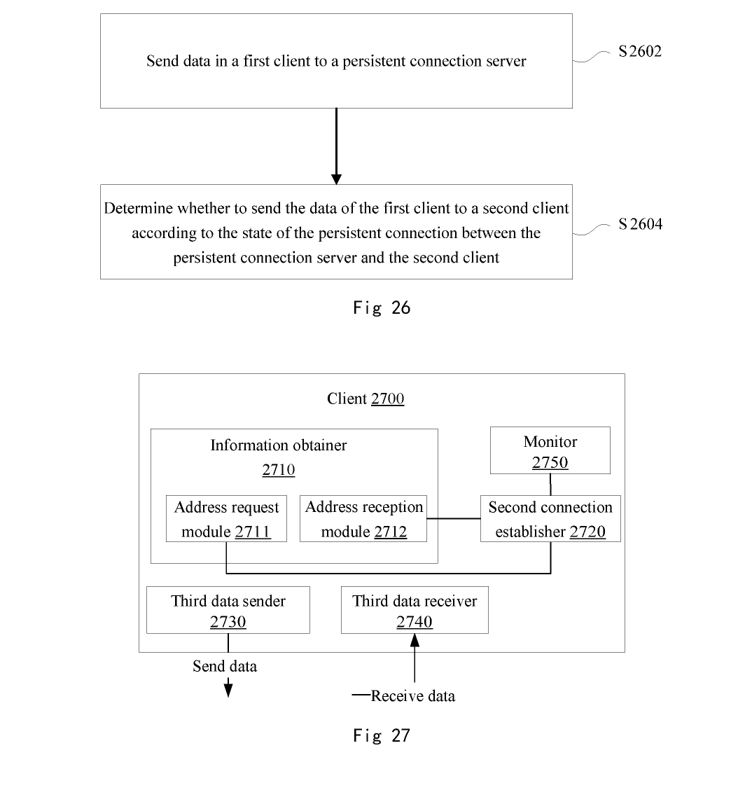

To solve the above technical problems, an embodiment of the invention provides still another data transmission method applied in a situation in which a first client and a second client conduct data transmission wirelessly. FIG. 26 shows a processing flow chart of a data transmission method according to an embodiment of the invention. Referring to FIG. 26, first, S2602 is performed to send data in a first client to a persistent connection server. After the persistent connection server receives the data in the first client, step S2604 is performed to determine whether to forward the data of the first client to a second client according to the state of the persistent connection between the persistent connection server and the second client.

According to the embodiment of the invention, the first client can send data to the second client, which achieves data transmission from the first client to the second client, solves the problem mentioned in the prior art that data transmission can not be conducted between clients, and further solves the problem that since data transmission can not be conducted between different clients, user requirements must be re-introduced when a new client is enabled, thereby resulting in resource waste and low efficiency.

In particular, the second client confirms a corresponding persistent connection server via a persistent connection allocation server according to its own identification information. The second client first sends an address request message carrying its own identification information to the persistent connection allocation server. After receiving the address request message, the persistent connection allocation server confirms a persistent connection server corresponding to the second client according to the identification information of the second client in the address request message, and then returns a response message to the second client. In the response message is carried at least one piece of address information of persistent connection server.

When there are at least two pieces of address information carried in the response message, the second client selects any one of the at least two pieces of address information, determines a corresponding persistent connection server according to the selected address information, and then establishes a persistent connection with the persistent connection server. If the establishment of the persistent connection fails, the second client reselects a piece of address information from the remaining address information carried in the response message, and establishes a persistent connection with a persistent connection server corresponding to the address information.

If the second client still can not successfully establish a persistent connection according to the address information of a persistent connection server carried in the response message, the second client repetitively performs the operation of arbitrarily selecting from the remaining address information carried in the response message, and repetitively performs the operation of establishing a persistent connection with a persistent connection server corresponding to the selected address information, until the second client successfully establishes a persistent connection with a corresponding persistent connection server.

If the second client can not successfully establish a persistent connection with a persistent connection server corresponding to any piece of the address information carried in the response message returned by the persistent connection allocation server this time, the second client resends the address request message to the persistent connection allocation server, and then establishes a persistent connection with a corresponding persistent connection server according to the address information of a persistent connection server(s) returned by the persistent connection allocation server once again.

After the second client successfully establishes a persistent connection with a corresponding persistent connection server, the second client sends a network connectivity detection message to the persistent connection server at intervals of a set time. Preferably, in an embodiment of the invention, the network connectivity detection message is a packet Internet groper (Ping for short hereinafter) message. The Ping message is a message currently widely used for detecting the connectivity of a network. The Ping message can perform network connectivity detection rapidly and efficiently, and therefore, in an embodiment of the invention, the Ping message is preferred as a detection message sent when detecting the connectivity of a network.

In addition, that the second client constantly sends the network connectivity detection message to the persistent connection server is monitored, and if it is monitored that time is out when the second client sends the network connectivity detection message or the sending fails, the persistent connection between the second client and the corresponding persistent connection server is disconnected. After the persistent connection is disconnected, the second client reselects the address information of a persistent connection server, and establishes a persistent connection with a corresponding persistent connection server according to the reselected address information of a persistent connection server. By sending the network connectivity detection message to the persistent connection server at intervals of the preset time, the second client can timely monitor the state of the persistent connection between the second client and the persistent connection server, so that it can timely determine whether to continue to receive a message from the persistent connection server.

At the persistent connection server side, a predetermined duration is set, and then a time interval at which the persistent connection server receives the network connectivity detection message is timed. When the timed time interval exceeds the predetermined duration, the persistent connection server disconnects the persistent connection between it and the second client.

An online device list is stored in the persistent connection server, and the list records identification information of individual clients which maintain persistent connections with the persistent connection server. If the persistent connection between a certain client and the persistent connection server is disconnected, the identification information corresponding to the disconnected client is deleted in the online device list of the persistent connection server. In the embodiment of the invention, the online device list stored in the persistent connection server can be updated in real time, which ensures that the persistent connection server can timely update information of clients which establish persistent connections with it, avoids that data is sent to a disconnected client since the data update of the online device list is not in time and a malignant consequence such as packet loss, etc. is caused, and improves the security of data transmission.

When the persistent connection server receives the data of the first client, the persistent connection server determines a corresponding second client according to the identification information carried in the data of the first client, and determines the state of the persistent connection between it and the second client according to information recorded in the online device list. If the state of the persistent connection is connected, the persistent connection server sends the data of the first client to the second client. If the state of the persistent connection is disconnected, the data of the first client is stored in the persistent connection server, and then it is not until the state of the persistent connection is recovered that the data of the first client stored in the persistent connection server is sent to the second client.

In the embodiment of the invention, the first client and/or the second client may be disposed in any terminal, which will not be defined by the embodiment of the invention. In addition, in the embodiment of the invention, in addition to client data transmission between different terminals mentioned above, client data transmission between a mobile terminal and a terminal can be further accomplished. Therefore, in an embodiment of the invention, the first client and/or the second client may be disposed in a terminal, such as a desktop computer, a notebook computer, etc., or also may be disposed in a mobile terminal, such as a mobile phone, a music player, a tablet computer, etc. Preferably, in an embodiment of the invention, the first client and/or the second client is/are disposed in a mobile terminal(s), in order that client data transmission between different terminals is elucidated more clearly and briefly.

In the embodiment of the invention, the first client and/or the second client may be any clients of the same type, such as a browser client, a security guard client, a reader client, a media player client, or also may be clients of different types, but which implement the same function, which will not be defined by the embodiment of the invention. The first, second herein are only used for differentiating different clients, they do not result in definition of clients' own attributes, order and functions, and the first, second may be interchanged to refer to different clients. That is, in the embodiment of the invention, it may be that the first client sends data of the first client to the second client, or also may be that the second client sends data of the second client to the first client, thereby realizing mutual transmission of information between the clients.

Preferably, in an embodiment of the invention, the first client and/or the second client is/are a browser client. A user generally performs on a browser client personalized operations of collecting network addresses, setting commonly used webpages, etc. When the user turns from one device to another device, he needs to newly enable a new client on another device. According to the embodiment of the invention, the personalized operations set by the user on the former client may be automatically synchronized to the newly enabled client, and it is unnecessary for the user to repeat the operations. Therefore, employing a browser client is a preferred embodiment of the invention, which may show the procedure and beneficial effects of the invention more clearly.

In addition, in the embodiment of the invention, data transmission is conducted between the first client and the second client via a wired network and/or a wireless network, wherein the wired network comprises a data line, and the wireless network comprises Bluetooth, wifi, local area network, etc.

On the basis of the data transmission method provided by embodiment 5 and based on the same inventive concept, an embodiment of the invention provides an apparatus for implementing the data transmission method.

FIG. 27 shows a structural schematic diagram of a data transmission device according to an embodiment of the invention. Referring to FIG. 27, the data transmission device 2700 of the embodiment of the invention comprises at least: an information obtainer 2710, a second connection establisher 2720, a third data sender 2730, a third data receiver 2740 and a monitor 2750. To elaborate the embodiment of the invention more clearly and briefly, in the following, the data transmission device 2700 is referred to as this client 2700.

Now, functions of individual devices or components and a connection relationship between individual parts of this client 2700 of the embodiment of the invention will be introduced. In this client 2700, the second connection establisher 2720 establishes a persistent connection with a corresponding persistent connection server, and then the third data receiver 2740 receives data in other clients sent by the other clients via the persistent connection server corresponding to this client 2700. In addition, the third data sender 2730 in this client 2700 sends data in this client 2700 to other clients.

According to the embodiment of the invention, a first client can send data to a second client, which achieves data transmission from the first client to the second client, solves the problem mentioned in the prior art that data transmission can not be conducted between clients, and further solves the problem that since data transmission can not be conducted between different clients, user requirements must be re-introduced when a new client is enabled, thereby resulting in resource waste and low efficiency.

In particular, the information obtainer 2710 in this client 2700 obtains the address information of a corresponding persistent connection server according to its own identification information. An address request module 2711 in the information obtainer 2710 sends an address request message carrying the identification information of this client 2700 to a persistent connection allocation server. After receiving the address request message, the persistent connection allocation server determines a persistent connection server corresponding to this client 2700 according to the identification information of this client 2700 in the request message, and then returns a response message to the information obtainer 2710. In the response message is carried at least one piece of address information of persistent connection server. Then, an address reception module 2712 in the information obtainer 2710 receives the address message returned by the persistent connection allocation server.

After receiving the address message of a corresponding persistent connection server, the second connection establisher 2720 establishes a persistent connection with a corresponding persistent connection server according to the returned address message of a persistent connection server. When there are at least two pieces of address information carried in the response message returned by the persistent connection allocation server, the second connection establisher 2720 selects any one of the at least two pieces of address information, then determines a corresponding persistent connection server according to the selected address information, and establishes a persistent connection with the determined persistent connection server.

If the establishment of the persistent connection fails, the second connection establisher 2720 reselects a piece of address information from the remaining address information, and establishes a persistent connection with a persistent connection server determined by the reselected address information. The second connection establisher 2720 repetitively performs the operation of selecting address information, and repetitively performs the operation of establishing a persistent connection with a persistent connection server corresponding to the reselected address information, until it successfully establishes a persistent connection with a persistent connection server.

If the second connection establisher 2720 can not successfully establish a persistent connection with a persistent connection server corresponding to any piece of the address information carried in the response message returned by the persistent connection allocation server this time, the information obtainer 2710 is triggered. The information obtainer 2710 again requests the address information of a persistent connection server from the persistent connection allocation server. The second connection establisher 2720 again establishes a persistent connection with a corresponding persistent connection server according to the address information of a persistent connection server(s) returned once again, until the establishment of a persistent connection is successful.

An online device list is stored in the persistent connection server, and the list records identification information of individual clients which maintain persistent connections with the persistent connection server. If the persistent connection between a certain client and the persistent connection server is disconnected, the identification information corresponding to the disconnected client is deleted in the online device list of the persistent connection server. In the embodiment of the invention, the online device list stored in the persistent connection server can be updated in real time, which ensures that the persistent connection server can timely update information of clients which establish persistent connections with it, avoids that data is sent to a disconnected client since the data update of the online device list is not in time and a malignant consequence such as packet loss, etc. is caused, and improves the security of data transmission.

After successfully establishing a persistent connection with a corresponding persistent connection server, this client 2700 sends a network connectivity detection message to the persistent connection server at intervals of a preset duration. Preferably, in an embodiment of the invention, the network connectivity detection message is a Ping message. The Ping message is a message currently widely used for detecting the connectivity of a network. The Ping message can perform network connectivity detection rapidly and efficiently, and therefore, in an embodiment of the invention, the Ping message is preferred as a detection message sent when detecting the connectivity of a network. The monitor 2750 in this client 2700 monitors the network connectivity detection message constantly sent by the second connection establisher 2720, and if it is monitored that time is out when the second connection establisher 2720 sends the network connectivity detection message or the sending fails, the monitor 2750 triggers the second connection establisher 2720. When triggered by the monitor 2750, the second connection establisher 2720 disconnects the persistent connection between this client 2700 and the current persistent connection server. After the persistent connection between this client 2700 and the persistent connection server is disconnected, it reselects the address of a persistent connection server, determines a corresponding persistent connection server, and establishes a persistent connection with the determined persistent connection server.

In addition, the third data sender 2730 in this client 2700 sends data in this client 2700 and its identification information to the persistent connection server, and the persistent connection server determines whether to send the data in this client 2700 to other client according to the state of the persistent connection between the persistent connection server and the other client.

In the embodiment of the invention, this client 2700 and/or other client may be disposed in any terminal, which will not be defined by the embodiment of the invention. In addition, in the embodiment of the invention, in addition to client data transmission between different terminals mentioned above, client data transmission between a mobile terminal and a terminal can be further accomplished. Therefore, in an embodiment of the invention, this client 2700 and/or other client may be disposed in a terminal, such as a desktop computer, a notebook computer, etc., or also may be disposed in a mobile terminal, such as a mobile phone, a music player, a tablet computer, etc. Preferably, in an embodiment of the invention, this client 2700 and/or other client is/are disposed in a mobile terminal(s), in order that client data transmission between different terminals is elucidated more clearly and briefly.

In the embodiment of the invention, this client 2700 and/or other client may be any clients of the same type, such as a browser client, a security guard client, a reader client, a media player client, or also may be clients of different types, but which implement the same function, which will not be defined by the embodiment of the invention. This, other herein are only used for differentiating different clients, they do not result in definition of clients' own attributes, order and functions, and this, other may be interchanged to refer to different clients. That is, in the embodiment of the invention, it may be that this client 2700 sends data of this client 2700 to other client, or also may be that other client sends data of the other client to this client 2700, thereby realizing mutual transmission of information between the clients.

Preferably, in an embodiment of the invention, this client 2700 and/or other client is/are a browser client. A user generally performs on a browser client personalized operations of collecting network addresses, setting commonly used webpages, etc. When the user turns from one device to another device, he needs to newly enable a new client on another device. According to the embodiment of the invention, the personalized operations set by the user on the former client may be automatically synchronized to the newly enabled client, and it is unnecessary for the user to repeat the operations. Therefore, employing a browser client is a preferred embodiment of the invention, which may show the procedure and beneficial effects of the invention more clearly.

In addition, in the embodiment of the invention, data transmission is conducted between this client 2700 and other client via a wired network and/or a wireless network, wherein the wired network comprises a data line, and the wireless network comprises Bluetooth, wifi, local area network, etc.

On the basis of the data transmission method and device provided by embodiment 5 and based on the same inventive concept, an embodiment of the invention provides a wireless data transmission system.

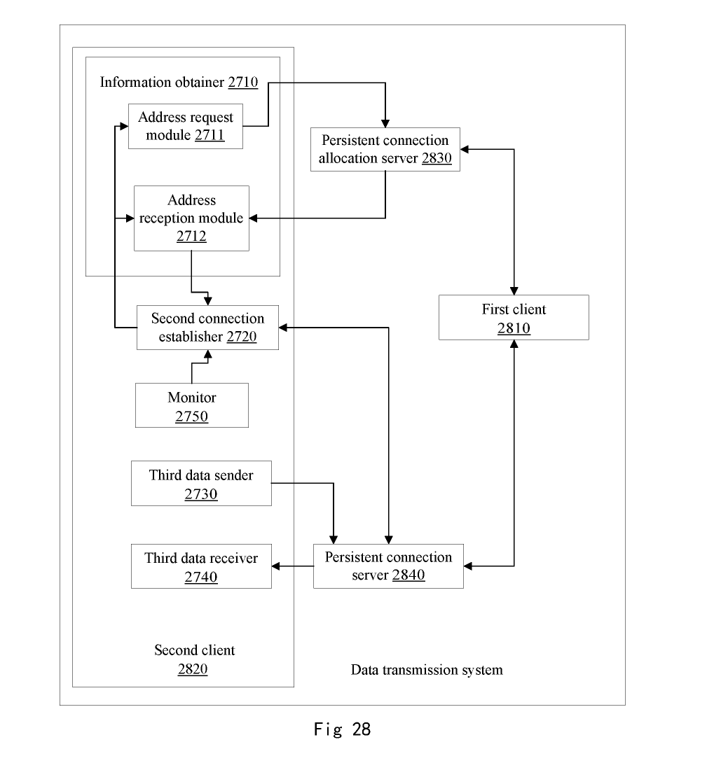

FIG. 28 shows a structural schematic diagram of a data transmission system according to an embodiment of the invention. As shown in FIG. 28, the data transmission system in the embodiment of the invention comprises a first client 2810, a second client 2820, a persistent connection allocation server 2830 and a persistent connection server 2840. Therein, the internal structures of the first client 2810 and the second client 2820 is referred to the client as shown in FIG. 27, and in order to differentiate the first client and the second client in this flow and not to make the two be confused, they are denoted as the first client 2810 and the second client 2820, respectively.

Now, functions of individual devices or components and a connection relationship between individual parts in the data transmission system of the embodiment of the invention will be introduced. The first client 2810 sends data to the second client 2820 via a persistent connection server 2840. After establishing a persistent connection with a persistent connection server 2840, the second client 2820 receives the data sent by the first client 2810 from the persistent connection server 2840.

The information obtainer 2710 in the second client 2820 obtains the address information of a corresponding persistent connection server 2840 according to its own identification information. The address request module 2711 in the information obtainer 2710 sends an address request message carrying the identification information of the second client 2820 to the persistent connection allocation server 2830. After receiving the address request message, the persistent connection allocation server 2830 determines a persistent connection server 2840 corresponding to the second client 2820 according to the identification information in the request message, and then returns a response message to the information obtainer 2710. In the response message is carried at least one piece of address information of persistent connection server 2840. Then, the address reception module 2712 in the information obtainer 2710 receives the address message returned by the persistent connection allocation server 2830.

After receiving the address message of a corresponding persistent connection server 2840, the second connection establisher 2720 establishes a persistent connection with a corresponding persistent connection server 2840 according to the returned address message of a persistent connection server 2840. When there are at least two pieces of address information carried in the response message returned by the persistent connection allocation server 2830, the second connection establisher 2720 selects any one of the at least two pieces of address information, then determines a corresponding persistent connection server 2840 according to the selected address information, and establishes a persistent connection with the determined persistent connection server 2840.

If the establishment of the persistent connection fails, the second connection establisher 2720 reselects a piece of address information from the remaining address information, and establishes a persistent connection with a persistent connection server determined by the reselected address information. The second connection establisher 2720 repetitively performs the operation of selecting address information, and repetitively performs the operation of establishing a persistent connection with a persistent connection server 2840 corresponding to the reselected address information, until it successfully establishes a persistent connection with a persistent connection server 2840.

If the second connection establisher 2720 can not successfully establish a persistent connection with a persistent connection server 2840 corresponding to any piece of the address information carried in the response message returned by the persistent connection allocation server this time, the information obtainer 2710 is triggered. The information obtainer 2710 again requests the address information of a persistent connection server 2840 from the persistent connection allocation server 2830. Then, the second connection establisher 2720 again establishes a persistent connection with a corresponding persistent connection server 2840 according to the address information of a persistent connection server(s) 2840 returned once again, until the establishment of a persistent connection is successful.

An online device list is stored in the persistent connection server 2840, and the list records identification information of individual clients which maintain persistent connections with the persistent connection server 2840. If the persistent connection between a certain client and the persistent connection server 2840 is disconnected, the identification information corresponding to the disconnected client is deleted in the online device list of the persistent connection server 2840. The real-time update of the online device list in the persistent connection server 2840 ensures that the persistent connection server 2840 can timely update information on clients which establish persistent connections with it, and improves the security of data transmission.

After successfully establishing a persistent connection with a corresponding persistent connection server 2840, the second client 2820 sends a network connectivity detection message to the persistent connection server at intervals of a preset duration. The monitor 2750 in the second client 2820 monitors the network connectivity detection message constantly sent by the second connection establisher 2720, and if it is monitored that time is out when the second client 2820 sends the network connectivity detection message or the sending fails, the monitor 2750 triggers the second connection establisher 2720. When triggered by the monitor 2750, the second connection establisher 2720 disconnects the persistent connection between the second client 2820 and the current persistent connection server 2840. Then, it reselects the address of a persistent connection server 2840, determines a corresponding persistent connection server 2840, and establishes a persistent connection with the determined persistent connection server 2840.

When the persistent connection server 2840 receives the data sent by the first client 2810, the persistent connection server 2840 searches for the state of the persistent connection between it and a corresponding second client 2820 according to the online device list stored in it. If the state of the persistent connection is connected, the persistent connection server 2840 sends the data of the first client 2810 to the third data receiver 2740 of the second client 2820. If the state of the persistent connection is disconnected, the data of the first client 2810 is stored in the persistent connection server 2840, and then it is not until the state of the persistent connection is recovered that the data of the first client 2810 stored in the persistent connection server 2840 is sent to the second client 2820. In addition, by a similar mechanism, the data in the second client 2820 may be sent to the first client 2810, of which the specific procedure will not be repeated here.

According to the embodiment of the invention, the first client can send data to the second client, which achieves data transmission from the first client to the second client, solves the problem mentioned in the prior art that data transmission can not be conducted between clients, and further solves the problem that since data transmission can not be conducted between different clients, user requirements must be re-introduced when a new client is enabled, thereby resulting in resource waste and low efficiency.

In the embodiment of the invention, the first client 2810 and/or the second client 2820 may be disposed in any terminal, which will not be defined by the embodiment of the invention. In addition, in the embodiment of the invention, in addition to client data transmission between different terminals mentioned above, client data transmission between a mobile terminal and a terminal can be further accomplished. Therefore, in an embodiment of the invention, the first client 2810 and/or the second client 2820 may be disposed in a terminal, such as a desktop computer, a notebook computer, etc., or also may be disposed in a mobile terminal, such as a mobile phone, a music player, a tablet computer, etc. Preferably, in an embodiment of the invention, the first client 2810 and/or the second client 2820 is/are disposed in a mobile terminal(s), in order that client data transmission between different terminals is elucidated more clearly and briefly.

In the embodiment of the invention, the first client 2810 and/or the second client 2820 may be any clients of the same type, such as a browser client, a security guard client, a reader client, a media player client, or also may be clients of different types, but which implement the same function, which will not be defined by the embodiment of the invention. The first, second herein are only used for differentiating different clients, they do not result in definition of clients' own attributes, order and functions, and the first, second may be interchanged to refer to different clients. That is, in the embodiment of the invention, it may be that the first client 2810 sends data of the first client 2810 to the second client 2820, or also may be that the second client 2820 sends data of the second client 2820 to the first client 2810 utilizing the third data sender 2730, thereby realizing mutual transmission of information between the clients.

Preferably, in an embodiment of the invention, the first client 2810 and/or the second client 2820 is/are a browser client. A user generally performs on a browser client personalized operations of collecting network addresses, setting commonly used webpages, etc. When the user turns from one device to another device, he needs to newly enable a new client on another device. According to the embodiment of the invention, the personalized operations set by the user on the former client may be automatically synchronized to the newly enabled client, and it is unnecessary for the user to repeat the operations. Therefore, employing a browser client is a preferred embodiment of the invention, which may show the procedure and beneficial effects of the invention more clearly.

In addition, in the embodiment of the invention, data transmission is conducted between the first client 2810 and the second client 2820 via a wired network and/or a wireless network, wherein the wired network comprises a data line, and the wireless network comprises Bluetooth, wifi, local area network, etc.

### Embodiment 5.1

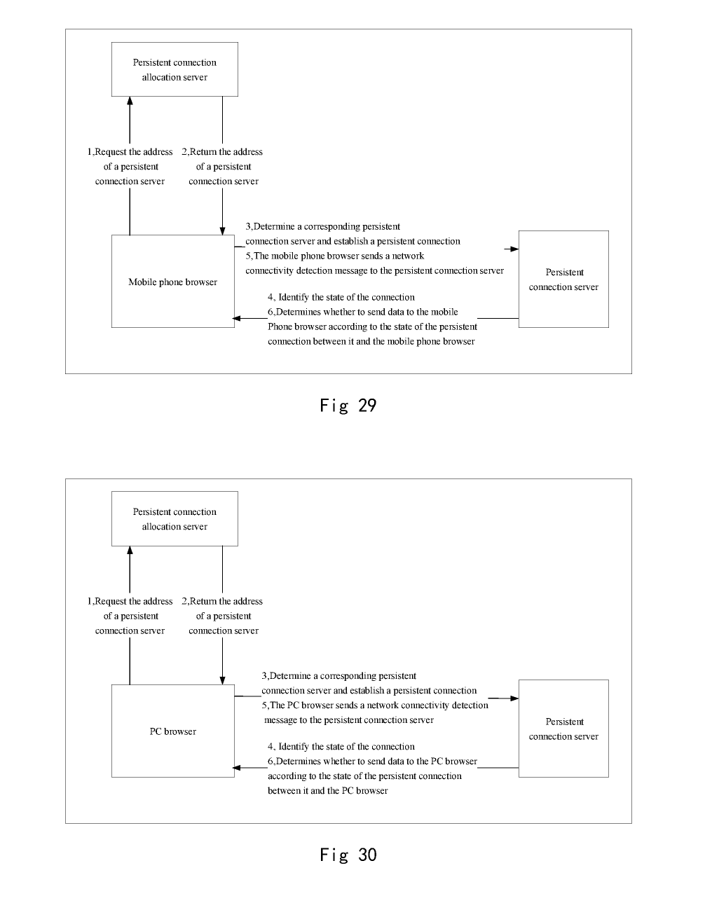

FIG. 29 shows a flow chart of a data transmission method according to a preferred embodiment of the invention, which is used for supporting any of the data transmission methods and data transmission devices provided in embodiment 5 and elaborating the data transmission method and data transmission device more clearly. As shown in FIG. 29, in this example, a PC is selected as the first terminal, a mobile phone is the second terminal, the clients are browser clients, the first client is disposed in the first terminal, and the second client is disposed in the second terminal. For the convenience of identifying the first client and the second client, in this example, the first client is disposed in a PC and called a PC browser, and the second client is disposed in a mobile phone and called a mobile phone browser.

With reference to FIG. 29, the mobile phone browser confirms a corresponding persistent connection server via a persistent connection allocation server according to its own identification information. As shown at step 1 in FIG. 29, the mobile phone browser first sends an address request message carrying its own identification information to the persistent connection allocation server. After receiving the address request message, the persistent connection allocation server performs step 2 as shown in FIG. 29 to confirm a persistent connection server corresponding to the mobile phone browser according to the identification information of the mobile phone browser in the address request message, and then return a response message to the mobile phone browser. In the response message is carried at least one piece of address information of persistent connection server.

When there are at least two pieces of address information carried in the response message, the mobile phone browser selects any one of the at least two pieces of address information, performs step 3 to determine a corresponding persistent connection server according to the selected address information, and send a request message for requesting to establish a persistent connection to the persistent connection server. If the establishment of the persistent connection fails, the mobile phone browser reselects a piece of address information from the remaining address information carried in the response message, and establishes a persistent connection with a persistent connection server corresponding to the address information. If the mobile phone browser still can not successfully establish a persistent connection according to the address information of a persistent connection server carried in the response message, the mobile phone browser repetitively performs the operation of arbitrarily selecting from the remaining address information carried in the response message, and repetitively performs the operation of establishing a persistent connection with a persistent connection server corresponding to the selected address information, until the mobile phone browser successfully establishes a persistent connection with a corresponding persistent connection server.

If the mobile phone browser can not successfully establish a persistent connection with a persistent connection server corresponding to any piece of the address information carried in the response message returned by the persistent connection allocation server this time, the mobile phone browser resends the address request message to the persistent connection allocation server, and then sends a request for establishing a persistent connection to a persistent connection server according to address information returned by the persistent connection allocation server once again.

After the persistent connection server receives the request for establishing a persistent connection sent by the mobile phone browser, step 4 is performed to identify the state of the persistent connection between it and the mobile phone browser to be connected in a local online device list according to the identification information of the mobile phone browser carried in the request message. After the establishment of a persistent connection between the mobile phone browser and the persistent connection server is successful, step 5 is triggered in which the mobile phone browser sends a network connectivity detection message to the persistent connection server. That the mobile phone browser constantly sends the network connectivity detection message to the persistent connection server is monitored, and if it is monitored that time is out when the mobile phone browser sends the network connectivity detection message or the sending fails, the persistent connection between the mobile phone browser and the corresponding persistent connection server is disconnected. After the persistent connection is disconnected, the mobile phone browser reselects the address information of a persistent connection server, and establishes a persistent connection with a corresponding persistent connection server according to the reselected address information of a persistent connection server.

In addition, at the persistent connection server side, a predetermined duration is set, and then a time interval at which the persistent connection server receives the network connectivity detection message is timed. When the timed time interval exceeds the predetermined duration, the persistent connection server disconnects the persistent connection between it and the mobile phone browser, and identifies the state of the persistent connection between it and the mobile phone browser to be disconnected in the online device list.

When the persistent connection server receives the data of the PC browser, step 6 in FIG. 29 is performed. Firstly, the persistent connection server determines a corresponding mobile phone browser according to the identification information carried in the data of the PC browser, and determines the state of the persistent connection between it and the mobile phone browser according to information recorded in the online device list. Secondly, the persistent connection server determines whether to send the data in the PC browser to the mobile phone browser according to the state of the persistent connection. In particular, if the state of the persistent connection between the persistent connection server and the mobile phone browser is connected, the data of the PC browser is sent to the mobile phone browser, and if the state of the persistent connection is disconnected, the data of the PC browser is stored in the persistent connection server, and it is not until the state of the persistent connection between the persistent connection server and the mobile phone browser is recovered that the data of the PC browser is sent to the mobile phone browser.

### Embodiment 5.2

FIG. 30 shows a flow chart of a data transmission method according to another preferred embodiment of the invention, which is used for supporting any of the data transmission methods and data transmission devices and elaborating the data transmission method and data transmission device more clearly. As shown in FIG. 30, in this example, a PC is selected as the first terminal, a mobile phone is the second terminal, and the clients are browser clients. For the convenience of identifying the first client and the second client, in this example, the first client is disposed in a PC and called a PC browser, and the second client is disposed in a mobile phone and called a mobile phone browser.

With reference to FIG. 30, the PC browser confirms a corresponding persistent connection server via a persistent connection allocation server according to its own identification information. As shown at step 1 in FIG. 30, the PC browser first sends an address request message carrying its own identification information to the persistent connection allocation server. After receiving the address request message, the persistent connection allocation server performs step 2 as shown in FIG. 30 to confirm a persistent connection server corresponding to the PC browser according to the identification information of the PC browser in the address request message, and then return a response message to the PC browser. In the response message is carried at least one piece of address information of persistent connection server.

When there are at least two pieces of address information carried in the response message, the PC browser selects any one of the at least two pieces of address information, performs step 3 to determine a corresponding persistent connection server according to the selected address information, and send a request message for requesting to establish a persistent connection to the persistent connection server. If the establishment of the persistent connection fails, the PC browser reselects a piece of address information from the remaining address information carried in the response message, and establishes a persistent connection with a persistent connection server corresponding to the address information. If the PC browser still can not successfully establish a persistent connection according to the address information of a persistent connection server carried in the response message, the PC browser repetitively performs the operation of arbitrarily selecting from the remaining address information carried in the response message, and repetitively performs the operation of establishing a persistent connection with a persistent connection server corresponding to the selected address information, until the PC browser successfully establishes a persistent connection with a corresponding persistent connection server.

If the PC browser can not successfully establish a persistent connection with a persistent connection server corresponding to any piece of the address information carried in the response message returned by the persistent connection allocation server this time, the PC browser resends the address request message to the persistent connection allocation server, and then sends a request for establishing a persistent connection to a persistent connection server according to address information returned by the persistent connection allocation server once again.

After the persistent connection server receives the request for establishing a persistent connection sent by the PC browser, step 4 is performed to identify the state of the persistent connection between it and the PC browser to be connected in a local online device list according to the identification information of the PC browser carried in the request message. After the establishment of a persistent connection between the PC browser and the persistent connection server is successful, step 5 in FIG. 30 is triggered in which the PC browser sends a network connectivity detection message to the persistent connection server. That the PC browser constantly sends the network connectivity detection message to the persistent connection server is monitored, and if it is monitored that time is out when the PC browser sends the network connectivity detection message or the sending fails, the persistent connection between the PC browser and the corresponding persistent connection server is disconnected. After the persistent connection is disconnected, the PC browser reselects the address information of a persistent connection server, and establishes a persistent connection with a corresponding persistent connection server according to the reselected address information of a persistent connection server.

In addition, at the persistent connection server side, a predetermined duration is set, and then a time interval at which the persistent connection server receives the network connectivity detection message is timed. When the timed time interval exceeds the predetermined duration, the persistent connection server disconnects the persistent connection between it and the PC browser, and identifies the state of the persistent connection between it and the PC browser to be disconnected in the online device list.

When the persistent connection server receives the data of the mobile phone browser, step 6 in FIG. 30 is performed. Firstly, the persistent connection server determines a corresponding PC browser according to the identification information carried in the data of the mobile phone browser, and determines the state of the persistent connection between it and the PC browser according to information recorded in the online device list. Secondly, the persistent connection server determines whether to send the data in the mobile phone browser to the PC browser according to the state of the persistent connection. In particular, if the state of the persistent connection between the persistent connection server and the PC browser is connected, the data of the mobile phone browser is sent to the PC browser, and if the state of the persistent connection is disconnected, the data of the mobile phone browser is stored in the persistent connection server, and it is not until the state of the persistent connection between the persistent connection server and the PC browser is recovered that the data of the mobile phone browser is sent to the PC browser.

According to any of the above preferred embodiments or a combination of multiple preferred embodiments, an embodiment of the invention can achieve the following beneficial effects:

According to the embodiment of the invention, the first client can send data to the second client, which achieves data transmission from the first client to the second client, solves the problem mentioned in the prior art that data transmission can not be conducted between clients, and further solves the problem that since data transmission can not be conducted between different clients, user requirements must be re-introduced when a new client is enabled, thereby resulting in resource waste and low efficiency.

In the specification provided herein, a plenty of particular details are described. However, it can be appreciated that an embodiment of the invention may be practiced without these particular details. In some embodiments, well known methods, structures and technologies are not illustrated in detail so as not to obscure the understanding of the specification.

Similarly, it shall be appreciated that in order to simplify the disclosure and help the understanding of one or more of all the inventive aspects, in the above description of the exemplary embodiments of the invention, sometimes individual features of the invention are grouped together into a single embodiment, figure or the description thereof. However, the disclosed methods should not be construed as reflecting the following intention, namely, the claimed invention claims more features than those explicitly recited in each claim. More precisely, as reflected in the following claims, an aspect of the invention lies in being less than all the features of individual embodiments disclosed previously. Therefore, the claims complying with a particular implementation are hereby incorporated into the particular implementation, wherein each claim itself acts as an individual embodiment of the invention.

It may be appreciated to those skilled in the art that modules in a device in an embodiment may be changed adaptively and arranged in one or more device different from the embodiment. Modules or units or assemblies may be combined into one module or unit or assembly, and additionally, they may be divided into multiple sub-modules or sub-units or subassemblies. Except that at least some of such features and/or procedures or units are mutually exclusive, all the features disclosed in the specification (including the accompanying claims, abstract and drawings) and all the procedures or units of any method or device disclosed as such may be combined employing any combination. Unless explicitly stated otherwise, each feature disclosed in the specification (including the accompanying claims, abstract and drawings) may be replaced by an alternative feature providing an identical, equal or similar objective.

Furthermore, it can be appreciated to the skilled in the art that although some embodiments described herein comprise some features and not other features comprised in other embodiment, a combination of features of different embodiments is indicative of being within the scope of the invention and forming a different embodiment. For example, in the following claims, any one of the claimed embodiments may be used in any combination.

Embodiments of the individual components of the invention may be implemented in hardware, or in a software module running on one or more processors, or in a combination thereof. It will be appreciated by those skilled in the art that, in practice, some or all of the functions of some or all of the components in a device or apparatus or system according to individual embodiments of the invention may be realized using a microprocessor or a digital signal processor (DSP). The invention may also be implemented as a device or apparatus program (e.g., a computer program and a computer program product) for carrying out a part or all of the method as described herein. Such a program implementing the invention may be stored on a computer readable medium, or may be in the form of one or more signals. Such a signal may be obtained by downloading it from an Internet website, or provided on a carrier signal, or provided in any other form.

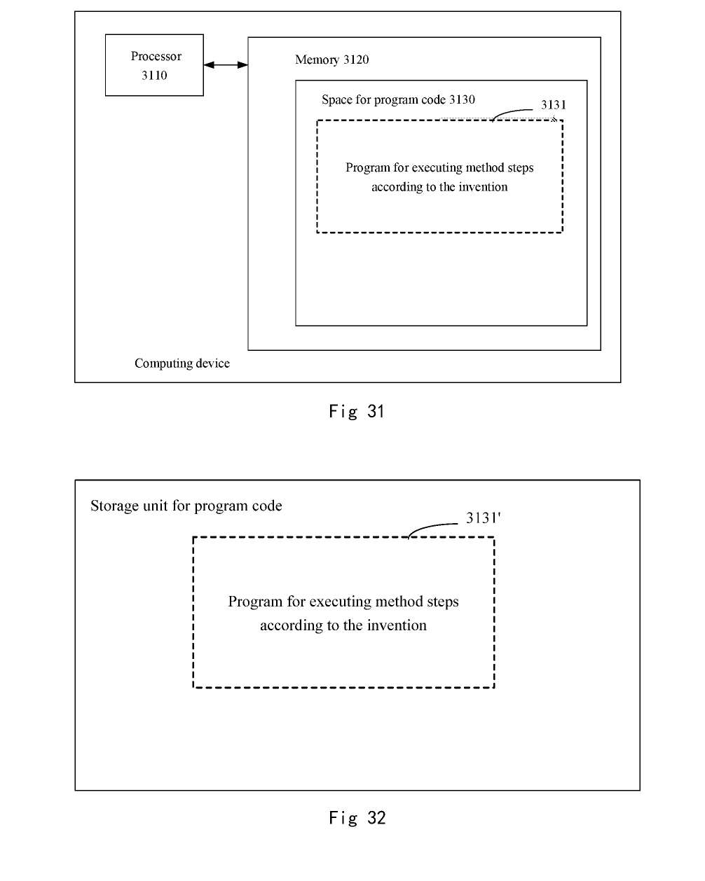

For example, FIG. 31 shows a computing device which may carry out a data transmission method according to the invention. The computing device traditionally comprises a processor 3110 and a computer program product or a computer readable medium in the form of a memory 3120. The memory 3120 may be an electronic memory such as a flash memory, an EEPROM (electrically erasable programmable read-only memory), an EPROM, a hard disk or a ROM. The memory 3120 has a memory space 3130 for a program code 3131 for carrying out any method steps in the methods as described above. For example, the memory space 3130 for a program code may comprise individual program codes 3131 for carrying out individual steps in the above methods, respectively. The program codes may be read out from or written to one or more computer program products. These computer program products comprise such a program code carrier as a hard disk, a compact disk (CD), a memory card or a floppy disk. Such a computer program product is generally a portable or stationary storage unit as described with reference to FIG. 32. The storage unit may have a memory segment, a memory space, etc. arranged similarly to the memory 3120 in the computing device of FIG. 31. The program code may for example be compressed in an appropriate form. In general, the storage unit comprises a computer readable code 3131′, i.e., a code which may be read by e.g., a processor such as 3110, and when run by a computing device, the codes cause the computing device to carry out individual steps in the methods described above.

“An embodiment”, “the embodiment” or “one or more embodiments” mentioned herein implies that a particular feature, structure or characteristic described in connection with an embodiment is included in at least one embodiment of the invention. In addition, it is to be noted that, examples of a phrase “in an embodiment” herein do not necessarily all refer to one and the same embodiment.

It is to be noted that the above embodiments illustrate rather than limit the invention, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a unit claim enumerating several apparatuses, several of the apparatuses may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the invention. Therefore, for those of ordinary skills in the art, many modifications and variations are apparent without departing the scope and spirit of the appended claims. For the scope of the invention, the disclosure of the invention is illustrative, but not limiting, and the scope of the invention is defined by the appended claims.

1. A first terminal, comprising:
a first client;
a memory having instructions stored thereon; and
a processor configured to execute the instructions to perform operations for data transmission, the operations comprising:
determining that the first terminal is connected with a second terminal;
obtaining identification information of the first client and data in the first client;
transmitting the identification information to the second terminal;
transmitting the identification information and the data to a corresponding persistent connection server via a first server of the first terminal; and
further transmitting the data to the second client by the persistent connection server.

2. The first terminal as in claim 1, the operations further comprising:
sending an address request message to a persistent connection allocation server, wherein in the address request message is carried the identification information; and
receiving a response message returned by the persistent connection allocation server, wherein in the response message is carried the address information of the persistent connection server.

3. The first terminal as in claim 1, wherein the data in the first client comprises at least one of the following:
network addresses collected in the favorites of the first client;
commonly used network addresses of the first client;
a network address currently opened by the first client; and
user data invoked by the first client according to a user instruction.

4. The first terminal as in claim 1, wherein the identification information comprises any of the following:
account information logged in by a user of the first client; and
a unique identification generated for the first client.

5. The first terminal as in claim 1, wherein the first terminal is connected with the second terminal via a USB data line.

6. The first terminal as in claim 1, wherein the first client and/or the second client is/are a browser client.

7. The first terminal as in claim 1, the operation of transmitting the data to the second client further comprising:
determining whether to forward the data of the first client to the second client according to a persistent connection state of the second client and the persistent connection server.

8. The first terminal as in claim 1, the operation of transmitting the identification information and the data to a corresponding persistent connection server via a first server of the first terminal comprising:
performing security verification on the data in the first client and its identification information by the first server; and
forwarding the data in the first client and its identification information which pass the security verification to the persistent connection server which is determined according to the identification information of the first client.

9. The first terminal as in claim 8, wherein the data of the first client which passes the security verification is non-malicious data, and the identification information of the first client which passes the security verification is identification information of the first client which has been registered in the first server.

10. The first terminal as in claim 7, the operation of determining whether to forward the data of the first client to the second client according to a persistent connection state of the second client and the persistent connection server comprising:
forwarding the data of the first client to the second client when the persistent connection state of the second client and the persistent connection server is a connected state; and
storing the data in the first client in the persistent connection server when the persistent connection state of the second client and the persistent connection server is a non-connected state; and sending the stored data in the first client to the second client by the persistent connection server when the state of the persistent connection between the second client and the persistent connection server is turned from a non-connected state to a connected state.

11. The first terminal as in claim 7, the operation of determining the persistent connection state of the second client and the persistent connection server comprising:
querying about the persistent connection state of the second client and the persistent connection server in an online device list stored in the persistent connection server, wherein in the online device list is stored identification information of individual clients which have established persistent connections with the persistent connection server;
determining the persistent connection state of the second client and the persistent connection server to be a connected state if the identification information of the second client is queried out; and
determining the persistent connection state of the second client and the persistent connection server to be a non-connected state if the identification information of the second client is not queried out.

12. A second terminal, comprising:
a second client;
a memory having instructions stored thereon; and
a processor configured to execute the instructions to perform operations for data transmission, the operations comprising:
determining that the second terminal is connected with a first terminal;
receiving identification information of a first client disposed in the first terminal sent by the first client;
obtaining the identification information and searching for address information of a corresponding persistent connection server according to the identification information; and
establishing a persistent connection between the second client and the persistent connection server according to the obtained address information, such that the second client receives data from the persistent connection server;
wherein the operation of searching for address information of a corresponding persistent connection server according to the identification information comprising
sending an address request message to a persistent connection allocation server, wherein in the address request message is carried the identification information; and
receiving a response message returned by the persistent connection allocation server, wherein in the response message is carried the address information of the persistent connection server.

13. The second terminal as in claim 12, after the operation of establishing a persistent connection between the second client and the persistent connection server, the operations further comprising:
receiving data from the persistent connection server, wherein the data is data which is uploaded to the persistent connection server by the first client; and
performing processing by the second client according to the data.

14. The second terminal as in claim 13, wherein the data comprises at least one of:
individual network addresses collected in the favorites of the first client;
commonly used network addresses of the first client;
a network address currently opened by the first client; and
user data invoked by the first client according to a user instruction.

15. The second terminal as in claim 14, wherein the operation of performing processing by the second client comprises at least one of:
the second client updating the favorites;
the second client updating the commonly used network addresses; and
the second client opening a webpage corresponding to a network address.

16. The second terminal as in claim 12, wherein after the operation of receiving the identification information of the first client, if it is queried out that the second client does not exist in the second terminal, an installation package of the second client is obtained and installed in the second terminal.

17. The second terminal as in claim 12, when there are at least two pieces of address information carried in the response message, the operation of establishing a persistent connection between the second client and the persistent connection server comprising:
selecting any one of the at least two pieces of address information, determining a corresponding persistent connection server according to the selected address information, and establishing a persistent connection between the second client and the determined persistent connection server;
if the establishment of the persistent connection fails, reselecting a piece of address information from the remaining address information, and establishing a persistent connection between the second client and a persistent connection server determined by the reselected address information; and
repetitively performing the operations of selecting address information and establishing a persistent connection, until the establishment of a persistent connection between the second client and a persistent connection server determined according to the selected address information is successful.

18. The second terminal as in claim 17, if the second client cannot successfully establish a persistent connection with a persistent connection server corresponding to any piece of the address information, the operations further comprising:
resending the address request message to the persistent connection allocation server; and
establishing a persistent connection between the second client and a persistent connection server corresponding to address information reallocated according to the address information of persistent connection servers reallocated by the persistent connection allocation server.

19. The second terminal as in claim 12, after the establishment of a persistent connection is successful, the operations further comprising:
monitoring a network connectivity detection message constantly sent by the second client, and if it is monitored that time is out when the second client sends the network connectivity detection message or the sending fails, disconnecting the persistent connection between the second client and the persistent connection server; and
reselecting the address information of a persistent connection server, determining a corresponding persistent connection server and establishing a persistent connection between the second client and the reselected persistent connection server.

20. A data transmission system comprising a first client disposed in a first terminal and a second client disposed in a second terminal, the first terminal being connected with the second terminal, and the data transmission system further comprising a first server corresponding to the first terminal, a persistent connection allocation server, and a persistent connection server, wherein:
the first client is configured to transmit its own identification information to the second client and transmit data in the first client to the persistent connection server via the first server;
the first server is configured to receive data sent by the first client and forward it to the persistent connection server;
the second client is configured to receive identification information sent by the first client and search for address information of a corresponding persistent connection server via the persistent connection allocation server; establish a persistent connection with the persistent connection server; and receive data transmitted by the first client via the persistent connection server;
the persistent connection allocation server is configured to allocate a persistent connection server according to the identification information of the first client; and receive an address request message sent by an individual client carrying the identification information of the first client and feed back the address of a corresponding persistent connection server to the requester; and
the persistent connection server is configured to establish a persistent connection with the second client; and receive data from the first client forwarded by the first server, and forward the data to the second client.

21-89. (canceled)
